(19) United States
(12) Patent Application Publication
(10) Pub. No.: US 2026/0084968 A1
(43) Pub. Date: Mar. 26, 2026

(54) PROCESSES AND SYSTEMS FOR MAKING BIOGRAPHITE UTILIZING A MOLTEN METAL CARBIDE REACTOR

(71) Applicant: Carbon Technology Holdings, LLC, Oakdale, MN (US)

(72) Inventors: Edgar LOTERO, Overland Park, KS (US); Dustin SLACK, Gwinn, MI (US); Daren DAUGAARD, Newburg, MO (US); James A. MENNELL, Brighton, UT (US)

(21) Appl. No.: 19/335,054

(22) Filed: Sep. 22, 2025

Related U.S. Application Data
(60) Provisional application No. 63/698,221, filed on Sep. 24, 2024.

(51) Int. Cl. C01B 32/205; B01J 14/00; B01J 19/24

(52) U.S. Cl. CPC C01B 32/205; B01J 14/00; B01J 19/245

(57) ABSTRACT

The invention provides a process for producing biographite from a biocarbon feedstock, comprising: providing a metal-containing species that is a metal carbide or is capable of forming a metal carbide; feeding a biocarbon feedstock and the metal-containing species into a molten metal carbide reactor having a first reaction zone and a second reaction zone, wherein the first reaction zone is operated at a first-zone temperature selected to achieve a molten state comprising the metal carbide, and wherein the second-zone temperature is lower than the first-zone temperature; operating the molten metal carbide reactor to dissolve carbon (from the biocarbon feedstock) in the molten state, thereby generating dissolved carbon, and to produce biographite from the dissolved carbon; recovering biographite product; and recycling a portion of the biographite to the molten metal carbide reactor. The recycled biographite functions as a graphitization template to enhance formation of biographite from the dissolved carbon.

### PRIORITY DATA

This non-provisional patent application claims priority to U.S. Provisional Patent App. No. 63/698,221, filed on Sep. 24, 2024, which is hereby incorporated by reference.

### FIELD OF THE INVENTION

The present invention generally relates to processes and systems for making and using biographite, and biographite compositions obtained from the disclosed processes and systems.

### BACKGROUND OF THE INVENTION

Carbon is a platform element in a wide variety of industries and has a vast number of chemical, material, and fuel uses. Carbon is a good fuel to produce energy, including electricity. Carbon also has tremendous chemical value for various commodities and advanced materials, including metals, metal alloys, composites, carbon fibers, electrodes, and catalyst supports. For metal making, carbon is useful as a reactant, for reducing metal oxides to metals during processing; as a fuel, to provide heat for processing; and as a component of a metal alloy. Historically, carbon in the form of coal has been used extensively for industrial purposes. Coal is still the world's largest source of energy for electricity generation and for metal making. However, coal is believed to be the single largest contributor to climate change.

An important form of carbon is graphite. There is a growing demand for graphite, and there is a desire for more sustainable and renewable processes and systems for making graphite. In particular, there is a desire to avoid mining rocks of natural graphite, and to avoid using fossil-fuel feedstocks to make synthetic graphite.

### SUMMARY OF THE INVENTION

The present invention addresses the aforementioned needs in the art.

In some variations, the invention provides a process for producing biographite from a biocarbon feedstock, the process comprising:
(a) providing a biocarbon-containing feedstock;
(b) providing a metal-containing species that comprises a selected metal element, wherein the metal-containing species is a metal carbide or is capable of forming a metal carbide;
(c) feeding the biocarbon feedstock and the metal-containing species into a molten metal carbide reactor having a first reaction zone and a second reaction zone, wherein the first reaction zone is operated at a first-zone temperature selected to achieve a molten state comprising the metal carbide within the first reaction zone, and wherein the second reaction zone is operated at a second-zone temperature that is lower than the first-zone temperature;
(d) operating the molten metal carbide reactor to dissolve carbon from the biocarbon feedstock in the molten state, thereby generating dissolved carbon, and to produce biographite from the dissolved carbon in the second reaction zone;
(e) recovering and optionally further processing the biographite; and
(f) recycling a portion of the biographite to the molten metal carbide reactor as recycled biographite, wherein the recycled biographite functions as a graphitization template to enhance formation of the biographite from the dissolved carbon.

In some embodiments, the biocarbon-containing feedstock is a solid feedstock. For example, the biocarbon-containing feedstock can be a solid material obtained from biomass pyrolysis.

In some embodiments, the biocarbon-containing feedstock is a liquid feedstock. For example, the biocarbon-containing feedstock can be a liquid material obtained from biomass pyrolysis.

In some embodiments, the biocarbon-containing feedstock is a vapor feedstock. In these embodiments, the process can co-produces hydrogen, from the vapor feedstock, in the molten metal carbide reactor.

In some embodiments, the selected metal element (in the metal-containing species) is selected from iron, magnesium, calcium, nickel, copper, gallium, lithium, sodium, potassium, beryllium, strontium, barium, scandium, yttrium, titanium, zirconium, hafnium, vanadium, niobium, chromium, molybdenum, tungsten, manganese, technetium, rhenium, ruthenium, osmium, cobalt, rhodium, iridium, palladium, platinum, zinc, cadmium, mercury, aluminum, indium, thallium, silicon, germanium, tin, lead, lanthanum, cerium, uranium, thorium, or a combination thereof. The metal-containing species can be a pure metal or a combination of pure metals. Alternatively, or additionally, the metal-containing species can be selected from a metal carbide, a metal alloy, a metal oxide, a metal hydride, a metal nitride, or a combination thereof.

In certain embodiments, the metal-containing species is iron, Fe. In certain embodiments, the metal-containing species is iron carbide, Fe₃C. In certain embodiments, the metal-containing species is a combination of iron and iron carbide.

In some embodiments, the first-zone temperature is selected from about 1500° C. to about 2000° C. In certain embodiments, the first-zone temperature is selected from about 1600° C. to about 1800° C.

In some embodiments, the second-zone temperature is selected from about 1200° C. to about 1600° C. In certain embodiments, the second-zone temperature is selected from about 1300° C. to about 1500° C. In some embodiments, the second-zone temperature is at least 100° C. lower than the first-zone temperature. In certain embodiments, the second-zone temperature is at least 200° C. lower than the first-zone temperature.

In some embodiments, the recycled biographite is recycled to the first reaction zone of the molten metal carbide reactor. In some embodiments, the recycled biographite is recycled to the second reaction zone of the molten metal carbide reactor. In certain embodiments, the recycled biographite is recycled to both the first and second reaction zones.

In some embodiments, the recycled biographite is first mixed with the biocarbon-containing feedstock and the metal-containing species to form a feed mixture, and then the feed mixture is conveyed to the first reaction zone of the molten metal carbide reactor.

In some embodiments, from about 10% to about 80% by mass of the biographite from step (e) is recycled as recycled biographite in step (f). In certain embodiments, from about 20% to about 50% by mass of the biographite from step (e) is recycled as recycled biographite in step (f).

In some embodiments, step (f) comprises recycling on the basis of biographite particle size. The recycled biographite can have a smaller average particle size compared to the biographite that is not recycled, for example.

In some embodiments, at least a portion of the metal carbide present in the first reaction zone is recovered from the first reaction zone of the molten metal carbide reactor. In some embodiments, at least a portion of the metal carbide present in the first reaction zone is recovered from the second reaction zone of the molten metal carbide reactor. In some embodiments, at least a portion of the metal carbide present in the first reaction zone is recovered from both the first and second reaction zones. Optionally, the portion of metal carbide recovered from the molten metal carbide reactor is recycled to the first reaction zone. The recycled biographite and the portion of metal carbide recovered from the molten metal carbide reactor can be first mixed with the biocarbon-containing feedstock and the metal-containing species to form a feed mixture, which is then conveyed to the first reaction zone of the molten metal carbide reactor.

In some embodiments, during step (d), slag is formed from the metal-containing species and/or the biocarbon feedstock. Slag is typically formed, but not necessarily. Slag formation can be avoided when pure iron (no iron oxide) and pure biocarbon (no ash) are fed to the molten metal carbide reactor. When slag is formed, at least at least a portion of the slag can be recovered from the first reaction zone and/or the second reaction zone of the molten metal carbide reactor.

In some embodiments, the process further comprises feeding a reducing gas into the molten metal carbide reactor, wherein the reducing gas contains H₂ and/or CO.

In some embodiments, the process further comprises washing the biographite. Washing can employ an acid wash, a caustic wash, or a sequential combination thereof (in either order).

In some embodiments, the process further comprises drying the biographite, calcining the biographite, or both drying and calcining the biographite.

The process can be operated continuously or semi-continuously. Alternatively, the process can be operated in batch.

In some embodiments, the first reaction zone and the second reaction zone are physically contained within a single reaction vessel. In other embodiments, the first reaction zone is physically contained in a first reaction vessel, and the second reaction zone is physically contained in a second reaction vessel.

In some embodiments, contents of the first reaction vessel are continuously or semi-continuously conveyed to the second reaction vessel. Alternatively, or additionally, contents of the second reaction vessel can be continuously or semi-continuously conveyed back to the first reaction vessel.

In some embodiments, in step (c), the biocarbon feedstock and the metal-containing species are fed into the first reaction vessel such that there is countercurrent flow of the biocarbon feedstock and the metal-containing species.

In some embodiments, the biographite is at least 90% renewable, according to a measurement of the ¹⁴C/¹²C isotopic ratio of the biographite. In certain embodiments, the biographite product is 100% renewable, according to a measurement of the ¹⁴C/¹²C isotopic ratio of the biographite.

In some embodiments, the biographite is recovered in the form of a biographite product that contains at least 80 wt % crystalline graphite according to spectroscopy. In certain embodiments, the biographite product contains at least 90 wt % crystalline graphite according to spectroscopy.

In some embodiments, the process further comprising fabricating an electrode containing the biographite. The electrode can be a metal-making electrode, such as an electrode utilized in electric arc furnace metal production, for example. The electrode can be a battery electrode.

Other variations provide a biographite product produced by a process comprising:
(a) providing a biocarbon-containing feedstock;
(b) providing a metal-containing species that comprises a selected metal element, wherein the metal-containing species is a metal carbide or is capable of forming a metal carbide;
(c) feeding the biocarbon feedstock and the metal-containing species into a molten metal carbide reactor having a first reaction zone and a second reaction zone, wherein the first reaction zone is operated at a first-zone temperature selected to achieve a molten state comprising the metal carbide within the first reaction zone, and wherein the second reaction zone is operated at a second-zone temperature that is lower than the first-zone temperature;
(d) operating the molten metal carbide reactor to dissolve carbon from the biocarbon feedstock in the molten state, thereby generating dissolved carbon, and to produce biographite from the dissolved carbon in the second reaction zone;
(e) recovering and optionally further processing the biographite, to generate a biographite product; and
(f) recycling a portion of the biographite to the molten metal carbide reactor as recycled biographite, wherein the recycled biographite functions as a graphitization template to enhance formation of the biographite from the dissolved carbon.

In some products, the biographite is at least 90% renewable, according to a measurement of the ¹⁴C/¹²C isotopic ratio of the biographite. In certain products, the biographite is 100% renewable, according to a measurement of the ¹⁴C/¹²C isotopic ratio of the biographite.

In some products, the biographite product contains at least 80 wt % crystalline graphite according to spectroscopy. In certain products, the biographite product contains at least 90 wt % crystalline graphite according to spectroscopy.

Other embodiments provide an electrode containing the biographite product as disclosed. The electrode can be a metal-making electrode. An exemplary metal-making electrode is one that is utilized in electric arc furnace metal production, to fabricate iron, ferroalloys, aluminum, or titanium, for example. The electrode can be a battery electrode, such as (but not limited to) a lithium-ion battery electrode.

Other variations provide a one-stage system for producing biographite, wherein the one-stage system is configured to carry out the disclosed process, and wherein the first reaction zone and the second reaction zone are physically contained within a single reaction vessel. An exemplary one-stage system is depicted in FIG. 1.

Other variations provide a two-stage system for producing biographite, wherein the two-stage system is configured to carry out the disclosed process, wherein the first reaction zone is physically contained in a first reaction vessel, and wherein the second reaction zone is physically contained in a second reaction vessel. An exemplary two-stage system is depicted in FIG. 2.

### BRIEF DESCRIPTION OF THE DRAWINGS

FIG. 1 is a simplified process and system block-flow diagram depicting some variations of the invention to produce biographite from a biocarbon-containing feedstock, utilizing a molten metal carbide reactor containing multiple reaction zones.

FIG. 2 is a simplified process and system block-flow diagram depicting some variations of the invention to produce biographite from a biocarbon-containing feedstock, utilizing a two-stage molten metal carbide reactor configured as multiple reaction vessels.

### DETAILED DESCRIPTION OF EMBODIMENTS OF THE INVENTION

Carbon can be produced, in principle, from virtually any carbonaceous material. Carbonaceous materials commonly include fossil resources such as natural gas, petroleum, coal, and lignite; and renewable resources such as lignocellulosic biomass and various carbon-rich waste materials. It is preferable to utilize renewable biomass to produce carbon-based reagents because of the rising economic, environmental, and social costs associated with fossil resources.

Biomass is a term used to describe any biologically produced matter, or biogenic matter. The chemical energy contained in biomass is derived from solar energy using the natural process of photosynthesis. Photosynthesis is the process by which plants take in carbon dioxide and water from their surroundings and, using energy from sunlight, convert them into sugars, starches, cellulose, hemicellulose, and lignin. Of all the renewable energy sources, biomass is unique in that it is, effectively, stored solar energy. Furthermore, biomass is the only renewable source of carbon.

There exist a variety of conversion technologies to turn biomass feedstocks into high-carbon materials. Pyrolysis is a process for thermal conversion of solid materials in the complete absence of oxidizing agent (air or oxygen), or with such limited supply that oxidation does not occur to any appreciable extent. Depending on process conditions and additives, biomass pyrolysis can be adjusted to produce widely varying amounts of gas, liquid, and solid. Historically, slow pyrolysis of wood has been performed in large piles, in a simple batch process, with no emissions control. Traditional charcoal-making technologies are energy-inefficient as well as highly polluting.

Carbon has several allotropes, or forms. Important allotropes of carbon include graphite, graphene, fullerenes, diamond, and amorphous carbon. Graphite and graphene have a hexagonal crystal structure; graphene is essentially a single layer of graphite. Fullerenes have a spherical, tubular, or ellipsoidal crystal structure. Diamond has a diamond cubic crystal structure with a tetrahedral geometry. Amorphous carbon is carbon that has no crystalline structure.

Graphite is a mineral composed of stacked sheets of carbon atoms. Graphite is very soft, has a low specific gravity, is relatively non-reactive, and has high electrical and thermal conductivity. Graphite is the most stable form of pure carbon under standard conditions (even more thermodynamically stable than diamond). The carbon in graphite is sp²-hybridized. Each carbon atom is joined to three other carbon atoms by covalent bonds. The carbon atoms form layers with a hexagonal arrangement of atoms. The molecular geometry of graphite is trigonal planar with a bond angle of 120°.

Graphite is one of the most versatile non-metallic minerals in the world. Conventionally, graphite is mined from the earth. Graphite occurs naturally in igneous and metamorphic rocks, where high temperatures and pressures and immense periods of time have converted organic material included in mineral deposits into graphite. Graphite is mined in China, Bavaria, South Korea, Russia, Canada, Norway, India, Sri Lanka, Mexico, Mozambique, and Madagascar. Today, China is the world's top graphite producer.

Graphite can also be created synthetically by heating materials with high carbon content, conventionally petroleum coke or coal-tar pitch. The carbon-rich material is heated up to about 3000° C., purifying the material of contaminants and allowing the carbon to form its hexagonal sheets at chemical equilibrium. On average, production of synthetic graphite emits more greenhouse gases than mining natural graphite (source: https://news.northwestern.edu/stories/2023/02/domestic-graphite-production-green-energy-transition, accessed on Jul. 24, 2024).

Graphite is considered a key, strategic material in the green economy including energy storage, electric vehicles, photovoltaics, and electronics. Demand for graphite is expected to outstrip supply over the next decade. Notably, there is an order of magnitude more graphite than lithium in most Li-ion batteries. For the electric-vehicle market, graphite demand is anticipated to soon exceed more than is produced globally today. Graphite usage in lithium-ion batteries, stationary batteries, lead-acid batteries, and fuel cells is expected to increase five-fold by 2050 under a scenario that limits global warming to two degrees Celsius. See Zhang et al., “Graphite Flows in the U.S.: Insights into a Key Ingredient of Energy Transition”, Environ. Sci. Technol. 2023, 57, 3402-3414, which is hereby incorporated by reference.

Graphite is used as a dry lubricant in applications where wet lubricants, such as oil, cannot be used. Graphite has been used in pencil lead since the 1600s. Graphite is used to make brake linings. Graphite is the only non-metal element that is a good conductor of electricity. As noted above, graphite electrodes are common in many types of batteries, as well as fuel cells. Graphite electrodes are used in electric arc furnaces for the steel production process. Large electrical currents are passed through the graphite electrodes, and electric arcs form between the tips of the electrodes and across the liquid steel. Natural graphite is used as molds in refractory applications that involve extremely high heat and therefore demand materials that will not melt or disintegrate under such extreme conditions. One example is a crucible used in the steel industry. Graphite is also used as a neutron moderator in nuclear reactors. Graphite is used in energy products, such as silicon for solar panels and rotor blades and electric brushes for wind turbines. Specialty graphite is used in semiconductor production. Graphite demand is also increasing for other advanced technologies including aerospace applications, ceramic armor tiles, and electro-consolidation (Zhang et al., op. cit.).

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying drawings.

For purposes of an enabling technical disclosure, various explanations, hypotheses, theories, speculations, assumptions, and so on are disclosed. The present invention does not rely on any of these being in fact true. None of the explanations, hypotheses, theories, speculations, or assumptions in this detailed description shall be construed to limit the scope of the invention in any way.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing reaction conditions, stoichiometries, concentrations of components, and so forth used in the specification and claims are to be understood as being modified in all instances by the term “about.” Accordingly, unless indicated to the contrary, the numerical parameters set forth in the following specification and attached claims are approximations that can vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language that means that the named claim elements are essential, but other claim elements can be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms, except in the case of Markush groups. Thus in some embodiments not otherwise explicitly recited, any instance of “comprising” can be replaced by “consisting of” or, alternatively, by “consisting essentially of.”

Furthermore, as used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness can in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

“Biomass” is a term used to describe any biologically produced matter, or biogenic matter. Biomass refers to the mass of living organisms, including plants, animals, and microorganisms, or, from a biochemical perspective, cellulose, lignin, sugars, fats, and proteins. Biomass includes both the above-ground and below-ground tissues of plants—for example, leaves, twigs, branches, boles, as well as roots of trees and rhizomes of grasses. The chemical energy contained in biomass is derived from solar energy using the natural process of photosynthesis. This is the process by which plants take in carbon dioxide and water from their surroundings and, using energy from sunlight, convert them into sugars, starches, cellulose, hemicellulose, and lignin. Biomass is useful in that it is, effectively, stored solar energy. Biomass is the only renewable source of carbon.

As used herein, “biogenic” is a material (whether a feedstock, product, or intermediate) that contains an element, such as carbon, that is renewable on time scales of months, years, or decades. Non-biogenic materials can be non-renewable, or can be renewable on time scales of centuries, thousands of years, millions of years, or even longer geologic time scales. For example, traditional fuel sources of coal and petroleum are non-renewable and non-biogenic. A biogenic material can consist essentially of biogenic sources. It will be understood by one skilled in the art that biogenic materials, as natural sources or derived from nature, can comprise an immaterial amount of non-biogenic material. Further, the processes disclosed herein can be used with non-biogenic material, though the beneficial environmental impact may not be as great.

There are three naturally occurring isotopes of carbon, ¹²C, ¹³C, and ¹⁴C. ¹²C and ¹³C are stable, occurring in a natural proportion of approximately 93:1. ¹⁴C is produced by thermal neutrons from cosmic radiation in the upper atmosphere, and is transported down to earth to be absorbed by living biological material. Isotopically, ¹⁴C constitutes a negligible part; but, since it is radioactive with a half-life of 5,700 years, it is radiometrically detectable. Dead tissue does not absorb ¹⁴C, so the amount of ¹⁴C is one of the methods used for radiometric dating of biological material.

Plants take up ¹⁴C by fixing atmospheric carbon through photosynthesis. Animals then take ¹⁴C into their bodies when they consume plants or consume other animals that consume plants. Accordingly, living plants and animals have the same ratio of ¹⁴C to ¹²C as the atmospheric CO₂. Once an organism dies, it stops exchanging carbon with the atmosphere, and thus no longer takes up new ¹⁴C. Radioactive decay then gradually depletes the ¹⁴C in the organism. This effect is the basis of radiocarbon dating.

Fossil fuels, such as coal, are made primarily of plant material that was deposited millions of years ago. This period of time equates to thousands of half-lives of ¹⁴C, so essentially all of the ¹⁴C in fossil fuels has decayed. Fossil fuels also are depleted in ¹³C relative to the atmosphere, because they were originally formed from living organisms. Therefore, the carbon from fossil fuels is depleted in both ¹³C and ¹⁴C compared to biogenic carbon.

This difference between the carbon isotopes of recently deceased organic matter, such as that from renewable resources, and the carbon isotopes of fossil fuels, such as coal, allows for a determination of the source of carbon in a composition. Specifically, whether the carbon in the composition was derived from a renewable resource or from a fossil fuel; in other words, whether a renewable resource or a fossil fuel was used in the production of the composition.

For present purposes, “biographite” is graphite that is produced from a biogenic reagent. For present purposes, mined graphite is not considered to be biographite or a biogenic reagent. Another contrary example is graphite produced from needle coke, which has historically been used in the manufacture of graphite electrodes such as for electric arc furnaces.

A “bioliquid feedstock” means a liquid-phase feed material that is derived from biomass. The bioliquid feedstock contains fully renewable carbon according to a measurement of the ¹⁴C/¹¹C isotopic ratio of the bioliquid feedstock. Some embodiments of the invention are premised on the recognition that simple heating of bioliquid feedstocks (such as at 1400-1600° C.) will not lead to a high-quality biographite. Bioliquid feedstocks often contain lignin polymers and other oxygen-containing polymers, which are difficult to convert to biographite. A graphitization catalyst can be added to the molten metal carbide reactor. Here, a “graphitization catalyst” is distinguished from the metal carbide or from any graphitic material recycled to the reactor that serves as graphitization template. Examples of graphitization catalysts include zeolites, metal-based catalysts, metal oxide-based catalysts, and inorganic salts. If a graphitization catalyst is added to the reactor, the catalyst can remain in the final biographite, which can be acceptable due to low concentrations of catalyst. Or, the graphitization catalyst can end up in the slag component, for example.

For present purposes, “reagent” is intended to mean a material in its broadest sense; a reagent can be a fuel, a chemical, a material, a compound, an additive, a blend component, a solvent, and so on. A reagent is not necessarily a chemical reagent that causes or participates in a chemical reaction. A reagent may or may not be a chemical reactant; it may or may not be consumed in a reaction. A reagent can be a chemical catalyst for a particular reaction. A reagent can cause or participate in adjusting a mechanical, physical, or hydrodynamic property of a material to which the reagent can be added. For example, a reagent can be introduced to a metal to impart certain strength properties to the metal. A reagent can be a substance of sufficient purity (which, in the current context, is typically carbon purity) for use in chemical analysis or physical testing.

“Pyrolysis” and “pyrolyze” generally refer to thermal decomposition of a carbonaceous material. In pyrolysis, less oxygen is present than is required for complete combustion of the material, such as less than 10%, 5%, 1%, 0.5%, 0.1%, or 0.01% of the oxygen (O₂ molar basis) that is required for complete combustion. In some embodiments, pyrolysis is performed in the absence of oxygen.

Reference herein to “sand” shall also include similar, substantially inert materials, such as glass particles, recovered ash particles, and the like. High heat-transfer rates from fluidized sand can result in rapid heating of the feedstock. There can be some ablation by attrition with the sand particles. Heat is usually provided by heat-exchanger tubes through which hot combustion gas flows.

In this specification, “spectroscopy” refers to the measurement of spectra produced when matter (in this case, a sample of biographite product) interacts with or emits electromagnetic radiation. As is known in the graphite art, there are several spectroscopic methods that can be used to determine crystallinity of carbon. In some embodiments, crystalline graphite is determined according to X-ray diffraction (XRD). In some embodiments, crystalline graphite is determined according to Raman spectroscopy, utilizing inelastic (Raman) scattering of photons. In some embodiments, crystalline graphite is determined according to combined XRD-Raman spectroscopy. It is also possible to use thermal methods (e.g., thermogravimetric analysis) to estimate the crystallinity of carbon. Thermal methods can be used in conjunction with spectroscopy, or can be used alone, such as with a prior calibration of crystalline graphite content according to spectroscopy or against known graphite standards.

References to “zones” shall be broadly construed to include regions of space within a single physical unit, physically separate units, or any combination thereof. For a continuous reactor, the demarcation of zones can relate to structure, such as the presence of flights within the reactor or distinct heating elements to provide heat to separate zones. Alternatively, or additionally, the demarcation of zones in a continuous reactor can relate to function, such as distinct temperatures, fluid flow patterns, solid flow patterns, extent of reaction, and so on. In a single batch reactor, “zones” are operating regimes in time, rather than in space. Multiple batch reactors can also be used.

Some variations of the invention are premised on the utilization of recycled graphite as a nucleation medium for precipitating carbon from a metal carbide melt. The particles of recycled graphite act as seeds to direct the formation of graphite crystals during carbon precipitation. Graphite is formed from a saturated or supersaturated metal carbide melt. Here, “saturated or supersaturated” refers to the concentration of carbon within the melt. After the graphite particles (e.g., flakes) are formed, they can float to the surface where the graphite particles can be skimmed, for example. The melting point of graphite is 3650° C., which is significantly lower than the temperature within the molten metal carbide reactor.

In some variations, the invention provides a process for producing biographite from a biocarbon feedstock, the process comprising:
(a) providing a biocarbon-containing feedstock;
(b) providing a metal-containing species that comprises a selected metal element, wherein the metal-containing species is a metal carbide or is capable of forming a metal carbide;
(c) feeding the biocarbon feedstock and the metal-containing species into a molten metal carbide reactor having a first reaction zone and a second reaction zone, wherein the first reaction zone is operated at a first-zone temperature selected to achieve a molten state comprising the metal carbide within the first reaction zone, and wherein the second reaction zone is operated at a second-zone temperature that is lower than the first-zone temperature;
(d) operating the molten metal carbide reactor to dissolve carbon from the biocarbon feedstock in the molten state, thereby generating dissolved carbon, and to produce biographite from the dissolved carbon in the second reaction zone;
(e) recovering and optionally further processing the biographite; and
(f) recycling a portion of the biographite to the molten metal carbide reactor as recycled biographite, wherein the recycled biographite functions as a graphitization template to enhance formation of the biographite from the dissolved carbon.

In some embodiments, the biocarbon-containing feedstock is a solid feedstock. For example, the biocarbon-containing feedstock can be a solid material obtained from biomass pyrolysis. The biocarbon-containing feedstock, in solid form, can be cellulose, lignin, or sugars, for example. Solid forms of biocarbon-containing feedstocks are further discussed later in the specification.

In some embodiments, the biocarbon-containing feedstock is a liquid feedstock. For example, the biocarbon-containing feedstock can be a liquid material obtained from biomass pyrolysis. The biocarbon-containing feedstock, in liquid form, can be bioethanol or another liquid-phase fermentation product. Liquid forms of biocarbon-containing feedstocks are further discussed later in the specification.

In some embodiments, the biocarbon-containing feedstock is a vapor feedstock. In these embodiments, the process can co-produce hydrogen, from the vapor feedstock, in the molten metal carbide reactor. An exemplary biocarbon-containing feedstock, in vapor form, is biogas obtained from anaerobic digestion of animal waste or lignocellulosic biomass. Biogas is rich in methane (CH₄). Another exemplary biocarbon-containing feedstock, in vapor form, is pyrolysis vapor obtained from biomass pyrolysis.

In some embodiments, the selected metal element (in the metal-containing species) is selected from iron, magnesium, calcium, nickel, copper, gallium, lithium, sodium, potassium, beryllium, strontium, barium, scandium, yttrium, titanium, zirconium, hafnium, vanadium, niobium, chromium, molybdenum, tungsten, manganese, technetium, rhenium, ruthenium, osmium, cobalt, rhodium, iridium, palladium, platinum, zinc, cadmium, mercury, aluminum, indium, thallium, silicon, germanium, tin, lead, lanthanum, cerium, uranium, thorium, or a combination thereof. The metal-containing species can be a pure metal or a combination of pure metals. Alternatively, or additionally, the metal-containing species can be selected from a metal carbide, a metal alloy, a metal oxide, a metal hydride, a metal nitride, or a combination thereof.

In certain embodiments, the metal-containing species is iron, Fe. In certain embodiments, the metal-containing species is iron carbide, Fe₃C. In certain embodiments, the metal-containing species is a combination of iron and iron carbide.

The metal carbides that are part of the molten state in the reactor are certainly not limited to iron carbide. In some embodiments, the metal carbide is selected to have a melting point below 2000° C., below 1900° C., below 1800° C., below 1700° C., below 1600° C., below 1500° C., below 1400° C., below 1300° C., or below 1200° C. Exemplary metal carbides and their melting points (ordinary melting temperatures at 1 bar) are as follows:
Iron carbide (Fe₃C): Melting point of approximately 1227° C.
Magnesium carbide (Mg₂C₃): Melting point of approximately 1402° C.
Cobalt carbide (Co₃C): Melting point of approximately 1380° C.
Chromium carbide (Cr₃C₂): Melting point of approximately 1895° C.
Nickel carbide (Ni₃C): Melting point of approximately 1400° C.
Manganese carbide (Mn₃C): Melting point of approximately 1550° C.
Lithium carbide (Li₂C₂): Melting of approximately 1730° C.
Potassium carbide (K₂C₂): Melting point of approximately 1740° C.

Typically, both the first-zone temperature and the second-zone temperature are below 3650° C., which is the melting point of graphite. In order to accomplish precipitation of biographite, the second-zone temperature needs to be less than 3650° C. (typically much lower).

In some embodiments, the first-zone temperature is selected from about 1500° C. to about 2000° C. In certain embodiments, the first-zone temperature is selected from about 1600° C. to about 1800° C. In various embodiments, the first-zone temperature is about, at least about, or at most about 1500° C., 1550° C., 1600° C., 1650° C., 1700° C., 1750° C., or 1800° C., including any intervening range. Note that reference to the first-zone temperature is the average temperature within the first zone of the reactor. Within the first zone itself, there can be a temperature profile in the axial or radial dimension.

In some embodiments, the second-zone temperature is selected from about 1200° C. to about 1600° C. In certain embodiments, the second-zone temperature is selected from about 1300° C. to about 1500° C. In various embodiments, the second-zone temperature is about, at least about, or at most about 1200° C., 1250° C., 1300° C., 1350° C., 1400° C., 1450° C., 1500° C., 1550° C., or 1600° C., including any intervening range. Note that reference to the second-zone temperature is the average temperature within the second zone of the reactor. Within the second zone itself, there can be a temperature profile in the axial or radial dimension.

In some embodiments, the second-zone temperature is at least 100° C. lower than the first-zone temperature. In certain embodiments, the second-zone temperature is at least 200° C. lower than the first-zone temperature. In various embodiments, the difference between the first-zone temperature (T₁) and the second-zone temperature (T₂), i.e. T₁−T₂, is about, at least about, or at most about 10° C., 20° C., 30° C., 40° C., 50° C., 60° C., 70° C., 80° C., 90° C., 100° C., 125° C., 150° C., 175° C., 200° C., 225° C., 250° C., 275° C., or 300° C., including any intervening range.

The maximum temperature within the molten metal carbide reactor can be about 2000° C., 1900° C., 1800° C., 1700° C., 1600° C., or 1500° C., for example. The maximum temperature can be significantly lower than known heat treatments to produce graphite, such as about 2500° C. to about 3000° C. Although the crystalline form of carbon is thermodynamically stable, while the amorphous form is only metastable, a high activation energy is associated with uncatalyzed conversion of amorphous carbon to crystalline graphite. The disclosed reaction utilizes a fundamentally different pathway to generate biographite, in which recycled biographite functions as a graphitization template to catalytically enhance formation of new biographite at a relatively low temperature.

The molten metal carbide reactor can be heated using a variety of heat-transfer mechanisms, which can utilize direct heating, indirect heating, or a combination thereof. “Direct heating” of a molten metal carbide reactor means that heat is generated directly within the reaction vessel itself. “Indirect heating” of a molten metal carbide reactor means that heat is generated externally and is transferred through the walls of the reaction vessel.

Examples of indirect heating include external steam heating, external combustion-gas heating, external hot-oil heating, external electrical-resistance (ohmic) heating, and combinations thereof. With indirect heating, heat is formed and then needs to be transferred to the internal contents of the reaction vessel so that the desired reaction temperature is achieved. One benefit of indirect heating is that there is no mass transferred with the internal reaction vessel. However, indirect heating tends to be less efficient than direct heating, especially for high temperatures.

Examples of direct heating include partial or complete oxidation within the reaction vessel, infrared radiation, microwave radiation, ohmic heating using resistive elements within the reaction vessel, induction heating, and combinations thereof. With direct heating, heat is formed within the reaction vessel itself, avoiding the heat-transfer step at the reactor walls.

In some embodiments, induction heating is utilized for the molten metal carbide reactor. Induction heating is a fast, clean, energy-efficient, and highly controllable non-contact method for heating metals or other electrically conductive materials. Induction heating utilizes one or more induction heaters. An induction heater can consist of an electromagnet and an electronic oscillator that passes a high-frequency alternating current through the electromagnet. A typical electromagnet is a copper coil that is hollow and contains a cooling medium (e.g., water) to prevent the electromagnet from becoming too hot. The rapidly alternating magnetic field penetrates from the induction coils (which are external to the vessel) into the internal space of the reaction vessel, generating eddy currents within the metal-containing species. The eddy currents flow through and heat the metal-containing species by Joule heating. In ferromagnetic and ferrimagnetic materials, such as iron, heat also is generated by magnetic hysteresis losses. Notably, however, the metal-containing species need not be magnetic for induction heating to work. The metal-containing species only needs to be a conductor or a semiconductor for induction heating to work. Because graphite is itself electrically conductive, the graphite product will heat up (via induction) as well, but the process can be controlled such that the graphite does not melt. The heat generated within the graphite can be transferred to the metal-containing species—that is, the graphite can function as an electrically conductive susceptor. The biocarbon feedstock that is fed to the molten metal carbide reactor may or may not be electrically conductive, and it need not be. If the biocarbon feedstock is electrically conductive, it can also function as an electrically conductive susceptor, during induction heating of the metal-containing species.

In some embodiments, internal oxidation is used to provide exothermic heat to the molten metal carbide reactor, to reach the desired reaction temperature. Internal oxidation can be complete combustion that generates heat, as well as CO and/or H₂O, from a reactant. Alternatively, or additionally, internal oxidation can be partial oxidation that generates heat, as well as CO and/or H₂O, from a reactant. The reactant for generating heat can be solid carbon, and optionally is a portion of the biocarbon feedstock that serves as a sacrificial reactant for generating heat. The reactant for generating heat can be injected as a separate vapor reactant, such as methane (e.g., in the form of natural gas or biogas), hydrogen (H₂), CO, or a reducing gas containing both H₂ and CO. The reactant for generating heat can be injected as a separate liquid reactant, such as methanol. In addition to the reactant, an oxidant must be introduced, in these embodiments employing internal oxidation. The oxidant can be selected from air (about 21 vol % O₂), substantially pure oxygen (90-100 vol % O₂), oxygen-enriched air (e.g., a gas mixture containing about 22-90 vol % O₂ in which the oxygen is derived from atmospheric air), oxygen-depleted air (e.g., a gas mixture containing about 5-20 vol % O₂ in which the oxygen is derived from atmospheric air), ozone (O₃), hydrogen peroxide (H₂O₂), or a combination thereof, for example. The quantity of oxidant introduced to the reactor in these embodiments can be the stoichiometric amount for complete oxidation of the intended reactant (for generating heat), or can be less than such stoichiometric amount, such as from about 10% to about 95%, or from about 25% to about 75%, of the stoichiometric amount for complete oxidation of the intended reactant.

The first and second reaction zones of the molten metal carbide reactor can be heated using the same mechanism (e.g., induction heating for both zones). Alternatively, the first and second reaction zones of the molten metal carbide reactor can be heated differently (e.g., induction heating in first reaction zone, and external combustion-gas heating in the second reaction zone). In some embodiments utilizing induction heating, tighter coil spacing is designed around the first reaction zone, to control a higher temperature for the first reaction zone compared to the second reaction zone.

The first reaction zone can have a first-zone residence time selected from about 15 minutes to about 8 hours, for example. In various embodiments, the first-zone residence time is about, at least about, or at most about 0.1, 0.2, 0.3, 0.4, 0.5, 1, 1.5, 2, 2.5, 3, 3.5, 4, 5, 6, 7, or 8 hours, including any intervening range.

The first reaction zone can have a first-zone pressure selected from about 1 bar to about 10 bar, for example. In various embodiments, the first-zone pressure is about, at least about, or at most about 1, 1.5, 2, 2.5, 3, 3.5, 4, 5, 6, 7, 8, 9, or 10 bar, including any intervening range.

The second reaction zone can have a second-zone residence time selected from about 30 minutes to about 12 hours, for example. In various embodiments, the second-zone residence time is about, at least about, or at most about 0.5, 1, 1.5, 2, 2.5, 3, 3.5, 4, 5, 6, 7, 8, 9, 10, 11, or 12 hours, including any intervening range.

The second reaction zone can have a second-zone pressure selected from about 0.1 bar to about 5 bar, for example. In various embodiments, the second-zone pressure is about, at least about, or at most about 0.1, 0.2, 0.5, 0.8, 1, 1.2, 1.5, 2, 3, 4, or 5 bar, including any intervening range. The second-zone pressure can be less than 1 bar, i.e. operated under vacuum, to assist the chemistry or to more efficiently remove biovapor, for example.

In some embodiments, the molten metal carbide reactor is operated at a vapor-phase residence time selected from about 1 minute to about 8 hours, such as from about 15 minutes to about 4 hours. In various embodiments, the vapor-phase residence time is about, at least about, or at most about 0.1, 0.2, 0.3, 0.4, 0.5, 1, 2, 3, 4, 5, 6, 7, or 8 hours, including any intervening range.

In some embodiments, the molten metal carbide reactor is operated at a liquid-phase residence time selected from about 5 minutes to about 12 hours, such as from about 30 minutes to about 8 hours. In various embodiments, the vapor-phase residence time is about, at least about, or at most about 0.1, 0.2, 0.3, 0.4, 0.5, 1, 2, 3, 4, 5, 6, 7, 8, 9, 10, 11, or 12 hours, including any intervening range.

In some embodiments, the molten metal carbide reactor is operated at a solid-phase residence time selected from about 15 minutes to about 24 hours, such as from about 1 hour minutes to about 12 hours. In various embodiments, the vapor-phase residence time is about, at least about, or at most about 0.5, 1, 2, 3, 4, 5, 6, 7, 8, 9, 10, 11, 12, 13, 14, 15, 16, 17, 18, 19, 20, 21, 22, 23, or 24 hours, including any intervening range.

Various flow patterns can be independently employed in the first and second reaction zones. In some embodiments, a continuous plug-flow profile exists in the first reaction zone and/or the second reaction zone. In some embodiments, a well-mixed flow pattern exists in the first reaction zone and/or the second reaction zone. A hybrid between plug flow and well-mixed flow can be employed in the first reaction zone and/or the second reaction zone. In some embodiments employing induction heating, a high-frequency magnetic field can enhance the mixing within the molten metal carbide reactor.

Optionally, internal flow bumps are used in the first reaction zone and/or the second reaction zone, to assist in the control of the solid-phase residence times and/or to adjust the flow pattern within the molten metal carbide reactor. Internal flow bumps are physical elements disposed within a reaction vessel, usually at the reactor walls, that disrupt the flow of material as it travels in the average flow direction. Internal flow bumps can increase the solid-phase residence time. Internal flow bumps can increase local Reynolds number, which can induce turbulent flow rather than laminar flow, thereby enhancing heat transfer and mass transfer within the reactor.

An inert gas can be introduced to the first reaction zone and/or the second reaction zone. Exemplary inert gases are nitrogen (N₂), argon, and helium. At temperatures exceeding about 1500° C., nitrogen can react with carbon to form cyanide compounds. In some embodiments employing inert gases, an inert gas other than N₂ is employed.

In some embodiments, the recycled biographite is recycled to the first reaction zone of the molten metal carbide reactor. In some embodiments, the recycled biographite is recycled to the second reaction zone of the molten metal carbide reactor. In certain embodiments, the recycled biographite is recycled to both the first and second reaction zones.

In some embodiments, the recycled biographite is first mixed with the biocarbon-containing feedstock and the metal-containing species to form a feed mixture, and then the feed mixture is conveyed to the first reaction zone of the molten metal carbide reactor.

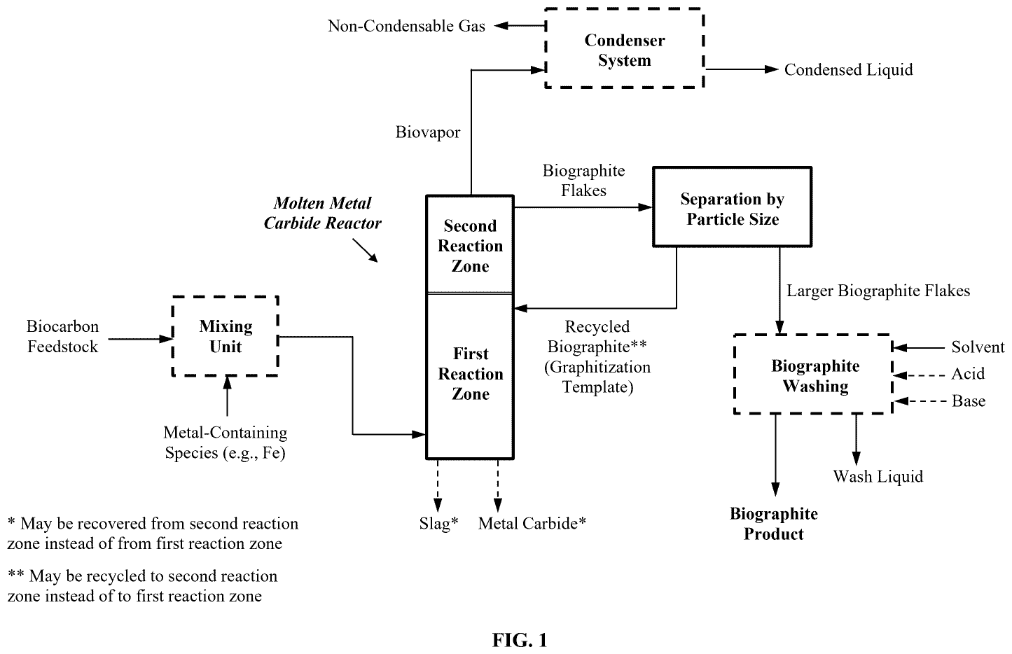

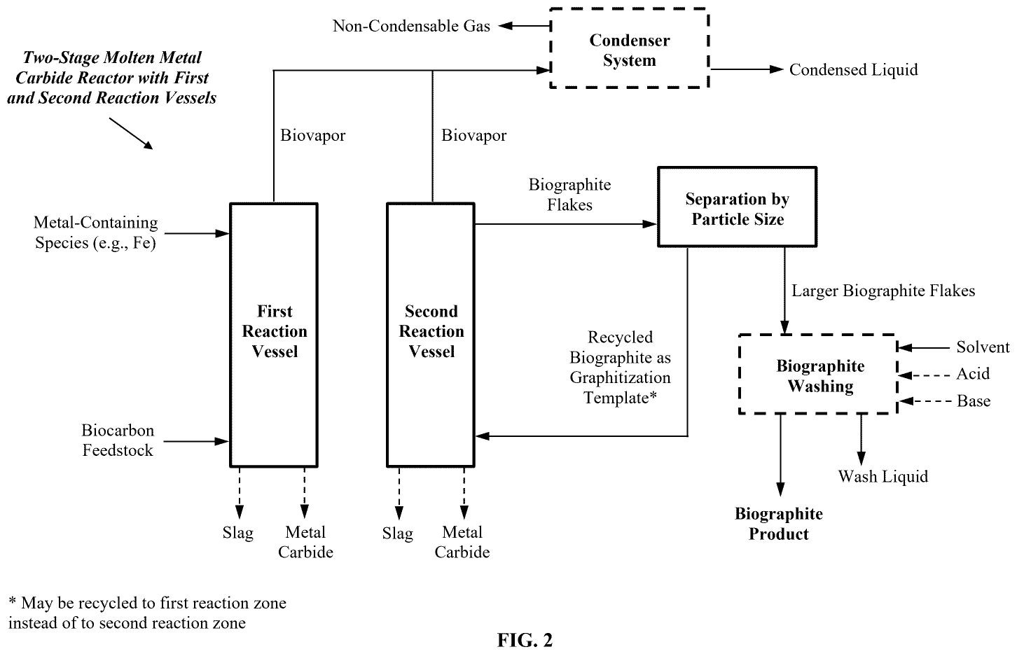

As shown in FIGS. 1 and 2, an optional mixing unit is used to mix the biocarbon feedstock and the metal-containing species. When a mixing unit is employed, various types of mixing units can be employed, such as container mixers, static mixers, dynamic mixers, agitated tanks, or homogenizers. The temperature of the mixing unit can be selected from about 25° C. to about 200° C., such as from about 50° C. to about 150° C., for example.

In some embodiments, from about 10% to about 80% by mass of the biographite from step (e) is recycled as recycled biographite in step (f). In certain embodiments, from about 20% to about 50% by mass of the biographite from step (e) is recycled as recycled biographite in step (f). In various embodiments, the percentage of biographite from step (e) that is recycled to step (f) is about, at least about, or at most about 5%, 10%, 15%, 20%, 25%, 30%, 35%, 40%, 45%, 50%, 55%, 60%, 65%, 70%, 75%, 80%, 85%, 90%, or 95%, including any intervening range. These are steady-state biographite recycle fractions, it being understood that during start-up, shutdown, or other transient operations, there can be no recycle, complete recycle, or any amount of recycle between such extremes. Also, it is possible that no biographite from step (e) is recycled to step (f), but biographite recovered from another process is used instead.

In some embodiments, step (f) comprises recycling on the basis of biographite particle size. The recycled biographite can have a smaller average particle size compared to the biographite that is not recycled, for example. Various size cut-offs can be employed, such as about 100 microns in effective particle size, as just one example. In this illustrative example, biographite particles (e.g., flakes) that are about 100 microns or larger pass to the washing step or to other product treatment or containment, while particles smaller than 100 microns serve as recycled biographite to template (nucleate and/or catalyze) the graphitization chemistry.

In some embodiments, at least a portion of the metal carbide present in the first reaction zone is recovered from the first reaction zone of the molten metal carbide reactor. In some embodiments, at least a portion of the metal carbide present in the first reaction zone is recovered from the second reaction zone of the molten metal carbide reactor. In certain embodiments, at least a portion of the metal carbide present in the first reaction zone is recovered from both the first and second reaction zones. In various embodiments, the percentage of metal carbide present in the first reaction zone that is recovered is about, at least about, or at most about 0%, 10%, 20%, 30%, 40%, 50%, 60%, 70%, 80%, 90%, or 100%, including any intervening range. In some instances, metal carbide preferably does not build up at steady state in the molten metal carbide reactor. Depending on the choice of metal carbide, the nature of the biocarbon feedstock, the nature of the metal-containing species added, the reactor conditions, and consequent reaction kinetics, it can be necessary to continuously remove some amount of metal carbide from the reactor. In other cases, it is necessary to continuously add make-up metal carbide, and/or continuously add a make-up metal-containing species that converts to metal carbide in the reactor. In still other cases, a steady state can be reached in which the rate of metal carbide added or formed within the reactor equals the rate at which metal carbide is consumed or leaves the reactor, in which case there is a steady-state, constant-volume pool of metal carbide in the reactor. A skilled chemical engineer can simulate the chemistry and flows of the system to predict the steady-state mass balance.

When metal carbide is recovered from the molten metal carbide reactor, optionally at least a portion of the recovered metal carbide is recycled to the first reaction zone. The recycled biographite and the metal carbide to be recycled can be first mixed with the biocarbon-containing feedstock and possibly another metal-containing species to form a feed mixture, which is then conveyed to the first reaction zone of the molten metal carbide reactor.

In some embodiments, during step (d), slag is formed from the metal-containing species and/or the biocarbon feedstock. Slag is typically formed, but not necessarily. Slag formation can potentially be avoided when pure iron (no iron oxide) and pure biocarbon (no ash) are fed to the molten metal carbide reactor. When slag is formed, at least at least a portion of the slag can be recovered from the first reaction zone and/or the second reaction zone of the molten metal carbide reactor.

In certain embodiments, a slag-formation additive is added to the first reaction zone and/or the second reaction zone. A slag-formation additive can clean carbon particles from metal carbide residues and/or can reduce acid requirements in a downstream acid leaching step, for example. Exemplary slag-formation additives include alumina, silica, aluminosilicates, magnesium oxide, calcium oxide, calcium fluoride, potassium carbonate, or a combination thereof.

In some embodiments, the process further comprises feeding a reducing gas into the molten metal carbide reactor, wherein the reducing gas contains H₂ and/or CO. In some embodiments, the reducing gas comprises H₂. In some embodiments, the reducing gas comprises CO. Other components can be present in the reducing gas, such as CH₄ and N₂. Sources and uses of reducing gas are discussed later in this specification.

In some embodiments, the process further comprises washing the biographite. Washing can employ an acid wash, a caustic wash, or a sequential combination thereof (in either order). An acid wash can employ an organic acid (e.g., acetic acid or formic acid) or an inorganic acid (e.g., HCl, H₂SO₄, HNO₄, and/or HF). A caustic wash can employ NaOH, KOH, NH₄OH, or K₂CO₃, for example.

In some embodiments, the process further comprises drying or calcining the biographite. When acid washing is employed, the acid washing typically occurs first, before drying/calcining. Acid washing removes metal residues, which opens pores. Calcining after washing closes some of the pores created during acid washing. This pore-closing action can be important for very high-quality graphite.

Drying the biographite can be performed at a temperature selected from about 100° C. to about 500° C., for example, to remove water. In various embodiments, the drying temperature is about, at least about, or at most about 100° C., 150° C., 200° C., 250° C., 300° C., 350° C., 400° C., 450° C., or 500° C., including any intervening range.

Calcining the biographite can be performed at a temperature selected from about 250° C. to about 1500° C., such as from about 500° C. to about 1000° C. In various embodiments, the calcining temperature is about, at least about, or at most about 250° C., 300° C., 350° C., 400° C., 450° C., 500° C., 600° C., 700° C., 800° C., 900° C., 1000° C., 1100° C., 1200° C., 1300° C., 1400° C., or 1500° C., including any intervening range.

In some embodiments, drying is performed in a dryer, followed by calcining in a calcining unit (e.g., a rotary calciner/kiln). In other embodiments, no separate dryer is employed; instead, the optionally washed biographite is introduced directly into a calcining unit. It will be recognized that within the calciner, some drying can first occur (evolution of water) followed by biographite calcining.

The process can be operated continuously or semi-continuously. Alternatively, the process can be operated in batch. Reaction steps can be operated in batch with intermediate collection and introduction of materials, to simulate a continuous process, if desired. In a semi-continuous process, at least one stream is intermittently injected or withdrawn from a process unit, such as the molten metal carbide reactor.

In some embodiments (e.g., FIG. 1), the first reaction zone and the second reaction zone are physically contained within a single reaction vessel.

In other embodiments (e.g., FIG. 2), the first reaction zone is physically contained in a first reaction vessel, and the second reaction zone is physically contained in a second reaction vessel. In some of these two-stage embodiments, contents of the first reaction vessel are continuously or semi-continuously conveyed to the second reaction vessel. Alternatively, or additionally, contents of the second reaction vessel can be continuously or semi-continuously conveyed back to the first reaction vessel. In can be preferable that little or none of the biographite goes directly back to the first reaction vessel, but rather is recovered from the second reaction vessel. A certain fraction of recycled biographite (e.g., small particles) can be recycled back to the second vessel, as shown in FIG. 2.

In some embodiments, in step (c), the biocarbon feedstock and the metal-containing species are fed into the reactor, or into the first reaction vessel in a two-stage system, such that there is cocurrent flow of the biocarbon feedstock and the metal-containing species. Cocurrent flow is implied in FIG. 1, since a mixture of biocarbon feedstock and metal-containing species is fed near the bottom of the reactor. However, in other embodiments, the biocarbon feedstock and the metal-containing species are not mixed but rather fed at separate locations into the reactor, such as the biocarbon feedstock being fed at or near the bottom of the reactor, while the metal-containing species is fed at or near the top of the reactor.

In some embodiments, in step (c), the biocarbon feedstock and the metal-containing species are fed into the first reaction vessel such that there is countercurrent flow of the biocarbon feedstock and the metal-containing species. Countercurrent flow is implied in FIG. 2, since the biocarbon feedstock is fed near the bottom of the first reaction vessel, while the metal-containing species is fed near the top of the first reaction vessel. Countercurrent flow can have a beneficial impact on the biographite formation chemistry.

In some embodiments, the biographite is at least 90% renewable, according to a measurement of the ¹⁴C/¹²C isotopic ratio of the biographite. In certain embodiments, the biographite product is 100% renewable, according to a measurement of the ¹⁴C/¹²C isotopic ratio of the biographite. In various embodiments, the biographite is at least about 80%, 85%, 90%, 91%, 92%, 93%, 94%, 95%, 96%, 97%, 98%, 99%, 99.5%, 99.9%, or 100% (fully) according to a measurement of the ¹⁴C/¹²C isotopic ratio of the biographite.

Chung, Engineering Materials for Technological Needs, Vol. 3, Carbon Materials: Science and Applications, World Scientific Publishing Co., Hackensack, New Jersey, USA, 2019 (hereinafter, “Chung”) is hereby incorporated by reference herein.

The biographite can be monocrystalline or polycrystalline. That is, in a single biographite particle (e.g., flake), there can be a single graphite crystal, or more typically, there are multiple graphite crystals. In a polycrystalline biographite material, there are multiple graphite crystallites that are oriented in various directions, but there is good alignment of carbon layers within one of the crystals.

Amorphous regions within the biographite product can be turbostratic carbon, which is layered but not crystalline. Turbostratic carbon has multiple carbon layers but they do not have 3D periodicity, and thus are not classified as crystalline. Amorphous regions within the biographite material can be fully amorphous with no layering or ordering.

Amorphous carbon is sp³-hybridized, while perfect graphite crystals are sp²-hybridized. The biographite product provided in this disclosure can have various percentages of sp² carbon, such as from about 50% to 100%, or from about 60% to about 90%. The percentage of sp² carbon is calculated as the percentage of carbon atoms that are bonded to other carbon atoms via sp²-hybridized bonds. In various embodiments, the biographite product is characterized by a percentage of sp² carbon of about, at least about, or at most about 50%, 55%, 60%, 65%, 70%, 75%, 80%, 85%, 90%, 95%, or 99%, including any intervening range. The percentage of sp² carbon can be determined by x-ray photoelectron spectroscopy, Raman spectroscopy, the plasmon energy technique, near-edge x-ray absorption spectroscopy, or electron energy-loss spectroscopy, for example.

In some embodiments, the biographite is recovered in the form of a biographite product that contains at least 80 wt % crystalline graphite according to spectroscopy. In certain embodiments, the biographite product contains at least 90 wt % crystalline graphite according to spectroscopy. Spectroscopic techniques for determining graphite crystallinity are discussed later in the specification. In various embodiments, the biographite product contains about, at least about, or at most about 50%, 55%, 60%, 65%, 70%, 75%, 80%, 85%, 90%, 95%, or 99% crystalline graphite according to spectroscopy, including any intervening range (e.g., 80-95%). The spectroscopy used to determine crystallinity can be selected from x-ray photoelectron spectroscopy, Raman spectroscopy, near-edge x-ray absorption spectroscopy, or electron energy-loss spectroscopy, for example.

In some embodiments, the process further comprising fabricating an electrode containing the biographite. The electrode can be a metal-making electrode, such as an electrode utilized in electric arc furnace metal production, for example. The electrode can be a battery electrode.

The process can further comprise fabricating an object, other than an electrode, from the biographite. The object can be a structural object (e.g., an engineered element), since graphite has good mechanical properties for some applications. The object can be a pellet, such as for metal-making (e.g., to replace metallurgical coke). The object can be formed for coke replacement in any commercial application of traditional coke or petroleum coke.

Other potential uses of biographite include, but are by no means limited to, polymer composites, electronic packaging, device cooling substrates, gaskets, filters, cement additives, neutron moderators in nuclear reactors, renewable pencil lead, and medical devices, to name just a few commercial applications.

Biographite has a unique combination of chemical, thermal, mechanical, electrical, and electrochemical properties. Biographite is electrically conductive and thermally conductive, and has a low coefficient of thermal expansion. Biographite is mechanically strong within the plane of a graphite layer. The biographite layers are weakly bonded together via Van der Waals forces, allowing the layers to slide-making graphite a good solid lubricant.

Biographite layers can be intercalated with other elements or compounds (besides carbon), which is very useful in battery chemistry, among other applications. Intercalation elements can be Li, Na, K, Rb, Cs, F, Cl, Br, and I, or combinations thereof (e.g., IBr), for example. Intercalation compounds can be NH₃, H₃PO₄, H₂SO₄, FeCl₃, and HNO₃, for example.

The biographite can be converted to biographite oxide, in which oxygen-containing functional groups are bonded to some of the carbon atoms. Oxygen-containing functional groups can be selected from —OH, —COOH, C—O—C(epoxide), or C═O, for example.

The biographite can be exfoliated. Intercalated compounds can enhance the exfoliation process, forming graphite flakes. In some embodiments, an intercalation compound vaporizes during treatment, forming gas pockets that expand and assist the exfoliation process.

The biographite can be converted into biographene. For example, intercalated biographite can be mechanically disintegrated (e.g., sonicated) into biographene. Biographene is by definition a single layer of 3D biographite, which is also referred to as single-layer biographene to distinguish from few-layer biographene that contains up to ten layers. When the number of layers exceeds 10, the material is biographite, rather than few-layer biographene.

Biographene can be used in applications that require high specific surface area, such as adsorption or filtration, for which activated carbon is conventionally used. The theoretical specific surface area of biographene is 2630 m²/g according to Chung. Biographene can be used as a semiconductor, and can be doped with various types of semiconductor dopants. Biographene can be functionalized with oxygen to make biographene oxide, for example. Single-layer biographene can be used in applications requiring optical transparency. For example, biographene's combination of optical transparency and electrical conductivity is attractive for transparent optic devices, e.g., in solar cells. Other applications of biographene include, but are by no means limited to, biographene paper, biographene fibers and fabrics, biographene foams, biographene inks, biographene quantum dots (e.g., for quantum computers), and biographene-containing polymer composites, to name just a few applications.

Other variations provide a biographite product produced by a process comprising:
(a) providing a biocarbon-containing feedstock;
(b) providing a metal-containing species that comprises a selected metal element, wherein the metal-containing species is a metal carbide or is capable of forming a metal carbide;
(c) feeding the biocarbon feedstock and the metal-containing species into a molten metal carbide reactor having a first reaction zone and a second reaction zone, wherein the first reaction zone is operated at a first-zone temperature selected to achieve a molten state comprising the metal carbide within the first reaction zone, and wherein the second reaction zone is operated at a second-zone temperature that is lower than the first-zone temperature;
(d) operating the molten metal carbide reactor to dissolve carbon from the biocarbon feedstock in the molten state, thereby generating dissolved carbon, and to produce biographite from the dissolved carbon in the second reaction zone;
(e) recovering and optionally further processing the biographite, to generate a biographite product; and
(f) recycling a portion of the biographite to the molten metal carbide reactor as recycled biographite, wherein the recycled biographite functions as a graphitization template to enhance formation of the biographite from the dissolved carbon.

In some products, the biographite product is at least 90% renewable, according to a measurement of the ¹⁴C/¹²C isotopic ratio of the biographite. In certain products, the biographite product is 100% renewable, according to a measurement of the ¹⁴C/¹²C isotopic ratio of the biographite. In various embodiments, the biographite product is at least about 80%, 85%, 90%, 91%, 92%, 93%, 94%, 95%, 96%, 97%, 98%, 99%, 99.5%, 99.9%, or 100% (fully) according to a measurement of the ¹⁴C/¹²C isotopic ratio of the biographite.

In some products, the biographite product contains at least 80 wt % crystalline graphite according to spectroscopy. In certain products, the biographite product contains at least 90 wt % crystalline graphite according to spectroscopy. In various embodiments, the biographite product contains about, at least about, or at most about 50%, 55%, 60%, 65%, 70%, 75%, 80%, 85%, 90%, 95%, or 99% crystalline graphite according to spectroscopy, including any intervening range (e.g., 75-90%).

Some embodiments provide an electrode containing the biographite product as disclosed. The electrode can be a metal-making electrode. An exemplary metal-making electrode is one that is utilized in electric arc furnace metal production, to fabricate iron, ferroalloys, aluminum, or titanium, for example. The electrode can be a battery electrode, such as (but not limited to) a lithium-ion battery electrode.

Other variations provide a one-stage system for producing biographite, wherein the one-stage system is configured to carry out the disclosed process, and wherein the first reaction zone and the second reaction zone are physically contained within a single reaction vessel. FIG. 1 is a simplified process and system block-flow diagram depicting some variations of the invention to produce biographite from a biocarbon-containing feedstock, utilizing a molten metal carbide reactor containing multiple reaction zones.

Other variations provide a two-stage system for producing biographite, wherein the two-stage system is configured to carry out the disclosed process, wherein the first reaction zone is physically contained in a first reaction vessel, and wherein the second reaction zone is physically contained in a second reaction vessel. FIG. 2 is a simplified process and system block-flow diagram depicting some variations of the invention to produce biographite from a biocarbon-containing feedstock, utilizing a two-stage molten metal carbide reactor configured as multiple reaction vessels.

When a two-stage system is used, there are two physically distinct reaction vessels that function as distinct reaction zones. When a one-stage system is used, there can be a physical feature within the reactor that delineates the first zone from the second zone. For example, an interface between the first and second zones can be defined by an inlet of recycled biographite. The interface between the first and second zones can be observable by a different arrangement of heating means to enable the second reaction zone to be at a lower temperature than the first reaction zone; e.g., the heat-exchange surface area (whether an internal heat exchanger or an external heat exchanger) can be different in the first zone compared to the second zone. In certain embodiments, the interface between the first and second zones is defined as the point in the reactor at which the local temperature, along the temperature gradient, is that temperature for which the rate of carbon precipitation as graphite, at its saturation concentration, exceeds the rate of carbon dissolution into the melt.

Any suitable means can be used to feed the biocarbon feedstock and the metal-containing species into the molten metal carbide reactor. For example, an auger (screw-type feeder) can be used as the feeding means. An extruder can be used as the feeding means. A slurry addition device can be used, in which the metal-containing species is contained as a slurry within a liquid biocarbon feedstock, or as a solid biocarbon feedstock along with a solvent, or as a biocarbon feedstock in a molten form of the metal-containing species, for example. Another feeding means utilizes pneumatic gas injection, in which the biocarbon feedstock is injected as a finely ground powder or small particles using a gas (e.g., N₂, Ar, a reducing gas containing H₂ and/or CO, or a combination thereof), and the metal-containing species (e.g., recycled metal carbide) is also injected as a solid powder or small particles. Combinations of feeding means can be used, especially when the biocarbon feedstock and the metal-containing species are introduced separately, such as to first and second reaction vessels that are physically distinct.

In certain embodiments, the system(s) for injection of biocarbon feedstock and metal-containing species can be cooled during operation, due to heat transfer from the high-temperature first reaction zone.

In some embodiments, the bioliquid feedstock is obtained from condensing and optionally fractionating a pyrolysis vapor from biomass pyrolysis. Condensing the pyrolysis vapor is performed using a condenser system, which can employ a single-stage condenser or a multiple-stage condenser. When fractionation is employed, the fractionation can be applied to the pyrolysis vapor, the condensed liquid, or both of these. Fractionation can separate according to molecular weight, boiling point, polarity, water content, or a combination thereof.

In some embodiments, the condenser system is a thermally controlled multiple-stage separation system configured to capture multiple liquid fractions. The multiple liquid fractions can be separated according to molecular weight, boiling point, polarity, water content, or a combination thereof, for example. The condensate can include at least two of the multiple liquid fractions in recombined form. In certain embodiments, at least one of the multiple liquid fractions is recovered as a light co-product that does not form part of the condensate.

In some embodiments, the bioliquid feedstock includes a condensate stream obtained from condensing a vapor released from the molten metal carbide reactor, such as the condensed liquid stream depicted in FIG. 1 or FIG. 2.

In some embodiments, the bioliquid feedstock is an external feedstock from a variety of sources. The bioliquid feedstock can be obtained from an adjacent biorefinery, or can be obtained commercially and transported to the process site. The bioliquid feedstock can be a crude bioliquid or a purified bioliquid. The bioliquid feedstock can contain lignin, lignin derivatives, sugars, sugar derivatives, and sugar degradation products (e.g., furfural), for example. In certain embodiments, the bioliquid feedstock contains aromatic groups, since aromatics are typically more carbon-rich than olefins, alkanes, alcohols, and organic acids. In some embodiments, the bioliquid feedstock contains polyphenols.

When the bioliquid feedstock is obtained from an external source, the external source can be a site that carries out any of the processes disclosed herein. The external source can be a commercial chemical company. The external source can be a biorefinery that produces a lignin or lignin-derived co-product. The lignin can be obtained from a biorefinery plant that uses pyrolysis, gasification, acid hydrolysis, enzymatic hydrolysis, chemical pulping, mechanical pulping, thermochemical pulping, or other process. Another external source of a bioliquid feedstock can be a food or nutraceutical manufacturing plant, such as one processing blueberries, plums, cherries, apples, strawberries, black currants, black olives, dark chocolate, black tea, coffee, hazelnuts, or pecans, all of which are relatively rich in polyphenols. Another external source of a polyphenolic material can be a natural-dye manufacturing plant.

The bioliquid feedstock can contain, on a dry basis, from about 20 wt % to about 90 wt % carbon, such as from about 30 wt % to about 75 wt % carbon, or from about 40 wt % to about 60 wt % carbon. The bioliquid feedstock can be water-free or can contain water in a concentration from about 0.1 wt % to about 50 wt % water, such as from about 1 wt % to about 20 wt % water, for example.

As stated above, in some embodiments, a reducing gas is introduced to the molten metal carbide reactor. In some embodiments, the reducing gas is obtained from collecting and optionally fractionating and/or treating a non-condensable gas stream from biomass pyrolysis. For instance, when the non-condensable gas stream contains H₂, that hydrogen can be separated out and used as a reducing gas. Water-gas shift chemistry can be applied to the non-condensable gas stream to adjust the H₂/CO ratio in the reducing gas, for example.

In some embodiments, the reducing gas contains at least some H₂. The H₂ can cause hydrodeoxygenation of oxygen-containing molecules of the bioliquid feedstock, removing oxygen to generate carbon-rich molecules along with H₂O. A portion of the H₂ can react with organics within the biocarbon feedstock or within reaction intermediates. The reaction of the H₂ with the organics can assist formation of ordered polycyclic aromatic structures, enhancing the final yield and/or quality of the biographite product.

In some embodiments, the reducing gas contains at least some CO. The CO can cause deoxygenation of oxygen-containing molecules of the biocarbon feedstock, removing oxygen to generate carbon-rich molecules along with CO₂. A portion of the CO can undergo a Boudouard reaction to form solid carbon. That solid carbon can be deposited as graphene-like layers, to enhance the biographite yield.

Various types of molten metal carbide reactors can be employed, including batch reactors (e.g., coke drums) and continuous reactors (e.g., screw-type reactors). In some embodiments, the molten metal carbide reactor uses the principles of a delayed coker, a fluidized coker, or a flexicoker. In certain embodiments, the molten metal carbide reactor is a screw coker reactor, which is a continuous or semi-continuous reactor utilizing a screw or auger to convey the growing biographite through the reaction zone.

A graphitization catalyst can be added to the molten metal carbide reactor. Here, a “graphitization catalyst” is distinguished from the metal carbide or from any graphitic material recycled to the reactor that serves as graphitization template. Examples of graphitization catalysts include zeolites, metal-based catalysts, metal oxide-based catalysts, and inorganic salts. If a graphitization catalyst is added to the reactor, the catalyst can remain in the final biographite, which can be acceptable due to low concentrations of catalyst. Or, the graphitization catalyst can end up in the slag component, for example.

In some embodiments, the weight ratio of the biocarbon feedstock to the metal-containing species is selected from about 0.5 to about 10, such as from about 1 to about 5. In various embodiments, the weight ratio of the biocarbon feedstock to the metal-containing species is about, at least about, or at most about 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, or 10, including any intervening range.

In this specification, “spectroscopy” refers to the measurement of spectra produced when matter (in this case, a sample of biographite product) interacts with or emits electromagnetic radiation. As is known in the graphite art, there are several spectroscopic methods that can be used to determine crystallinity of carbon. In some embodiments, crystalline graphite is determined according to X-ray diffraction (XRD). In some embodiments, crystalline graphite is determined according to Raman spectroscopy, utilizing inelastic (Raman) scattering of photons. In some embodiments, crystalline graphite is determined according to combined XRD-Raman spectroscopy. It is also possible to use thermal methods (e.g., thermogravimetric analysis) to estimate the crystallinity of carbon. Thermal methods can be used in conjunction with spectroscopy, or can be used alone, such as with a prior calibration of crystalline graphite content according to spectroscopy or against known graphite standards.

The biographite product can be at least 90% renewable, according to a measurement of the ¹⁴C/¹²C isotopic ratio of the biographite product. The biographite product can comprise at least 95%, at least 99%, or 100% (fully) renewable, according to a measurement of the ¹⁴C/¹²C isotopic ratio of the biographite product.

In certain embodiments, rather than using recycled biographite as the graphitization template, or in addition to doing so, a waste graphite material can be added to the molten metal carbide reactor. The waste graphite can be spent electrode graphite, e.g. spent lithium-ion electrode graphite. Although the originally sourced graphite can have been mined graphite and was not itself classified as renewable, using a waste material that otherwise would be destined for a landfill has environmental and economic benefits, and can qualify for certain green credits.

In some systems, the molten metal carbide reactor and downstream purification units (e.g., a washing unit) are at different site locations. For example, the molten metal carbide reactor can produce a raw biographite product at a first site. At a second site, the raw biographite product is received and washed (e.g., with a solvent, acid, and/or base) and then dried and calcined to product a final biographite product.

The system site can be the site of existing graphite production. The system site can be the site of existing electrode production. The system site can be the site of existing biocarbon production or co-production. The system site can be a greenfield or brownfield site.

The biographite product can be a renewable biographite product, according to a measurement of the ¹⁴C/¹²C isotopic ratio. The total carbon in the biographite product can be at least 50% renewable as determined from a measurement of the ¹⁴C/¹²C isotopic ratio of the total carbon. The total carbon in the biographite product can be at least 75% renewable as determined from a measurement of the ¹⁴C/¹²C isotopic ratio of the total carbon. The total carbon in the biographite product can be at least 90% renewable as determined from a measurement of the ¹⁴C/¹²C isotopic ratio of the total carbon. In various embodiments, the total carbon in the biographite product is about, or at least about 50%, 55%, 60%, 65%, 70%, 75%, 80%, 81%, 82%, 83%, 84%, 85%, 86%, 87%, 88%, 89%, 90%, 91%, 92%, 93%, 94%, 95%, 96%, 97%, 98%, 99%, 99.5%, 99.9% renewable as determined from a measurement of the ¹⁴C/¹²C isotopic ratio of the total carbon. The measurement of the ¹⁴C/¹²C isotopic ratio of the biographite product can utilize ASTM D6866, which is hereby incorporated by reference herein.

The biographite product disclosed herein can be utilized in the production of a metal product. A metal product can include one or more metals, such as iron, copper, nickel, magnesium, manganese, aluminum, tin, zinc, cobalt, chromium, tungsten, molybdenum, titanium, gold, silver, lead, silicon, lithium, boron, zirconium, vanadium, platinum, palladium, rhodium, gallium, germanium, indium, bismuth, or combinations or alloys thereof. For this disclosure, silicon is considered to be a metal.

Some embodiments provide an electrode material comprising the disclosed biographite product. Some embodiments provide an electrode containing the electrode material. The electrode can be a battery electrode or a fuel cell electrode, for example. The electrode can be an electric arc furnace electrode, such as for production of iron, steel, or another metal or metal alloy. Graphite electrodes are an essential part of the electric arc furnace (EAF) steel production process and comprise a significant portion of cost, since graphite electrodes are typically consumed every 8-12 hours in continuous EAF-based steel production.

The electrode can be used in aluminum production. Aluminum is usually produced electrolytically by using anodes and cathodes. Alumina (Al₂O₃) powder is dissolved in a molten bath of sodium aluminum fluoride. Electrical current is passed between carbon anodes and a carbon cathode in the cell, reducing alumina to aluminum (Al) metal that deposits on the cathode surface. High-purity Al is recovered from the carbon cathode. Carbon anodes are consumed in the process, generating CO₂ gas (the oxygen content of that CO₂ is from the oxygen atoms in Al₂O₃). Note that the CO₂ gas contains renewable carbon when the cathode utilizes the renewable biographite. In aluminum production, the renewable biographite product disclosed herein can be used as the cathode, anode, or both of these.

Various uses of the renewable biographite product in electrodes include applications in batteries, fuel cells, capacitors, and other energy-storage or energy-delivery devices. In a lithium-ion battery, the renewable biographite product can be used on the anode side to intercalate lithium within the graphite crystal lattice or between layers of the graphite.

Additional embodiments, variations, options, and features will now be further described, without limitation of the claimed invention.

Some embodiments utilize a biomass-containing feedstock for the production of a solid biocarbon feedstock and/or a bioliquid feedstock. For example, a biomass-containing feedstock can be subjected to biomass pyrolysis to generate biocarbon and a pyrolysis vapor, which can be condensed into a bioliquid.

In some embodiments, the biomass-containing feedstock is selected from softwood chips, hardwood chips, timber harvesting residue, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction or demolition waste, railroad ties, lignin, animal manure, municipal solid waste, municipal sewage, or a combination thereof.

The condenser system can be a thermally controlled multiple-stage separation system. In various embodiments, the thermally controlled multiple-stage separation system includes one or more filters, absorption beds with solid media, absorption beds with liquid media, adsorption beds with solid media, dry scrubbers, wet scrubbers, Venturi scrubbers, centrifuges, cyclones, quench units, reactive condensers, distillation columns, reactive-distillation columns, evaporators, reactive evaporators, heat exchangers, fan separators, electrostatic precipitators, demisters, or a combination thereof. The thermally controlled multiple-stage separation system can be configured for generating a liquid condensate and a non-condensable gas from the incoming vapor. The incoming vapor can be biovapor (exiting the molten metal carbide reactor) and/or can be a biomass pyrolysis vapor (from a pyrolysis unit not shown in FIG. 1 or 2).

In some embodiments, the thermally controlled multiple-stage separation system includes a cyclone unit configured for separating solid biocarbon-containing material from the incoming vapor, which again can be biovapor (FIG. 1 or 2) and/or biomass pyrolysis vapor.

The biocarbon feedstock can be a bioliquid that is a liquid condensate (also referred to as a condensed bioliquid). In some embodiments, a quench unit is configured for exposing an incoming vapor to water, to generate a liquid condensate. In some embodiments, the thermally controlled multiple-stage separation system includes a demister unit configured to recover residual liquid from the incoming vapor. The residual liquid is optionally combined with the liquid condensate. In some embodiments, the thermally controlled multiple-stage separation system is configured to capture multiple liquid fractions. The multiple liquid fractions can be separated according to molecular weight, boiling point, polarity, water content, or a combination thereof, for example. The liquid condensate can include at least two of the multiple liquid fractions in recombined form. In certain embodiments, at least one of the multiple liquid fractions is recovered as a light co-product that does not form part of the liquid condensate.

The condensed bioliquid can contain a polyphenolic material. In some embodiments, the polyphenolic material contains from about 20 wt % to about 80 wt % fixed carbon. In certain embodiments, the polyphenolic material contains from about 40 wt % to about 60 wt % fixed carbon. In various embodiments, the polyphenolic material contains about, at least about, or at most about 20, 25, 30, 35, 40, 45, 50, 55, 60, 65, 70, 75, or 80 wt % fixed carbon, including any intervening range.

In some embodiments, the polyphenolic material has a weight-average molecular weight M_{w} from about 75 g/mol to about 50,000 g/mol. In certain embodiments, the polyphenolic material has a M_{w} from about 75 g/mol to about 1,000 g/mol. In certain embodiments, the polyphenolic material has a M_{w} from about 1,000 g/mol to about 50,000 g/mol. In various embodiments, the polyphenolic material has a M_{w} of about, at least about, or at most about 100, 200, 300, 400, 500, 1,000, 1,500, 2,000, 2,500, 3,000, 4,000, 5,000, 10,000, 15,000, 20,000, 25,000, 30,000, 35,000, 40,000, 45,000, or 50,000 g/mol, including any intervening range. It is believed that the polyphenolic material can have a high M. due to polycondensation reactions that are thermodynamically and kinetically enhanced by the removal of water, leading to large number of monomer units within the polymer chain.

In some embodiments, the polyphenolic material has a viscosity at 25° C. from about 1 cP to about 1000 cP. In certain embodiments, the polyphenolic material has a viscosity at 25° C. from about 10 cP to about 500 cP. In various embodiments, the polyphenolic material has a viscosity at 25° C. of about, or at least about, 1, 2, 3, 4, 5, 10, 15, 20, 25, 50, 75, 100, 150, 200, 250, 300, 400, 500, 600, 700, 800, 900, or 1000 cP.

In some embodiments, the polyphenolic material contains from about 1 wt % to about 60 wt % water. This water content refers to bulk free water, as well as adsorbed water (H₂O), but not potential formation of water from —H and —OH content in the polyphenolic material. In certain embodiments, the polyphenolic material contains from about 5 wt % to about 25 wt % water. In various embodiments, the polyphenolic material contains about, at least about, or at most about 0.1, 0.5, 1, 2, 3, 4, 5, 6, 7, 8, 9, 10, 15, 20, 25, 30, 35, 40, 45, 50, 55, 60, 65, or 70 wt % water, including any intervening range. Certain embodiments utilize a polyphenolic material that is a relatively dry condensate fraction. Such polyphenolic material can contain about 5 wt % water or less, about 4 wt % water or less, about 3 wt % water or less, about 2 wt % water or less, or about 1 wt % water or less. In principle, a polyphenolic material can be recovered that contains essentially no water, such as by using molecular sieves.

In some processes, the condensed bioliquid with polyphenolic material is heated prior to contacting with recycled biographite. The condensed bioliquid can be heated to a temperature of at least about 150° C., at least about 200° C., or at least about 250° C., for example.

In some processes, the recycled biographite is heated prior to contacting with the condensed bioliquid. The recycled biographite can be controlled to be at a temperature within ±100° C. or within ±50° C. of the temperature of the applicable unit from which the biographite was recycled, prior to contacting with the condensed bioliquid. Typically, the recycled biographite slightly cools within the recycle line(s); heating can be used to maintain or increase the temperature of the solid recycled biographite.

In some embodiments, a densification unit is downstream of the molten metal carbide reactor, such as downstream of a calcination unit, to densify the calcined biographite. The densification unit can be selected from an extruder, a briquetter, a pellet mill, or a combination thereof, for example. In some embodiments, the densification unit is an extruder, such as a single-screw extruder or a twin-screw extruder.

The densification unit can be operated at a densification temperature greater than 100° C., such as at least 150° C. or at least 200° C. In various embodiments, the densification temperature is about, at least about, or at most about 100° C., 110° C., 120° C., 130° C., 140° C., 150° C., 160° C., 170° C., 180° C., 190° C., 200° C., 210° C., 220° C., 230° C., 240° C., 250° C., 260° C., 270° C., 280° C., 290° C., or 300° C., including any intervening range.

The densification unit can be operated at a densification pressure of about, at least about, or at most about 1 bar, 2 bar, 3 bar, 4 bar, 5 bar, 10 bar, 15 bar, 20 bar, 25 bar, 30 bar, 35 bar, 40 bar, 45 bar, or 50 bar, including any intervening range.

The densification unit can be operated at a densification time of about, at least about, or at most about 1 minute, 5 minutes, 10 minutes, 15 minutes, 30 minutes, or 60 minutes, including any intervening range.

In some embodiments employing calcining, calcined biographite has a moisture content from 0 wt % to about 10 wt % water. In certain embodiments, the calcined biographite has a moisture content from 0 wt % to about 5 wt % water, or from 0 wt % to about 2 wt % water, or from 0 wt % to about 1 wt % water. In certain embodiments, the calcined biographite has a moisture content from about 1 wt % to about 2 wt %. In various embodiments, the calcined biographite has a moisture content of about, or at most about, 0.01, 0.05, 0.1, 0.2, 0.5, 1, 1.5, 2, 2.5, 3, 4, 5, 6, 7, 8, 9, or 10 wt %, including any intervening range.

In some embodiments, the biographite product has an ash content from 1 wt % to about 5 wt % total ash. In certain embodiments, the biographite product has an ash content of about, or at most about, 0.1, 0.5, 1, 2, 3, 4, 5, 6, 7, 8, 9, or 10 wt % ash, including any intervening range.

The biographite product can be recovered in various forms, such as powder, particulates, pellets, briquettes, rods, cylinders, sheets, or random geometries.

In some embodiments, the biographite product is characterized by a bulk density of at least about 40 lb/ft³. In certain embodiments, the biographite product is characterized by a bulk density of at least about 50 lb/ft³. In various embodiments, the biographite product is characterized by a bulk density of about, or at least about, 40, 50, 60, 70, 80, 90, or 100 lb/ft³, including any intervening range.

In some embodiments, the biographite product is subjected to milling. The milling can utilize a mechanical-treatment apparatus selected from a hammer mill, an extruder, an attrition mill, a disc mill, a pin mill, a ball mill, a cone crusher, a jaw crusher, or a combination thereof.

In some embodiments, the biographite product is blended with an additive. Blending can utilize a relatively simple apparatus selected from a tumbler, a convective blender, a hopper blender, a fluidization mixer, or a combination thereof. Alternatively, or additionally, blending can utilize a mechanical-treatment apparatus selected from a hammer mill, an extruder, an attrition mill, a disc mill, a pin mill, a ball mill, a cone crusher, a jaw crusher, or a combination thereof.

When pellets of biographite are desired, a pelletization unit can be employed downstream of a calcination unit, for example. The pelletization unit can be selected from an extruder, a ring die pellet mill, a flat die pellet mill, a roll compactor, a roll briquetter, a wet agglomeration mill, a dry agglomeration mill, or a combination thereof.

When the biographite product is in the form of pellets, for some applications, mechanical durability is important. In some embodiments, the biographite product is in the form of pellets characterized by a pellet compressive strength at 25° C. of at least about 100 lbf/in². In certain embodiments, the pellets are characterized by a pellet compressive strength at 25° C. of at least about 200 lbf/in². In various embodiments, the pellets are characterized by a pellet compressive strength at 25° C. of about, or at least about, 50, 75, 100, 125, 150, 175, 200, 225, 250, 275, or 300 lbf/in², including any intervening range. The units of lbf/in² (psi) are pound-force per square inch. The pellet compressive strength is calculated as compression force at pellet breakage divided by lateral area of the pellet. The lateral area of the pellet is the area along the length of the pellet that is exposed to the compressive force, and not counting the pellet sides that are not exposed to the compressive force. In the case of a perfectly spherical pellet, the lateral area is the sphere surface area. In the case of a cylindrical pellet, the lateral area is the area along the length of the cylinder, and does not include the area at the two ends of the cylinder. The pellet compressive strength can be measured using a laboratory tensile and compression load tester, for example. Pellet breakage is also known as pellet rupture or pellet crushing and can be automatically detected by the laboratory tensile and compression load tester.

The pellet compressive strength can also be measured after thermal exposure, which can be important to understand the mechanical durability of a biographite pellet in high-temperature use. For example, the pellet compressive strength can also be measured after thermal exposure at 900° C. for 20 minutes in a low-oxygen environment. The pellet compressive strength after thermal exposure can be measured using a laboratory tensile and compression load tester, for example, after the test sample has cooled back down to room temperature (about 25° C.). In some embodiments, the pellet compressive strength after 20 minutes at 900° C. is at least about 30 lbf/in², or at least about 60 lbf/in², measured after cooling back down to 25° C. In various embodiments, the pellet compressive strength after 20 minutes at 900° C. is about, or at least about 10, 20, 30, 40, 50, 60, 70, 80, or 90 lbf/in², including any intervening ranges.

In some embodiments of a biographite pellet, the pellet has a pellet shape selected from a sphere, a cylinder, a cube, an octagon, a hexagon, a honeycomb, an oval, a column, a bar, a pillow, a lentil, a random granular, or a combination thereof.

In some embodiments of a biographite pellet, the pellet has a pellet size selected from about 1 mm to about 10 cm, calculated as effective diameter of the biocarbon pellet. In various embodiments, the biocarbon pellet has an effective diameter of about, at least about, or at most about 1 mm, 2 mm, 3 mm, 4 mm, 5 mm, 6 mm, 7 mm, 8 mm, 9 mm, 10 mm, 15 mm, 2 cm, 3 cm, 4 cm, 5 cm, 6 cm, 7 cm, 8 cm, 9 cm, or 10 cm, including any intervening range.

In some embodiments of a biographite pellet, the pellet is characterized by a low odor according to ASTM D1296. Another relevant odor test can be employed, including a simple qualitative test for odor. An olfactometer can be utilized to measure odor.

In some embodiments of a biographite pellet, the pellet is characterized as non-self-heating when subjected to a self-heating test according to Manual of Tests and Criteria, Seventh revised edition 2019, United Nations, Page 375, 33.4.6 Test N.4: “Test method for self-heating substances”.

In some embodiments of a biographite pellet, a pellet binder is employed. For example, a pelletization unit can be downstream of a calcination unit, to receive the calcined biographite and also receive a pellet binder, and to generate biographite pellets. The pellet binder, when present, can be selected from starch, thermoplastic starch, crosslinked starch, starch polymers, cellulose, cellulose ethers, hemicellulose, methylcellulose, chitosan, lignin, lactose, sucrose, dextrose, maltodextrin, banana flour, wheat flour, wheat starch, soy flour, corn flour, wood flour, coal tars, coal fines, met coke, asphalt, coal-tar pitch, petroleum pitch, bitumen, pyrolysis tars, gilsonite, bentonite clay, borax, limestone, lime, waxes, vegetable waxes, baking soda, baking powder, sodium hydroxide, potassium hydroxide, iron ore concentrate, silica fume, gypsum, Portland cement, guar gum, xanthan gum, polyvidones, polyacrylamides, polylactides, phenol-formaldehyde resins, vegetable resins, recycled shingles, recycled tires, recycled cardboard, recycled paper, derivatives thereof, or any combination of the foregoing.

In some embodiments, a pellet binder is selected from starch, thermoplastic starch, crosslinked starch, starch polymers, derivatives thereof, or any combinations of the foregoing. The pellet binder can be a thermoplastic starch that is optionally crosslinked. The thermoplastic starch can be a reaction product of starch and a polyol. The polyol can be selected from ethylene glycol, propylene glycol, glycerol, butanediols, butanetriols, erythritol, xylitol, sorbitol, or a combination thereof. The reaction product can be formed from a reaction that is catalyzed by an acid. The acid can be selected from formic acid, acetic acid, lactic acid, citric acid, oxalic acid, uronic acids, glucuronic acids, or a combination thereof. Alternatively, the reaction product can be formed from a reaction that is catalyzed by a base.

The biographite pellets can have a Hardgrove Grindability Index (HGI) of at least about 30, at least about 40, or at least about 50. In various embodiments, the pellets have a Hardgrove Grindability Index from about 30 to about 100. In various embodiments, the pellets have a Hardgrove Grindability Index of about, at least about, or at most about 20, 30, 40, 50, 60, 70, 80, 90, 100, 110, or 120, including any intervening ranges. ASTM-Standard D 409/D 409M for “Standard Test Method for Grindability of Coal by the Hardgrove-Machine Method” is hereby incorporated by reference herein in its entirety. Unless otherwise indicated, all references in this disclosure to Hardgrove Grindability Index or HGI are in reference to ASTM-Standard D 409/D 409M.

The biographite pellets can have a Pellet Durability Index (PDI) of at least about 80%, at least about 85%, at least about 90%, or at least about 95%. In various embodiments, the pellet have a Pellet Durability Index of about, at least about, or at most about 70%, 75%, 80%, 85%, 90%, 91%, 92%, 93%, 94%, 95%, 96%, 97%, 98%, or 99%, including any intervening ranges. Unless otherwise indicated, all references in this disclosure to Pellet Durability Index are in reference to ISO 17831-1:2015 “Solid biofuels Determination of mechanical durability of pellets and briquettes—Part 1: Pellets”, which is hereby incorporated by reference herein in its entirety.

The biographite product can contain one or more additives for various purposes, such as for reduced flammability. The biographite product can be characterized as non-self-heating when subjected to a self-heating test according to Manual of Tests and Criteria, Seventh revised edition 2019, United Nations, Page 375, 33.4.6 Test N.4: “Test method for self-heating substances”, which is hereby incorporated by reference herein.

In various embodiments, the concentration of additives within the biographite product can be about, at least about, or at most about, 0, 1, 2, 3, 4, 5, 6, 7, 8, 9, 10, 15, 20, 25, 30, 35, 40, 45 or 50 wt %, including any intervening range. When additives are employed, the additives do not need to be uniformly distributed throughout the biographite composition.

Additives can be introduced at any point in the process. In some embodiments, the additive type and/or concentration are selected to optimize electronic conductivity associated with the biographite product. In some embodiments, the additive type and/or concentration are selected to optimize ionic conductivity associated with the biographite product. In some embodiments, the additive type and/or concentration are selected to optimize combined electronic-ionic conductivity associated with the biographite product. In some embodiments, the additive type and/or concentration are selected to optimize crystallinity (graphite quality) of the biographite product. In some embodiments, the additive type and/or concentration are selected to optimize energy content associated with the biographite product. In some embodiments, the additive type and/or concentration are selected to optimize bulk density associated with the biographite product. In some embodiments, the additive type and/or concentration are selected to optimize hydrophobicity associated with the biographite product. In some embodiments, the additive type and/or concentration are selected to optimize reactivity associated with the biographite product. In some embodiments, the additive type and/or concentration are selected to optimize Hardgrove Grindability Index associated with biographite product. In some embodiments, the additive type and/or concentration are selected to optimize Pellet Durability Index associated with biographite product.

Imaging and spectroscopy can be used to analyze the biographite product (whether or not in pellet form), or any process intermediates. Imaging techniques can include, but are not limited to, optical microscopy; dark-field microscopy; scanning electron microscopy (SEM); transmission electron microscopy (TEM); and X-ray tomography (XRT), for example. Spectroscopy techniques can include, but are not limited to, energy dispersive X-ray spectroscopy (EDS), X-ray fluorescence (XRF), infrared (IR) spectroscopy; and nuclear magnetic resonance (NMR) spectroscopy, for example.

### Biomass Pyrolysis

Processes and systems suitable for pyrolyzing a biomass feedstock to generate a biogenic reagent will now be further described in detail. A biogenic reagent can be the biocarbon feedstock in FIG. 1 or 2. References herein to “biocarbon reagent” will be understood, in various instances, as references to biogenic carbon or a biocarbon composition containing biogenic carbon, depending on the context. In the present disclosure, the biogenic reagent can be prepared and used in a variety of ways. The biogenic reagent can be used as a bioliquid feedstock, especially when pyrolysis conditions are selected to maximize liquid production (e.g., pyrolysis oil) relative to solid production. The biogenic reagent can be recovered and sold as a biocarbon co-product from biomass pyrolysis, while the vapor from biomass pyrolysis is condensed and used as the bioliquid feedstock. The biogenic reagent can be gasified, to generate a reducing gas that can then be fed to the molten metal carbide reactor. Combinations of the foregoing are also possible. It is also possible that no biomass pyrolysis is conducted at all-instead utilizing a biocarbon feedstock not from pyrolysis at all.

“Pyrolysis” and “pyrolyze” generally refer to thermal decomposition of a carbonaceous material. In pyrolysis, less oxygen is present than is required for complete combustion of the material, such as less than 10%, 5%, 1%, 0.5%, 0.1%, or 0.01% of the oxygen (02 molar basis) that is required for complete combustion. In some embodiments, pyrolysis is performed in the absence of oxygen.

Exemplary changes that can occur during pyrolysis include any of the following: (i) heat transfer from a heat source increases the temperature inside the feedstock; (ii) the initiation of primary pyrolysis reactions at this higher temperature releases volatiles and forms a char; (iii) the flow of hot volatiles toward cooler solids results in heat transfer between hot volatiles and cooler unpyrolyzed feedstock; (iv) condensation of some of the volatiles in the cooler parts of the feedstock, followed by secondary reactions, can produce tar; (v) autocatalytic secondary pyrolysis reactions proceed while primary pyrolytic reactions simultaneously occur in competition; and (vi) further thermal decomposition, reforming, water-gas shift reactions, free-radical recombination, and/or dehydrations can also occur, which are a function of the residence time, temperature, and pressure profile.

Pyrolysis can at least partially dehydrate a starting feedstock (e.g., lignocellulosic biomass). In various embodiments, pyrolysis removes greater than about 50%, 75%, 90%, 95%, 99%, or more of the water from the starting feedstock.

In some embodiments, a starting biomass feedstock is selected from the softwood chips, hardwood chips, timber harvesting residues, tree branches, tree stumps, leaves, bark, sawdust, corn, corn stover, wheat, wheat straw, rice, rice straw, sugarcane, sugarcane bagasse, sugarcane straw, energy cane, sugar beets, sugar beet pulp, sunflowers, sorghum, canola, algae, miscanthus, alfalfa, switchgrass, fruits, fruit shells, fruit stalks, fruit peels, fruit pits, vegetables, vegetable shells, vegetable stalks, vegetable peels, vegetable pits, grape pumice, almond shells, pecan shells, coconut shells, coffee grounds, food waste, commercial waste, grass pellets, hay pellets, wood pellets, cardboard, paper, paper pulp, paper packaging, paper trimmings, food packaging, construction and/or demolition waste, lignin, animal manure, municipal solid waste, municipal sewage, or a combination thereof. Note that typically a biomass feedstock contains at least carbon, hydrogen, and oxygen.

The biogenic reagent can comprise at least about 50 wt %, at least about 75 wt %, or at least about 90 wt % total carbon. In various embodiments, the biogenic reagent contains about, at least about, or at most about 20, 25, 30, 35, 40, 45, 50, 55, 60, 65, 70, 75, 80, 85, 90, 95, or 99 wt % carbon. The total carbon is fixed carbon plus non-fixed carbon that is present in volatile matter. In some embodiments, component weight percentages are on an absolute basis, which is assumed unless stated otherwise. In other embodiments, component weight percentages are on a moisture-free and ash-free basis.

The pyrolysis conditions can be varied widely, depending on the desired compositions for the biogenic reagent and pyrolysis off-gas, the starting feedstock, the reactor configuration, and other factors.

In some embodiments, multiple reactor zones are designed and operated in a way that optimizes carbon yield and product quality from pyrolysis, while maintaining flexibility and adjustability for feedstock variations and product requirements.

In some non-limiting embodiments, the temperatures and residence times are selected to achieve relatively slow pyrolysis chemistry. The benefit is potentially the substantial preservation of cell walls contained in the biomass structure, which means the final product can retain some, most, or all of the shape and strength of the starting biomass. In order to maximize this potential benefit, apparatus that does not mechanically destroy the cell walls or otherwise convert the biomass particles into small fines can be utilized. Certain such reactor configurations are discussed following the process description below.

Additionally, if the feedstock is a milled or sized feedstock, such as wood chips or pellets, it can be desirable for the feedstock to be carefully milled or sized. Careful initial treatment will tend to preserve the strength and cell-wall integrity that is present in the native feedstock source (e.g., trees). This can also be important when the final product should retain some, most, or all of the shape and strength of the starting biomass.

In some embodiments, a first zone of a pyrolysis reactor is configured for feeding biomass (or another carbon-containing feedstock) in a manner that does not “shock” the biomass, which would rupture the cell walls and initiate fast decomposition of the solid phase into vapors and gases. This first zone can be thought of as mild pyrolysis.

In some embodiments, a second zone of a pyrolysis reactor is configured as the primary reaction zone, in which preheated biomass undergoes pyrolysis chemistry to release gases and condensable vapors, leaving a significant amount of solid material which is a high-carbon reaction intermediate. Biomass components (primarily cellulose, hemicellulose, and lignin) decompose and create vapors, which escape by penetrating through pores or creating new nanopores. The latter effect contributes to the creation of porosity and surface area.

In some embodiments, a third zone of a pyrolysis reactor is configured for receiving the high-carbon reaction intermediate and cooling down the solids to some extent. Typically, the third zone will be a lower temperature than the second zone. In the third zone, the chemistry and mass transport can be surprisingly complex. Without being limited by any particular theory or proposed mechanisms, it is believed that secondary reactions can occur in the third zone. Essentially, carbon-containing components that are in the gas phase can decompose to form additional fixed carbon and/or become adsorbed onto the carbon. Thus, the final carbonaceous material may not simply be the solid, devolatilized residue of the processing steps, but rather can include additional carbon that has been deposited from the gas phase, such as by decomposition of organic vapors (e.g., tars) that can form carbon.

Certain embodiments extend the concept of additional carbon formation by including a separate unit in which cooled carbon is subjected to an environment including carbon-containing species, to enhance the carbon content of the final product. When the temperature of this unit is below pyrolysis temperatures, the additional carbon is expected to be in the form of adsorbed carbonaceous species, rather than additional fixed carbon.

There are a large number of options as to intermediate input and output (purge or probe) streams of one or more phases present in any particular zone, various mass and energy recycle schemes, various additives that can be introduced anywhere in the process, adjustability of process conditions including both reaction and separation conditions in order to tailor product distributions, and so on. Zone-specific input and output streams enable good process monitoring and control, such as through FTIR sampling and dynamic process adjustments.

Some embodiments do not employ fast pyrolysis, and some embodiments do not employ slow pyrolysis. Surprisingly high-quality carbon materials, including compositions with very high fractions of fixed carbon, can be obtained from the disclosed processes and systems.

In some embodiments, a pyrolysis process for producing a biogenic reagent comprises the following steps:
(a) providing a carbon-containing feedstock comprising biomass;
(b) optionally drying the feedstock to remove at least a portion of moisture contained within the feedstock;
(c) optionally deaerating the feedstock to remove at least a portion of interstitial oxygen, if any, contained with the feedstock;
(d) pyrolyzing the feedstock in the presence of a substantially inert gas phase for at least 10 minutes and with at least one temperature selected from about 250° C. to about 700° C., to generate hot pyrolyzed solids, condensable vapors, and non-condensable gases;
(e) separating at least a portion of the condensable vapors and at least a portion of the non-condensable gases from the hot pyrolyzed solids;
(f) cooling the hot pyrolyzed solids to generate cooled pyrolyzed solids; and
(g) recovering a biogenic reagent comprising at least a portion of the cooled pyrolyzed solids.

“Biomass,” for purposes of this disclosure, shall be construed as any biogenic feedstock or mixture of a biogenic and non-biogenic feedstocks. Elementally, biomass includes at least carbon, hydrogen, and oxygen. The methods and apparatus of the invention can accommodate a wide range of feedstocks of various types, sizes, and moisture contents.

Biomass includes, for example, plant and plant-derived material, vegetation, agricultural waste, forestry waste, wood waste, paper waste, animal-derived waste, poultry-derived waste, and municipal solid waste. In various embodiments of the invention utilizing biomass, the biomass feedstock can include one or more materials selected from: timber harvesting residues, softwood chips, hardwood chips, tree branches, tree stumps, knots, leaves, bark, sawdust, off-spec paper pulp, cellulose, corn, corn stover, wheat straw, rice straw, sugarcane bagasse, switchgrass, miscanthus, animal manure, municipal garbage, municipal sewage, commercial waste, grape pumice, almond shells, pecan shells, coconut shells, coffee grounds, grass pellets, hay pellets, wood pellets, cardboard, paper, carbohydrates, plastic, and cloth. A person of ordinary skill in the art will readily appreciate that the feedstock options are virtually unlimited.

Some embodiments employ carbon-containing feedstocks other than biomass, such as a fossil fuel (e.g., coal or petroleum coke), or any mixtures of biomass and fossil fuels (such as biomass/coal blends). In some embodiments, a feedstock is, or includes, coal, oil shale, crude oil, asphalt, or solids from crude-oil processing (such as petcoke). Feedstocks can include waste tires, recycled plastics, recycled paper, construction waste, deconstruction waste, and other waste or recycled materials. Carbon-containing feedstocks can be transportable by any known means, such as by truck, train, ship, barge, tractor trailer, or any other vehicle or means of conveyance.

Selection of a particular feedstock or feedstocks is not regarded as technically critical, but is carried out in a manner that tends to favor an economical process as well as a low-carbon-intensity, renewable process.

Typically, regardless of the feedstocks chosen, there can be (in some embodiments) screening to remove undesirable materials. The feedstock can optionally be dried prior to processing.

The feedstock employed can be provided or processed into a wide variety of particle sizes or shapes. For example, the feed material can be a fine powder, or a mixture of fine and coarse particles. The feed material can be in the form of large pieces of material, such as wood chips or other forms of wood (e.g., round, cylindrical, square, etc.). In some embodiments, the feed material comprises pellets or other agglomerated forms of particles that have been pressed together or otherwise bound, such as with a binder.

It is noted that size reduction is a costly and energy-intensive process. Pyrolyzed material can be sized with significantly less energy input—that is, reducing particle size of the product, and not the feedstock. This is an option in the present invention because the process does not require a fine starting material, and there is not necessarily any significant particle-size reduction during processing. The ability to process very large pieces of feedstock is a significant economic advantage of this invention. Notably, some market applications of the high-carbon product actually require large sizes (e.g., on the order of centimeters), so that in some embodiments, large pieces are fed, produced, and sold.

When it is desired to produce a final carbonaceous biogenic reagent that has structural integrity, such as in the form of cylinders, there are at least two options in the context of this invention. First, the material produced from the process can be collected and then further process mechanically into the desired form. For example, the product can be pressed or pelletized, with a binder. The second option is to utilize feed materials that generally possess the desired size and/or shape for the final product, and employ processing steps that do not destroy the basic structure of the feed material. In some embodiments, the feed and product have similar geometrical shapes, such as spheres, cylinders, or cubes.

The ability to maintain the approximate size of feed material throughout the process is beneficial when product strength is important. Also, this avoids the difficulty and cost of pelletizing high fixed-carbon materials.

The starting feed material can be provided with a range of moisture levels, as will be appreciated. In some embodiments, the feed material can already be sufficiently dry that it need not be further dried before pyrolysis. Typically, it will be desirable to utilize commercial sources of biomass which will usually contain moisture, and feed the biomass through a drying step before introduction into the pyrolysis reactor. However, in some embodiments a dried feedstock can be utilized.

It is usually desirable to provide a relatively low-oxygen environment in the pyrolysis reactor, such as about, or at most about, 10 mol %, 5 mol %, 4 mol %, 3 mol %, 2 mol %, 1.5 mol %, 1 mol %, 0.5 mol %, 0.2 mol %, 0.1 mol %, 0.05 mol %, 0.02 mol %, or 0.01 mol % O₂ in the gas phase. First, uncontrolled combustion should be avoided in the pyrolysis reactor, for safety reasons. Some amount of total carbon oxidation to CO₂ can occur, and the heat released from the exothermic oxidation can assist the endothermic pyrolysis chemistry. Large amounts of oxidation of carbon, including partial oxidation to syngas, will reduce the carbon yield to solids.

Practically speaking, it can be difficult to achieve a strictly oxygen-free environment in the reactor. This limit can be approached, and in some embodiments, the reactor is substantially free of molecular oxygen in the gas phase. To ensure that little or no oxygen is present in the pyrolysis reactor, it can be desirable to remove air from the feed material before it is introduced to the reactor. There are various ways to remove or reduce air in the feedstock.

In some embodiments, a deaeration unit is utilized in which feedstock, before or after drying, is conveyed in the presence of another gas which can remove adsorbed oxygen and penetrate the feedstock pores to remove oxygen from the pores. Essentially any gas that has lower than 21 vol % O₂ can be employed, at varying effectiveness. In some embodiments, nitrogen is employed. In some embodiments, CO and/or CO₂ is employed. Mixtures can be used, such as a mixture of nitrogen and a small amount of oxygen. Steam can be present in the deaeration gas, although adding significant moisture back to the feed should be avoided. The effluent from the deaeration unit can be purged (to the atmosphere or to an emissions treatment unit) or recycled.

In principle, the effluent (or a portion thereof) from the deaeration unit could be introduced into the pyrolysis reactor itself since the oxygen removed from the solids will now be highly diluted. In this embodiment, it can be advantageous to introduce the deaeration effluent gas to the last zone of the reactor, when it is operated in a countercurrent configuration.

Various types of deaeration units can be employed. If drying it to be performed, drying can be performed before deaerating because it can be inefficient to scrub soluble oxygen out of the moisture present. In certain embodiments, the drying and deaerating steps are combined into a single unit, or some amount of deaeration is achieved during drying, and so on.

The optionally dried and optionally deaerated feed material is introduced to a pyrolysis reactor or multiple reactors in series or parallel. The feed material can be introduced using any known means, including screw feeders or lock hoppers, for example. In some embodiments, a material feed system incorporates an air knife.

When a single reactor is employed, multiple zones c present. Multiple zones, such as two, three, four, or more zones, can allow for the separate control of temperature, solids residence time, gas residence time, gas composition, flow pattern, and/or pressure in order to adjust the overall process performance.

References to “zones” shall be broadly construed to include regions of space within a single physical unit, physically separate units, or any combination thereof. For a continuous reactor, the demarcation of zones can relate to structure, such as the presence of flights within the reactor or distinct heating elements to provide heat to separate zones. Alternatively, or additionally, the demarcation of zones in a continuous reactor can relate to function, such as distinct temperatures, fluid flow patterns, solid flow patterns, extent of reaction, and so on. In a single batch reactor, “zones” are operating regimes in time, rather than in space. Multiple batch reactors can also be used.

It will be appreciated that there are not necessarily abrupt transitions from one zone to another zone. For example, the boundary between the preheating zone and pyrolysis zone can be somewhat arbitrary; some amount of pyrolysis can take place in a portion of the preheating zone, and some amount of “preheating” can continue to take place in the pyrolysis zone. The temperature profile in the reactor is typically continuous, including at zone boundaries within the reactor.

Some embodiments employ a first zone that is operated under conditions of preheating and/or mild pyrolysis. The temperature of the first zone can be selected from about 150° C. to about 500° C., such as about 300° C. to about 400° C. The temperature of the first zone can be sufficiently low so as to not shock the biomass material, where shocking the biomass material ruptures the cell walls and initiates fast decomposition of the solid phase into vapors and gases.

All references to zone temperatures in this specification should be construed in a non-limiting way to include temperatures that can apply to the bulk solids present, or the gas phase, or the reactor walls (on the process side). It will be understood that there will be a temperature gradient in each zone, both axially and radially, as well as temporally (i.e., following start-up or due to transients). Thus, references to zone temperatures can be references to average temperatures or other effective temperatures that can influence the actual kinetics. Temperatures can be directly measured by thermocouples or other temperature probes, or indirectly measured or estimated by other means.

The second zone, or in general the primary pyrolysis zone, is operated under conditions of pyrolysis or carbonization. The temperature of the second zone can be selected from about 250° C. to about 700° C., such as about, or at least about, or at most about 300° C., 350° C., 400° C., 450° C., 500° C., 550° C., 600° C., or 650° C. Within this zone, preheated biomass undergoes pyrolysis chemistry to release gases and condensable vapors, leaving a significant amount of solid material as a high-carbon reaction intermediate. Biomass components (primarily cellulose, hemicellulose, and lignin) decompose and create vapors, which escape by penetrating through pores or creating new pores. The temperature will depend on at least the residence time of the second zone, as well as the nature of the feedstock and desired product properties.

The third zone, or cooling zone, is operated to cool down the high-carbon reaction intermediate to varying degrees. At a minimum, the temperature of the third zone should be a lower temperature than that of the second zone. The temperature of the third zone can be selected from about 100° C. to about 550° C., such as about 150° C. to about 350° C.

Chemical reactions can continue to occur in the cooling zone. Without being limited by any particular theory, it is believed that secondary pyrolysis reactions can be initiated in the third zone. Carbon-containing components that are in the gas phase can condense (due to the reduced temperature of the third zone). The temperature remains sufficiently high, however, to promote reactions that can form additional fixed carbon from the condensed liquids (secondary pyrolysis) or at least form bonds between adsorbed species and the fixed carbon. One exemplary reaction that can take place is the Boudouard reaction for conversion of carbon monoxide to carbon dioxide plus fixed carbon.

The residence times of the reactor zones can vary. There is an interplay of time and temperature, so that for a desired amount of pyrolysis, higher temperatures can allow for lower reaction times, and vice versa. The residence time in a continuous reactor (zone) is the volume divided by the volumetric flow rate. The residence time in a batch reactor is the batch reaction time, following heating to reaction temperature.

It should be recognized that in multiphase reactors, there are multiple residence times. In the present context, in each zone, there will be a residence time (and residence-time distribution) of both the solids phase and the vapor phase. For a given apparatus employing multiple zones, and with a given throughput, the residence times across the zones will generally be coupled on the solids side, but residence times can be uncoupled on the vapor side when multiple inlet and outlet ports are utilized in individual zones. The solids and vapor residence times are uncoupled.

The solids residence time of the preheating zone can be selected from about 5 min to about 60 min, such as about 10, 20, 30, 40, or 50 min. Depending on the temperature, sufficient time is desired to allow the biomass to reach a desired preheat temperature. The heat-transfer rate, which will depend on the particle type and size, the physical apparatus, and on the heating parameters, will dictate the minimum residence time necessary to allow the solids to reach a desired preheat temperature. Additional time may not be desirable as it would contribute to higher capital cost, unless some amount of mild pyrolysis is intended in the preheating zone.

The solids residence time of the pyrolysis zone can be selected from about 10 min to about 120 min, such as about 20, 30, 40, 50, 60, 70, 80, 90, or 100 min. Depending on the pyrolysis temperature in this zone, there should be sufficient time to allow the carbonization chemistry to take place, following the necessary heat transfer. For times below about 10 min, in order to remove high quantities of non-carbon elements, the temperature would need to be quite high, such as above 700° C. This temperature would promote fast pyrolysis and its generation of vapors and gases derived from the carbon itself, which is to be avoided when the intended product is solid carbon.

In a static system, there would be an equilibrium conversion that could be substantially reached at a certain time. When, as in certain embodiments, vapor is continuously flowing over solids with continuous volatiles removal, the equilibrium constraint can be removed to allow for pyrolysis and devolatilization to continue until reaction rates approach zero. Longer times would not tend to substantially alter the remaining recalcitrant solids.

The solids residence time of the cooling zone can be selected from about 5 min to about 60 min, such as about 10, 20, 30, 40, or 50 min. Depending on the cooling temperature in this zone, there should be sufficient time to allow the carbon solids to cool to the desired temperature. The cooling rate and temperature will dictate the minimum residence time necessary to allow the carbon to be cooled. Additional time may not be desirable, unless some amount of secondary pyrolysis is desired.

As discussed above, the residence time of the vapor phase can be separately selected and controlled. The vapor residence time of the preheating zone can be selected from about 0.1 min to about 15 min, such as about 0.5, 1, 2, 3, 4, 5, 6, 7, 8, 9, or 10 min. The vapor residence time of the pyrolysis zone can be selected from about 0.1 min to about 20 min, such as about 0.5, 1, 2, 3, 4, 5, 6, 7, 8, 9, 10, 11, 12, 13, 14, or 15 min. The vapor residence time of the cooling zone can be selected from about 0.1 min to about 15 min, such as about 0.5, 1, 2, 3, 4, 5, 6, 7, 8, 9, or 10 min. Short vapor residence times promote fast sweeping of volatiles out of the system, while longer vapor residence times promote reactions of components in the vapor phase with the solid phase.

The mode of operation for the reactor, and overall system, can be continuous, semi-continuous, batch, or any combination or variation of these. In some embodiments, the reactor is a continuous, countercurrent reactor in which solids and vapor flow substantially in opposite directions. The reactor can also be operated in batch but with simulated countercurrent flow of vapors, such as by periodically introducing and removing gas phases from the batch vessel.

Various flow patterns can be desired or observed. With chemical reactions and simultaneous separations involving multiple phases in multiple reactor zones, the fluid dynamics can be quite complex. Typically, the flow of solids can approach plug flow (well-mixed in the radial dimension) while the flow of vapor can approach fully mixed flow (fast transport in both radial and axial dimensions). Multiple inlet and outlet ports for vapor can contribute to overall mixing.

The pressure in each zone can be separately selected and controlled. The pressure of each zone can be independently selected from about 1 kPa to about 3000 kPa, such as about 101.3 kPa (normal atmospheric pressure). Independent zone control of pressure is possible when multiple gas inlets and outlets are used, including vacuum ports to withdraw gas when a zone pressure less than atmospheric is desired.

The process can conveniently be operated at atmospheric pressure, in some embodiments. There are many advantages associated with operation at atmospheric pressure, ranging from mechanical simplicity to enhanced safety. In certain embodiments, the pyrolysis zone is operated at a pressure of about 90 kPa, 95 kPa, 100 kPa, 101 kPa, 102 kPa, 105 kPa, or 110 kPa (absolute pressures).

Vacuum operation (e.g., 10-100 kPa) would promote fast sweeping of volatiles out of the system. Higher pressures (e.g., 100-1000 kPa) can be useful when the off-gases will be fed to a high-pressure operation. Elevated pressures can also be useful to promote heat transfer, chemistry, or separations.

The step of separating at least a portion of the condensable vapors and at least a portion of the non-condensable gases from the hot pyrolyzed solids can be accomplished in the reactor itself, or using a distinct separation unit. A substantially inert sweep gas can be introduced into one or more of the zones. Condensable vapors and non-condensable gases are then carried away from the zone(s) in the sweep gas, and out of the reactor.

The sweep gas can be N₂, Ar, CO, CO₂, H₂, H₂O, CH₄, other light hydrocarbons, or combinations thereof, for example. The sweep gas can first be preheated prior to introduction, or possibly cooled if it is obtained from a heated source.

The sweep gas more thoroughly removes volatile components, by getting them out of the system before they can condense or further react. The sweep gas allows volatiles to be removed at higher rates than would be attained merely from volatilization at a given process temperature. Or, use of the sweep gas allows milder temperatures to be used to remove a certain quantity of volatiles. The reason the sweep gas improves the volatiles removal is that the mechanism of separation is not merely relative volatility but rather liquid/vapor phase disengagement assisted by the sweep gas. The sweep gas can both reduce mass-transfer limitations of volatilization as well as reduce thermodynamic limitations by continuously depleting a given volatile species, to cause more of it to vaporize in order to attain thermodynamic equilibrium.

Some embodiments remove gases laden with volatile organic carbon from subsequent processing stages, in order to produce a product with high fixed carbon. Without removal, the volatile carbon can adsorb or absorb onto the pyrolyzed solids, thereby requiring additional energy (cost) to achieve a purer form of carbon which can be desired. By removing vapors quickly, it is also speculated that porosity can be enhanced in the pyrolyzing solids. Higher porosity is desirable for some products.

In certain embodiments, the sweep gas in conjunction with a relatively low process pressure, such as atmospheric pressure, provides for fast vapor removal without large amounts of inert gas necessary.

In some embodiments, the sweep gas flows countercurrent to the flow direction of feedstock. In other embodiments, the sweep gas flows co-current to the flow direction of feedstock. In some embodiments, the flow pattern of solids approaches plug flow while the flow pattern of the sweep gas, and gas phase generally, approaches fully mixed flow in one or more zones.

The sweep can be performed in any one or more of the reactor zones. In some embodiments, the sweep gas is introduced into the cooling zone and extracted (along with volatiles produced) from the cooling and/or pyrolysis zones. In some embodiments, the sweep gas is introduced into the pyrolysis zone and extracted from the pyrolysis and/or preheating zones. In some embodiments, the sweep gas is introduced into the preheating zone and extracted from the pyrolysis zone. In these or other embodiments, the sweep gas can be introduced into each of the preheating, pyrolysis, and cooling zones and also extracted from each of the zones.

In some embodiments, the zone or zones in which separation is carried out is a physically separate unit from the reactor. The separation unit or zone can be disposed between reactor zones, if desired. For example, there can be a separation unit placed between pyrolysis and cooling units.

The sweep gas can be introduced continuously, especially when the solids flow is continuous. When the pyrolysis reaction is operated as a batch process, the sweep gas can be introduced after a certain amount of time, or periodically, to remove volatiles. Even when the pyrolysis reaction is operated continuously, the sweep gas can be introduced semi-continuously or periodically, if desired, with suitable valves and controls.

The volatiles-containing sweep gas can exit from the one or more reactor zones, and can be combined if obtained from multiple zones. The resulting gas stream, containing various vapors, can then be fed to a thermal oxidizer for control of air emissions. Any known thermal-oxidation unit can be employed. In some embodiments, the thermal oxidizer is fed with natural gas and air, to reach sufficient temperatures for substantial destruction of volatiles contained therein.

The effluent of the thermal oxidizer will be a hot gas stream comprising water, carbon dioxide, and nitrogen. This effluent stream can be purged directly to air emissions, if desired. The energy content of the thermal oxidizer effluent can be recovered, such as in a waste-heat recovery unit. The energy content can also be recovered by heat exchange with another stream (such as the sweep gas). The energy content can be utilized by directly or indirectly heating, or assisting with heating, a unit elsewhere in the process, such as the dryer or the reactor. In some embodiments, essentially all of the thermal oxidizer effluent is employed for indirect heating (utility side) of the dryer. The thermal oxidizer can employ other fuels than natural gas.

The yield of carbonaceous material can vary, depending on the above-described factors including type of feedstock and process conditions. In some embodiments, the net yield of solids as a percentage of the starting feedstock, on a dry basis, is at least 25%, 30%, 35%, 40%, 45%, 50%, or higher. The remainder will be split between condensable vapors, such as terpenes, tars, alcohols, acids, aldehydes, or ketones; and non-condensable gases, such as carbon monoxide, hydrogen, carbon dioxide, and methane. The relative amounts of condensable vapors compared to non-condensable gases will also depend on process conditions, including the water present.

In terms of the carbon balance, in some embodiments the net yield of carbon as a percentage of starting carbon in the feedstock is at least 25%, 30%, 40%, 50%, 60%, 65%, 70%, 75%, 80%, or higher. For example, the in some embodiments the carbonaceous material contains between about 40% and about 70% of the carbon contained in the starting feedstock. The rest of the carbon results in the formation of methane, carbon monoxide, carbon dioxide, light hydrocarbons, aromatics, tars, terpenes, alcohols, acids, aldehydes, or ketones, to varying extents.

In alternative embodiments, some portion of these compounds is combined with the carbon-rich solids to enrich the carbon and energy content of the product. In these embodiments, some or all of the resulting gas stream from the reactor, containing various vapors, can be condensed, at least in part, and then passed over cooled pyrolyzed solids derived from the cooling zone and/or from the separate cooling unit. These embodiments are described in more detail below.

Following the reaction and cooling within the cooling zone (if present), the carbonaceous solids can be introduced into a distinct cooling unit. In some embodiments, solids are collected and simply allowed to cool at slow rates. If the carbonaceous solids are reactive or unstable in air, it can be desirable to maintain an inert atmosphere and/or rapidly cool the solids to, for example, a temperature less than 40° C., such as ambient temperature. In some embodiments, a water quench is employed for rapid cooling. In some embodiments, a fluidized-bed cooler is employed. A “cooling unit” should be broadly construed to also include containers, tanks, pipes, or portions thereof.

In some embodiments, the process further comprises operating the cooling unit to cool the warm pyrolyzed solids with steam, thereby generating the cool pyrolyzed solids and superheated steam; wherein the drying is carried out, at least in part, with the superheated steam derived from the cooling unit. Optionally, the cooling unit can be operated to first cool the warm pyrolyzed solids with steam to reach a first cooling-unit temperature, and then with air to reach a second cooling-unit temperature, wherein the second cooling-unit temperature is lower than the first cooling-unit temperature and is associated with a reduced combustion risk for the warm pyrolyzed solids in the presence of the air.

Following cooling to ambient conditions, the carbonaceous solids can be recovered and stored, conveyed to another site operation, transported to another site, or otherwise disposed, traded, or sold. The solids can be fed to a unit to reduce particle size. A variety of size-reduction units are known in the art, including crushers, shredders, grinders, pulverizers, jet mills, pin mills, and ball mills.

Screening or some other means for separation based on particle size can be included. The grinding can be upstream or downstream of grinding, if present. A portion of the screened material (e.g., large chunks) can be returned to the grinding unit. The small and large particles can be recovered for separate downstream uses. In some embodiments, cooled pyrolyzed solids are ground into a fine powder, such as a pulverized carbon or activated carbon product.

Various additives can be introduced throughout the process, before, during, or after any step disclosed herein. The additives can be broadly classified as process additives, selected to improve process performance such as carbon yield or pyrolysis time/temperature to achieve a desired carbon purity; and product additives, selected to improve one or more properties of the biogenic reagent, or a downstream product incorporating the reagent. Certain additives can provide enhanced process and product (biogenic reagents or products containing biogenic reagents) characteristics.

Additives can be added before, during, or after any one or more steps of the process, including into the feedstock itself at any time, before or after it is harvested. Additive treatment can be incorporated prior to, during, or after feedstock sizing, drying, or other preparation. Additives can be incorporated at or on feedstock supply facilities, transport trucks, unloading equipment, storage bins, conveyors (including open or closed conveyors), dryers, process heaters, or any other units. Additives can be added anywhere into the pyrolysis process itself, using suitable means for introducing additives. Additives can be added after carbonization, or even after pulverization, if desired.

In some embodiments, an additive is selected from a metal, a metal oxide, a metal hydroxide, or a combination thereof. For example an additive can be selected from, but is by no means limited to, magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, and combinations thereof.

In some embodiments, an additive is selected from an acid, a base, or a salt thereof. For example an additive can be selected from, but is by no means limited to, sodium hydroxide, potassium hydroxide, magnesium oxide, hydrogen bromide, hydrogen chloride, sodium silicate, potassium permanganate, or combinations thereof.

In some embodiments, an additive is selected from a metal halide. Metal halides are compounds between metals and halogens (fluorine, chlorine, bromine, iodine, and astatine). The halogens can form many compounds with metals. Metal halides are generally obtained by direct combination, or more commonly, neutralization of basic metal salt with a hydrohalic acid. In some embodiments, an additive is selected from iron chloride (FeCl₂ and/or FeCl₃), iron bromide (FeBr₂ and/or FeBr₃), or hydrates thereof, and any combinations thereof.

Additives can result in a final product with higher energy content (energy density). An increase in energy content can result from an increase in total carbon, fixed carbon, volatile carbon, or even hydrogen. Alternatively or additionally, the increase in energy content can result from removal of non-combustible matter or of material having lower energy density than carbon. In some embodiments, additives reduce the extent of liquid formation, in favor of solid and gas formation, or in favor of solid formation.

Without being limited to any particular hypothesis, additives can chemically modify the starting biomass, or treated biomass prior to pyrolysis, to reduce rupture of cell walls for greater strength/integrity. In some embodiments, additives can increase fixed carbon content of biomass feedstock prior to pyrolysis.

Additives can result in a biogenic reagent with improved mechanical properties, such as yield strength, compressive strength, tensile strength, fatigue strength, impact strength, elastic modulus, bulk modulus, or shear modulus. Additives can improve mechanical properties by simply being present (e.g., the additive itself imparts strength to the mixture) or due to some transformation that takes place within the additive phase or within the resulting mixture. For example, reactions such as vitrification can occur within a portion of the biogenic reagent that includes the additive, thereby improving the final strength.

Chemical additives can be applied to wet or dry biomass feedstocks. The additives can be applied as a solid powder, a spray, a mist, a liquid, or a vapor. In some embodiments, additives can be introduced through spraying of a liquid solution (such as an aqueous solution or in a solvent), or by soaking in tanks, bins, bags, or other containers.

In certain embodiments, dip pretreatment is employed wherein the solid feedstock is dipped into a bath comprising the additive, either batchwise or continuously, for a time sufficient to allow penetration of the additive into the solid feed material.

In some embodiments, additives applied to the feedstock can reduce energy requirements for the pyrolysis, and/or increase the yield of the carbonaceous product. In these or other embodiments, additives applied to the feedstock can provide functionality that is desired for the intended use of the carbonaceous product.

The throughput, or process capacity, can vary widely from small laboratory-scale units to full operations, including any pilot, demonstration, or semi-commercial scale. In various embodiments, the process capacity (for feedstocks, products, or both) is at least about 1 kg/day, 10 kg/day, 100 kg/day, 1 ton/day (all tons are metric tons), 10 tons/day, 100 tons/day, 500 tons/day, 1000 tons/day, 2000 tons/day, or higher.

In some embodiments, a portion of solids produced can be recycled to the front end of the process, i.e. to the drying or deaeration unit or directly to the reactor. By returning to the front end and passing through the process again, treated solids can become higher in fixed carbon. Solid, liquid, and gas streams produced or existing within the process can be independently recycled, passed to subsequent steps, or removed/purged from the process at any point.

In some embodiments, pyrolyzed material is recovered and then fed to a separate unit for further pyrolysis, to create a product with higher carbon purity (e.g., conversion of low-fixed-carbon material to high-fixed-carbon material). In some embodiments, the secondary process can be conducted in a simple container, such as a steel drum, in which heated inert gas (such as heated N₂) is passed through. Other containers useful for this purpose include process tanks, barrels, bins, totes, sacks, and roll-offs. This secondary sweep gas with volatiles can be sent to the thermal oxidizer, or back to the main process reactor, for example. To cool the final product, another stream of inert gas, which is initially at ambient temperature for example, can be passed through the solids to cool the solids, and then returned to an inert gas preheat system.

Some variations of the invention utilize a biogenic reagent production system comprising:
(a) a feeder configured to introduce a carbon-containing feedstock;
(b) an optional dryer, disposed in operable communication with the feeder, configured to remove moisture contained within a carbon-containing feedstock;
(c) a multiple-zone reactor, disposed in operable communication with the dryer, wherein the multiple-zone reactor contains at least a pyrolysis zone disposed in operable communication with a spatially separated cooling zone, and wherein the multiple-zone reactor is configured with an outlet to remove condensable vapors and non-condensable gases from solids;
(d) a solids cooler, disposed in operable communication with the multiple-zone reactor; and
(e) a biogenic reagent recovery unit, disposed in operable communication with the solids cooler.
   Some variations utilize a biogenic reagent production system comprising:
(a) a feeder configured to introduce a carbon-containing feedstock;
(b) an optional dryer, disposed in operable communication with the feeder, configured to remove moisture contained within a carbon-containing feedstock;
(c) an optional preheater, disposed in operable communication with the dryer, configured to heat and/or mildly pyrolyze the feedstock;
(d) a pyrolysis reactor, disposed in operable communication with the preheater, configured to pyrolyze the feedstock;
(e) a cooler, disposed in operable communication with the pyrolysis reactor, configured to cool pyrolyzed solids; and
(f) a biogenic reagent recovery unit, disposed in operable communication with the cooler,
wherein the system is configured with at least one gas outlet to remove condensable vapors and non-condensable gases from solids.

The feeder can be physically integrated with the multiple-zone reactor, such as through the use of a screw feeder or auger mechanism to introduce feed solids into the first reaction zone.

In some embodiments, the system further comprises a preheating zone, disposed in operable communication with the pyrolysis zone. Each of the pyrolysis zone, cooling zone, and preheating zone (it present) can be located within a single unit, or can be located in separate units.

Optionally, the dryer can be configured as a drying zone within the multiple-zone reactor. Optionally, the solids cooler can be disposed within the multiple-zone reactor (i.e., configured as an additional cooling zone or integrated with the main cooling zone).

The system can include a purging means for removing oxygen from the system. For example, the purging means can comprise one or more inlets to introduce a substantially inert gas, and one or more outlets to remove the substantially inert gas and displaced oxygen from the system. In some embodiments, the purging means is a deaerater disposed in operable communication between the dryer and the multiple-zone reactor.

The multiple-zone reactor can be configured with at least a first gas inlet and a first gas outlet. The first gas inlet and the first gas outlet can be disposed in communication with different zones, or with the same zone.

In some embodiments, the multiple-zone reactor is configured with a second gas inlet and/or a second gas outlet. In some embodiments, the multiple-zone reactor is configured with a third gas inlet and/or a third gas outlet. In some embodiments, the multiple-zone reactor is configured with a fourth gas inlet and/or a fourth gas outlet. In some embodiments, each zone present in the multiple-zone reactor is configured with a gas inlet and a gas outlet.

Gas inlets and outlets allow not only introduction and withdrawal of vapor, but gas outlets (probes) in particular allow precise process monitoring and control across various stages of the process, up to and potentially including all stages of the process. Precise process monitoring would be expected to result in yield and efficiency improvements, both dynamically as well as over a period of time when operational history can be utilized to adjust process conditions.

In certain embodiments, a reaction gas probe is disposed in operable communication with the pyrolysis zone. Such a reaction gas probe can be useful to extract gases and analyze them, in order to determine extent of reaction, pyrolysis selectivity, or other process monitoring. Then, based on the measurement, the process can be controlled or adjusted in any number of ways, such as by adjusting feed rate, rate of inert gas sweep, temperature (of one or more zones), pressure (of one or more zones), additives, and so on.

As intended herein, “monitor and control” via reaction gas probes should be construed to include any one or more sample extractions via reaction gas probes, and optionally making process or equipment adjustments based on the measurements, if deemed necessary or desirable, using well-known principles of process control (feedback, feedforward, proportional-integral-derivative logic, etc.).

A reaction gas probe can be configured to withdraw gas samples in a number of ways. For example, a sampling line can have a lower pressure than the pyrolysis reactor pressure, so that when the sampling line is opened an amount of gas can readily be withdrawn from pyrolysis zone. The sampling line can be under vacuum, such as when the pyrolysis zone is near atmospheric pressure. Typically, a reaction gas probe will be associated with one gas output, or a portion thereof (e.g., a line split from a gas output line).

In some embodiments, both a gas input and a gas output are utilized as a reaction gas probe by periodically introducing an inert gas into a zone, and pulling the inert gas with a process sample out of the gas output (“sample sweep”). Such an arrangement could be used in a zone that does not otherwise have a gas inlet/outlet for the substantially inert gas for processing, or, the reaction gas probe could be associated with a separate gas inlet/outlet that is in addition to process inlets and outlets. A sampling inert gas that is introduced and withdrawn periodically for sampling (in embodiments that utilize sample sweeps) could even be different than the process inert gas, if desired, either for reasons of accuracy in analysis or to introduce an analytical tracer.

For example, acetic acid concentration in the gas phase of the pyrolysis zone can be measured using a gas probe to extract a sample, which is then analyzed using a suitable technique (such as gas chromatography, GC; mass spectroscopy, MS; GC-MS, or Fourier-Transform Infrared Spectroscopy, FTIR). CO and/or CO₂ concentration in the gas phase could be measured and used as an indication of the pyrolysis selectivity toward gases/vapors, for example. Terpene concentration in the gas phase could be measured and used as an indication of the pyrolysis selectivity toward liquids, for example.

In some embodiments, the system further comprises at least one additional gas probe disposed in operable communication with the cooling zone, or with the drying zone (if present) or the preheating zone (if present).

A gas probe for the cooling zone could be useful to determine the extent of any additional chemistry taking place in the cooling zone, for example. A gas probe in the cooling zone could also be useful as an independent measurement of temperature (in addition, for example, to a thermocouple disposed in the cooling zone). This independent measurement can be a correlation of cooling temperature with a measured amount of a certain species. The correlation could be separately developed, or could be established after some period of process operation.

A gas probe for the drying zone could be useful to determine the extent of drying, by measuring water content, for example. A gas probe in the preheating zone could be useful to determine the extent of any mild pyrolysis taking place, for example.

In certain embodiments, the cooling zone is configured with a gas inlet, and the pyrolysis zone is configured with a gas outlet, to generate substantially countercurrent flow of the gas phase relative to the solid phase. Alternatively, or additionally, the preheating zone (when it is present) can be configured with a gas outlet, to generate substantially countercurrent flow of the gas phase relative to the solid phase. Alternatively, or additionally, the drying zone can be configured with a gas outlet, to generate substantially countercurrent flow.

The pyrolysis reactor or reactors can be selected from any suitable reactor configuration that is capable of carrying out the pyrolysis process. Exemplary reactor configurations include, but are not limited to, fixed-bed reactors, fluidized-bed reactors, entrained-flow reactors, augers, ablative reactors, rotating cones, rotary drum kilns, calciners, roasters, moving-bed reactors, transport-bed reactors, ablative reactors, rotating cones, or microwave-assisted pyrolysis reactors.

In some embodiments in which an auger is used, sand or another heat carrier can optionally be employed. For example, the feedstock and sand can be fed at one end of a screw. The screw mixes the sand and feedstock and conveys them through the reactor. The screw can provide good control of the feedstock residence time and does not dilute the pyrolyzed products with a carrier or fluidizing gas. The sand can be reheated in a separate vessel.

In some embodiments in which an ablative process is used, the feedstock is moved at a high speed against a hot metal surface. Ablation of any char forming at surfaces can maintain a high rate of heat transfer. Such apparatus can prevent dilution of products. As an alternative, the feedstock particles can be suspended in a carrier gas and introduced at a high speed through a cyclone whose wall is heated.

In some embodiments in which a fluidized-bed reactor is used, the feedstock can be introduced into a bed of hot sand fluidized by a gas, which is typically a recirculated product gas. Reference herein to “sand” shall also include similar, substantially inert materials, such as glass particles, recovered ash particles, and the like. High heat-transfer rates from fluidized sand can result in rapid heating of the feedstock. There can be some ablation by attrition with the sand particles. Heat is usually provided by heat-exchanger tubes through which hot combustion gas flows.

Circulating fluidized-bed reactors can be employed, wherein gas, sand, and feedstock move together. Exemplary transport gases include recirculated product gases and combustion gases. High heat-transfer rates from the sand ensure rapid heating of the feedstock, and ablation is expected to be stronger than with regular fluidized beds. A separator can be employed to separate the product gases from the sand and char particles. The sand particles can be reheated in a fluidized burner vessel and recycled to the reactor.

In some embodiments, a multiple-zone reactor is a continuous reactor comprising a feedstock inlet, a plurality of spatially separated reaction zones configured for separately controlling the temperature and mixing within each of the reaction zones, and a carbonaceous-solids outlet, wherein one of the reaction zones is configured with a first gas inlet for introducing a substantially inert gas into the reactor, and wherein one of the reaction zones is configured with a first gas outlet.

In various embodiments the reactor includes at least two, three, four, or more reaction zones. Each of the reaction zones is disposed in communication with separately adjustable heating means independently selected from electrical heat transfer, steam heat transfer, hot-oil heat transfer, phase-change heat transfer, waste heat transfer, or a combination thereof. In some embodiments, at least one reactor zone is heated with an effluent stream from the thermal oxidizer, if present.

The reactor can be configured for separately adjusting gas-phase composition and gas-phase residence time of at least two reaction zones, up to and including all reaction zones present in the reactor.

The reactor can be equipped with a second gas inlet and/or a second gas outlet. In some embodiments, the reactor is configured with a gas inlet in each reaction zone. In these or other embodiments, the reactor is configured with a gas outlet in each reaction zone. The reactor can be a co-current or countercurrent reactor.

In some embodiments, the feedstock inlet comprises a screw or auger feed mechanism. In some embodiments, the carbonaceous-solids outlet comprises a screw or auger output mechanism.

Certain embodiments utilize a rotating calciner with a screw feeder. In these embodiments, the reactor is axially rotatable, i.e. it spins about its centerline axis. The speed of rotation will impact the solid flow pattern, and heat and mass transport. Each of the reaction zones can be configured with flights disposed on internal walls, to provide agitation of solids. The flights can be separately adjustable in each of the reaction zones.

Other means of agitating solids can be employed, such as augers, screws, or paddle conveyors. In some embodiments, the reactor includes a single, continuous auger disposed throughout each of the reaction zones. In other embodiments, the reactor includes twin screws disposed throughout each of the reaction zones.

Some systems are designed specifically with the capability to maintain the approximate size of feed material throughout the process—that is, to process the biomass feedstock without destroying or significantly damaging its structure. In some embodiments, the pyrolysis zone does not contain augers, screws, or rakes that would tend to greatly reduce the size of feed material being pyrolyzed.

In some embodiments of the invention, the system further includes a thermal oxidizer disposed in operable communication with the outlet at which condensable vapors and non-condensable gases are removed. The thermal oxidizer can be configured to receive a separate fuel (such as natural gas) and an oxidant (such as air) into a combustion chamber, adapted for combustion of the fuel and at least a portion of the condensable vapors. Certain non-condensable gases can also be oxidized, such as CO or CH₄, to CO₂.

When a thermal oxidizer is employed, the system can include a heat exchanger disposed between the thermal oxidizer and the dryer, configured to utilize at least some of the heat of the combustion for the dryer. This embodiment can contribute significantly to the overall energy efficiency of the process.

In some embodiments, the system further comprises a carbon-enhancement unit, disposed in operable communication with the solids cooler, configured for combining condensable vapors, in at least partially condensed form, with the solids. The carbon-enhancement unit can increase the carbon content of the biogenic reagent obtained from the recovery unit.

The system can further include a separate pyrolysis unit adapted to further pyrolyze the biogenic reagent to further increase its carbon content. The separate pyrolysis unit can be a relatively simply container, unit, or device, such as a tank, barrel, bin, drum, tote, sack, or roll-off.

The overall system can be at a fixed location, or it can be distributed at several locations. The system can be constructed using modules which can be simply duplicated for practical scale-up. The system can also be constructed using economy-of-scale principles, as is well-known in the process industries.

Some variations relating to carbon enhancement of solids will now be further described. In some embodiments, a process for producing a biogenic reagent comprises:
(a) providing a carbon-containing feedstock comprising biomass;
(b) optionally drying the feedstock to remove at least a portion of moisture contained within the feedstock;
(c) optionally deaerating the feedstock to remove at least a portion of interstitial oxygen, if any, contained with the feedstock;
(d) in a pyrolysis zone, pyrolyzing the feedstock in the presence of a substantially inert gas for at least 10 minutes and with a pyrolysis temperature selected from about 250° C. to about 700° C., to generate hot pyrolyzed solids, condensable vapors, and non-condensable gases;
(e) separating at least a portion of the condensable vapors and at least a portion of the non-condensable gases from the hot pyrolyzed solids;
(f) in a cooling zone, cooling the hot pyrolyzed solids, in the presence of the substantially inert gas for at least 5 minutes and with a cooling temperature less than the pyrolysis temperature, to generate warm pyrolyzed solids;
(g) optionally cooling the warm pyrolyzed solids to generate cool pyrolyzed solids;
(h) subsequently passing at least a portion of the condensable vapors and/or at least a portion of the non-condensable gases from step (e) across the warm pyrolyzed solids and/or the cool pyrolyzed solids, to form enhanced pyrolyzed solids with increased carbon content; and
(i) recovering a biogenic reagent comprising at least a portion of the enhanced pyrolyzed solids.

In some embodiments, step (h) includes passing at least a portion of the condensable vapors from step (e), in vapor and/or condensed form, across the warm pyrolyzed solids, to produce enhanced pyrolyzed solids with increased carbon content. In some embodiments, step (h) includes passing at least a portion of the non-condensable gases from step (e) across the warm pyrolyzed solids, to produce enhanced pyrolyzed solids with increased carbon content.

Alternatively, or additionally, vapors or gases can be contacted with the cool pyrolyzed solids. In some embodiments, step (h) includes passing at least a portion of the condensable vapors from step (e), in vapor and/or condensed form, across the cool pyrolyzed solids, to produce enhanced pyrolyzed solids with increased carbon content. In some embodiments, step (h) includes passing at least a portion of the non-condensable gases from step (e) across the cool pyrolyzed solids, to produce enhanced pyrolyzed solids with increased carbon content.

In certain embodiments, step (h) includes passing substantially all of the condensable vapors from step (e), in vapor and/or condensed form, across the cool pyrolyzed solids, to produce enhanced pyrolyzed solids with increased carbon content. In certain embodiments, step (h) includes passing substantially all of the non-condensable gases from step (e) across the cool pyrolyzed solids, to produce enhanced pyrolyzed solids with increased carbon content.

The process can include various methods of treating or separating the vapors or gases prior to using them for carbon enhancement. For example, an intermediate feed stream consisting essentially of at least a portion of the condensable vapors and at least a portion of the non-condensable gases, obtained from step (e), can be fed to a separation unit configured to generate at least first and second output streams. In certain embodiments, the intermediate feed stream comprises all of the condensable vapors, all of the non-condensable gases, or both.

Separation techniques can include or use distillation columns, flash vessels, centrifuges, cyclones, membranes, filters, packed beds, capillary columns, and so on. Separation can be principally based, for example, on distillation, absorption, adsorption, or diffusion, and can utilize differences in vapor pressure, activity, molecular weight, density, viscosity, polarity, chemical functionality, affinity to a stationary phase, and any combinations thereof.

In some embodiments, the first and second output streams are separated from the intermediate feed stream based on relative volatility. For example, the separation unit can be a distillation column, a flash tank, or a condenser.

Thus in some embodiments, the first output stream comprises the condensable vapors, and the second output stream comprises the non-condensable gases. The condensable vapors can include at least one carbon-containing compound selected from terpenes, alcohols, acids, aldehydes, or ketones. The vapors from pyrolysis can include aromatic compounds such as benzene, toluene, ethylbenzene, and xylenes. Heavier aromatic compounds, such as refractory tars, can be present in the vapor. The non-condensable gases can include at least one carbon-containing molecule selected from carbon monoxide, carbon dioxide, and methane.

In some embodiments, the first and second output streams are separated intermediate feed stream based on relative polarity. For example, the separation unit can be a stripping column, a packed bed, a chromatography column, or membranes.

Thus in some embodiments, the first output stream comprises polar compounds, and the second output stream comprises non-polar compounds. The polar compounds can include at least one carbon-containing molecule selected from methanol, furfural, or acetic acid. The non-polar compounds can include at least one carbon-containing molecule selected from carbon monoxide, carbon dioxide, methane, a terpene, or a terpene derivative.

Step (h) can increase the total carbon content of the biogenic reagent, relative to an otherwise-identical process without step (h). The extent of increase in carbon content can be, for example, about 1%, 2%, 5%, 10%, 15%, 25%, or even higher, in various embodiments.

In some embodiments, step (h) increases the fixed carbon content of the biogenic reagent. In these or other embodiments, step (h) increases the volatile carbon content of the biogenic reagent. Volatile carbon content is the carbon attributed to volatile matter in the reagent. The volatile matter can be, but is not limited to, hydrocarbons including aliphatic or aromatic compounds (e.g., terpenes); oxygenates including alcohols, aldehydes, or ketones; and various tars. Volatile carbon will typically remain bound or adsorbed to the solids at ambient conditions but upon heating, will be released before the fixed carbon would be oxidized, gasified, or otherwise released as a vapor.

Depending on conditions associated with step (h), it is possible for some amount of volatile carbon to become fixed carbon (e.g., via Boudouard carbon formation from CO). Typically, the volatile matter will enter the micropores of the fixed carbon and will be present as condensed/adsorbed species, but remain relatively volatile. This residual volatility can be more advantageous for fuel applications, compared to product applications requiring high surface area and porosity.

Step (h) can increase the energy content (i.e., energy density) of the biogenic reagent. The increase in energy content can result from an increase in total carbon, fixed carbon, volatile carbon, or even hydrogen. The extent of increase in energy content can be, for example, about 1%, 2%, 5%, 10%, 15%, 25%, or even higher, in various embodiments.

Further separations can be employed to recover one or more non-condensable gases or condensable vapors, for use within the process or further processing. For example, further processing can be included to produce refined carbon monoxide and/or hydrogen.

As another example, separation of acetic acid can be conducted, followed by reduction of the acetic acid into ethanol. The reduction of the acetic acid can be accomplished, at least in part, using hydrogen derived from the non-condensable gases produced.

Condensable vapors can be used for either energy in the process (such as by thermal oxidation) or in carbon enrichment, to increase the carbon content of the biogenic reagent. Certain non-condensable gases, such as CO or CH₄, can be utilized either for energy in the process, or as part of the substantially inert gas for the pyrolysis step. Combinations of any of the foregoing are also possible.

A potential benefit of including step (h) is that the gas stream is scrubbed, with the resulting gas stream being enriched in CO and CO₂. The resulting gas stream can be utilized for energy recovery, recycled for carbon enrichment of solids, and/or used as an inert gas in the reactor. Similarly, by separating non-condensable gases from condensable vapors, the CO/CO₂ stream is prepared for use as the inert gas in the reactor system or in the cooling system, for example.

Other variations are premised on the realization that the principles of the carbon-enhancement step can be applied to any feedstock in which it is desired to add carbon.

In some embodiments, a batch or continuous process for producing a biogenic reagent comprises:
(a) providing a solid stream comprising a carbon-containing material;
(b) providing a gas stream comprising condensable carbon-containing vapors, non-condensable carbon-containing gases, or a mixture of condensable carbon-containing vapors and non-condensable carbon-containing gases; and
(c) passing the gas stream across the solid stream under suitable conditions to form a carbon-containing product with increased carbon content relative to the carbon-containing material.

In some embodiments, the starting carbon-containing material is pyrolyzed biomass or torrefied biomass. The gas stream can be obtained during an integrated process that provides the carbon-containing material. Or, the gas stream can be obtained from separate processing of the carbon-containing material. The gas stream, or a portion thereof, can be obtained from an external source (e.g., an oven at a lumber mill). Mixtures of gas streams, as well as mixtures of carbon-containing materials, from a variety of sources, are possible.

In some embodiments, the process further comprises recycling or reusing the gas stream for repeating the process to further increase carbon and/or energy content of the carbon-containing product. In some embodiments, the process further comprises recycling or reusing the gas stream for carrying out the process to increase carbon and/or energy content of another feedstock different from the carbon-containing material.

In some embodiments, the process further includes introducing the gas stream to a separation unit configured to generate at least first and second output streams, wherein the gas stream comprises a mixture of condensable carbon-containing vapors and non-condensable carbon-containing gases. The first and second output streams can be separated based on relative volatility, relative polarity, or any other property. The gas stream can be obtained from separate processing of the carbon-containing material.

In some embodiments, the process further comprises recycling or reusing the gas stream for repeating the process to further increase carbon content of the carbon-containing product. In some embodiments, the process further comprises recycling or reusing the gas stream for carrying out the process to increase carbon content of another feedstock.

The carbon-containing product can have an increased total carbon content, a higher fixed carbon content, a higher volatile carbon content, a higher energy content, or any combination thereof, relative to the starting carbon-containing material.

In related variations, a biogenic reagent production system comprises:
(a) a feeder configured to introduce a carbon-containing feedstock;
(b) an optional dryer, disposed in operable communication with the feeder, configured to remove moisture contained within a carbon-containing feedstock;
(c) a multiple-zone reactor, disposed in operable communication with the dryer, wherein the multiple-zone reactor contains at least a pyrolysis zone disposed in operable communication with a spatially separated cooling zone, and wherein the multiple-zone reactor is configured with an outlet to remove condensable vapors and non-condensable gases from solids;
(d) a solids cooler, disposed in operable communication with the multiple-zone reactor;
(e) a material-enrichment unit, disposed in operable communication with the solids cooler, configured to pass the condensable vapors and/or the non-condensable gases across the solids, to form enhanced solids with increased carbon content; and
(f) a biogenic reagent recovery unit, disposed in operable communication with the material-enrichment unit.

The system can further comprise a preheating zone, disposed in operable communication with the pyrolysis zone. In some embodiments, the dryer is configured as a drying zone within the multiple-zone reactor. Each of the zones can be located within a single unit or in separate units. Also, the solids cooler can be disposed within the multiple-zone reactor.

In some embodiments, the cooling zone is configured with a gas inlet, and the pyrolysis zone is configured with a gas outlet, to generate substantially countercurrent flow of the gas phase relative to the solid phase. In these or other embodiments, the preheating zone and/or the drying zone (or dryer) is configured with a gas outlet, to generate substantially countercurrent flow of the gas phase relative to the solid phase.

In particular embodiments, the system incorporates a material-enrichment unit that comprises:
(i) a housing with an upper portion and a lower portion;
(ii) an inlet at a bottom of the lower portion of the housing configured to carry the condensable vapors and non-condensable gases;
(iii) an outlet at a top of the upper portion of the housing configured to carry a concentrated gas stream derived from the condensable vapors and non-condensable gases;
(iv) a path defined between the upper portion and the lower portion of the housing; and
(v) a transport system following the path, the transport system configured to transport the solids, wherein the housing is shaped such that the solids adsorb at least some of the condensable vapors and/or at least some of the non-condensable gases.

The present invention is capable of producing a variety of compositions useful as biogenic reagents, and products incorporating such reagents. In some variations, a biogenic reagent is produced by any process disclosed herein, such as a process comprising the steps of:
(a) providing a carbon-containing feedstock comprising biomass;
(b) optionally drying the feedstock to remove at least a portion of moisture contained within the feedstock;
(c) optionally deaerating the feedstock to remove at least a portion of interstitial oxygen, if any, contained with the feedstock;
(d) in a pyrolysis zone, pyrolyzing the feedstock in the presence of a substantially inert gas for at least 10 minutes and with a pyrolysis temperature selected from about 250° C. to about 700° C., to generate hot pyrolyzed solids, condensable vapors, and non-condensable gases;
(e) separating at least a portion of the condensable vapors and at least a portion of the non-condensable gases from the hot pyrolyzed solids;
(f) in a cooling zone, cooling the hot pyrolyzed solids, in the presence of the substantially inert gas for at least 5 minutes and with a cooling temperature less than the pyrolysis temperature, to generate warm pyrolyzed solids;
(g) cooling the warm pyrolyzed solids to generate cool pyrolyzed solids; and
(h) recovering a biogenic reagent comprising at least a portion of the cool pyrolyzed solids.

In some embodiments, the reagent comprises about at least 70 wt %, at least 80 wt %, at least 90 wt %, or at least 95 wt % total carbon on a dry basis. The total carbon includes at least fixed carbon, and can further include carbon from volatile matter. In some embodiments, carbon from volatile matter is about at least 5%, at least 10%, at least 25%, or at least 50% of the total carbon present in the biogenic reagent. Fixed carbon can be measured using ASTM D3172, while volatile carbon can be measured using ASTM D3175, for example.

The biogenic reagent can comprise about 10 wt % or less, such as about 5 wt % or less, hydrogen on a dry basis. The biogenic reagent can comprise about 1 wt % or less, such as about 0.5 wt % or less, nitrogen on a dry basis. The biogenic reagent can comprise about 0.5 wt % or less, such as about 0.2 wt % or less, phosphorus on a dry basis. The biogenic reagent can comprise about 0.2 wt % or less, such as about 0.1 wt % or less, sulfur on a dry basis.

Carbon, hydrogen, and nitrogen can be measured using ASTM D5373 for ultimate analysis, for example. Oxygen can be measured using ASTM D3176, for example. Sulfur can be measured using ASTM D3177, for example.

Certain embodiments provide reagents with little or essentially no hydrogen (except from any moisture that can be present), nitrogen, phosphorus, or sulfur, and are substantially carbon plus any ash and moisture present. Therefore, some embodiments provide a biogenic reagent with up to and including 100% carbon, on a dry/ash-free (DAF) basis.

Generally speaking, feedstocks such as biomass contain non-volatile species, including silica and various metals, which are not readily released during pyrolysis. It is of course possible to utilize ash-free feedstocks, in which case there should not be substantial quantities of ash in the pyrolyzed solids. Ash can be measured using ASTM D3174, for example.

Various amounts of non-combustible matter, such as ash, can be present. The biogenic reagent can comprise about 10 wt % or less, such as about 5 wt %, about 2 wt %, about 1 wt % or less non-combustible matter on a dry basis. In certain embodiments, the reagent contains little ash, or even essentially no ash or other non-combustible matter. Therefore, some embodiments provide essentially pure carbon, including 100% carbon, on a dry basis.

Various amounts of moisture can be present. On a total mass basis, the biogenic reagent can comprise at least 1 wt %, 2 wt %, 5 wt %, 10 wt %, 15 wt %, 25 wt %, 35 wt %, 50 wt %, or more moisture. As intended herein, “moisture” is to be construed as including any form of water present in the biogenic reagent, including absorbed moisture, adsorbed water molecules, chemical hydrates, and physical hydrates. The equilibrium moisture content can vary at least with the local environment, such as the relative humidity. Also, moisture can vary during transportation, preparation for use, and other logistics. Moisture can be measured using ASTM D3173, for example.

The biogenic reagent can have various energy contents which for present purposes means the energy density based on the higher heating value associated with total combustion of the bone-dry reagent. For example, the biogenic reagent can possess an energy content of about at least 11,000 Btu/lb, at least 12,000 Btu/lb, at least 13,000 Btu/lb, at least 14,000 Btu/lb, or at least 15,000 Btu/lb. In certain embodiments, the energy content is between about 14,000-15,000 Btu/lb. The energy content can be measured using ASTM D5865, for example.

The biogenic reagent can be formed into a powder, such as a coarse powder or a fine powder. For example, the reagent can be formed into a powder with an average mesh size of about 200 mesh, about 100 mesh, about 50 mesh, about 10 mesh, about 6 mesh, about 4 mesh, or about 2 mesh, in embodiments.

In some embodiments, the biogenic reagent is formed into structural objects comprising pressed, binded, or agglomerated particles. The starting material to form these objects can be a powder form of the reagent, such as an intermediate obtained by particle-size reduction. The objects can be formed by mechanical pressing or other forces, optionally with a binder or other means of agglomerating particles together.

In some embodiments, the biogenic reagent is produced in the form of structural objects whose structure substantially derives from the feedstock. For example, feedstock chips can produce product chips of biogenic reagent. Or, feedstock cylinders can produce biogenic reagent cylinders, which can be somewhat smaller but otherwise maintain the basic structure and geometry of the starting material.

A biogenic reagent according to the present invention can be produced as, or formed into, an object that has a minimum dimension of at least about 1 cm, 2 cm, 3 cm, 4 cm, 5 cm, 6 cm, 7 cm, 8 cm, 9 cm, 10 cm, or higher. In various embodiments, the minimum dimension or maximum dimension can be a length, width, or diameter.

Other variations of the invention relate to the incorporation of additives into the process, into the product, or both. In some embodiments, the biogenic reagent includes at least one process additive incorporated during the process. In these or other embodiments, the reagent includes at least one product additive introduced to the reagent following the process.

In some embodiments, a biogenic reagent comprises, on a dry basis:
70 wt % or more total carbon;
5 wt % or less hydrogen;
1 wt % or less nitrogen;
0.5 wt % or less phosphorus;
0.2 wt % or less sulfur; and
an additive selected from a metal, a metal oxide, a metal hydroxide, a metal halide, or a combination thereof.

The additive can be selected from, but is by no means limited to, magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, and combinations thereof.

In some embodiments, a biogenic reagent comprises, on a dry basis:
70 wt % or more total carbon;
5 wt % or less hydrogen;
1 wt % or less nitrogen;
0.5 wt % or less phosphorus;
0.2 wt % or less sulfur; and
an additive selected from an acid, a base, or a salt thereof.

The additive can be selected from, but is by no means limited to, sodium hydroxide, potassium hydroxide, magnesium oxide, hydrogen bromide, hydrogen chloride, sodium silicate, potassium permanganate, or combinations thereof.

In certain embodiments, a biogenic reagent comprises, on a dry basis:
70 wt % or more total carbon;
5 wt % or less hydrogen;
1 wt % or less nitrogen;
0.5 wt % or less phosphorus;
0.2 wt % or less sulfur;
a first additive selected from a metal, metal oxide, metal hydroxide, a metal halide, or a combination thereof; and
a second additive selected from an acid, a base, or a salt thereof,
wherein the first additive is different from the second additive.

The first additive can be selected from magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, and combinations thereof, while the second additive can be independently selected from sodium hydroxide, potassium hydroxide, magnesium oxide, hydrogen bromide, hydrogen chloride, sodium silicate, potassium permanganate, or combinations thereof.

A certain biogenic reagent consists essentially of, on a dry basis, carbon, hydrogen, nitrogen, phosphorus, sulfur, non-combustible matter, and an additive selected from magnesium, manganese, aluminum, nickel, chromium, silicon, boron, cerium, molybdenum, phosphorus, tungsten, vanadium, iron chloride, iron bromide, magnesium oxide, dolomite, dolomitic lime, fluorite, fluorospar, bentonite, calcium oxide, lime, or a combination thereof.

A certain biogenic reagent consists essentially of, on a dry basis, carbon, hydrogen, nitrogen, phosphorus, sulfur, non-combustible matter, and an additive selected from sodium hydroxide, potassium hydroxide, magnesium oxide, hydrogen bromide, hydrogen chloride, sodium silicate, or a combination thereof.

The amount of additive (or total additives) can vary widely, such as from about 0.01 wt % to about 25 wt %, including about 0.1 wt %, about 1 wt %, about 5 wt %, about 10 wt %, or about 20 wt %. It will be appreciated then when relatively large amounts of additives are incorporated, such as higher than about 1 wt %, there will be a reduction in energy content calculated on the basis of the total reagent weight (inclusive of additives). Still, in various embodiments, the biogenic reagent with additive(s) can possess an energy content of about at least 11,000 Btu/lb, at least 12,000 Btu/lb, at least 13,000 Btu/lb, at least 14,000 Btu/lb, or at least 15,000 Btu/lb.

In certain embodiments, the majority of carbon contained in the biogenic reagent is classified as renewable carbon. In some embodiments, substantially all of the carbon is classified as renewable carbon. There can be certain market mechanisms (e.g., Renewable Identification Numbers, tax credits, etc.) wherein value is attributed to the renewable carbon content within the biogenic reagent.

The biogenic reagents produced as described herein is useful for a wide variety of carbonaceous products. The biogenic reagent can be a desirable market product itself. Biogenic reagents as provided herein are associated with lower levels of impurities, reduced process emissions, and improved sustainability (including higher renewable carbon content) compared to the state of the art.

In variations, a product includes any of the biogenic reagents that can be obtained by the disclosed processes, or that are described in the compositions set forth herein, or any portions, combinations, or derivatives thereof.

Generally speaking, the biogenic reagents can be combusted to produce energy (including electricity and heat); partially oxidized, gasified, or steam-reformed to produce syngas; utilized for their adsorptive or absorptive properties; utilized for their reactive properties during metal refining (such as reduction of metal oxides) or other industrial processing; or utilized for their material properties in carbon steel and various other metal alloys. Essentially, the biogenic reagents can be utilized for any market application of carbon-based commodities or advanced materials, including specialty uses to be developed.

Prior to suitability or actual use in any product applications, the disclosed biogenic reagents can be analyzed, measured, and optionally modified (such as through additives) in various ways. Some properties of potential interest, other than chemical composition and energy content, include density, particle size, surface area, microporosity, absorptivity, adsorptivity, binding capacity, reactivity, desulfurization activity, and basicity, to name a few properties.

Products or materials that can incorporate these biogenic reagents include, but are by no means limited to, carbon-based blast furnace addition products, carbon-based taconite pellet addition products, ladle addition carbon-based products, met coke carbon-based products, coal replacement products, carbon-based coking products, carbon breeze products, fluidized-bed carbon-based feedstocks, carbon-based furnace addition products, injectable carbon-based products, pulverized carbon-based products, stoker carbon-based products, carbon electrodes, or activated carbon products.

Use of the disclosed biogenic reagents in metals production can reduce slag, increase overall efficiency, and reduce lifecycle environmental impacts in metal processing and manufacturing.

Some variations of the invention utilize the biogenic reagents as carbon-based blast furnace addition products. A blast furnace is a type of metallurgical furnace used for smelting to produce industrial metals, such as (but not limited to) iron. Smelting is a form of extractive metallurgy; its main use is to produce a metal from its ore. Smelting uses heat and a chemical reducing agent to decompose the ore. The carbon and/or the carbon monoxide derived from the carbon removes oxygen from the ore, leaving behind elemental metal.

The reducing agent can consist essentially of, or comprise, a biogenic reagent. In a blast furnace, biogenic reagent, ore, and typically limestone can be continuously supplied through the top of the furnace, while air (optionally with oxygen enrichment) is blown into the bottom of the chamber, so that the chemical reactions take place throughout the furnace as the material moves downward. The end products are usually molten metal and slag phases tapped from the bottom, and flue gases exiting from the top of the furnace. The downward flow of the ore in contact with an upflow of hot, carbon monoxide-rich gases is a countercurrent process.

Carbon quality in the blast furnace is measured by its resistance to degradation. The role of the carbon as a permeable medium is crucial in economic blast furnace operation. The degradation of the carbon varies with the position in the blast furnace and involves the combination of reaction with CO₂, H₂O, or O₂ and the abrasion of carbon particles against each other and other components of the burden. Degraded carbon particles can cause plugging and poor performance.

The Coke Reactivity test is a highly regarded measure of the performance of carbon in a blast furnace. This test has two components: the Coke Reactivity Index (CRI) and the Coke Strength after Reaction (CSR). A carbon-based material with a low CRI value (high reactivity) and a high CSR value can be used to achieve efficient blast furnace performance. CRI can be determined according to any suitable method known in the art, for example by ASTM Method DS341 on an as-received basis.

In some embodiments, the biogenic reagent provides a carbon product having suitable properties for introduction directly into a blast furnace.

The strength of the biogenic reagent can be determined by any suitable method known in the art, for example by a drop-shatter test, or a CSR test. In some embodiments, the biogenic reagent, optionally when blended with another source of carbon, provides a final carbon product having CSR of at least about 50%, 60%, or 70%. A combination product can also provide a final coke product having a suitable reactivity for combustion in a blast furnace. In some embodiments, the product has a CRI such that the biogenic reagent is suitable for use as an additive or replacement for met coal, met coke, coke breeze, foundry coke, or injectable coal.

Some embodiments employ one or more additives in an amount sufficient to provide a biogenic reagent that, when added to another carbon source (e.g., coke) having a CRI or CSR insufficient for use as a blast furnace product, provides a composite product with a CRI and/or CSR sufficient for use in a blast furnace. In some embodiments, one or more additives are present in an amount sufficient to provide a biogenic reagent having a CRI of not more than about 40%, 30%, or 20%.

In some embodiments, one or more additives selected from the alkaline earth metals, or oxides or carbonates thereof, are introduced during or after the process of producing a biogenic reagent. For example, calcium, calcium oxide, calcium carbonate, magnesium oxide, or magnesium carbonate can be introduced as additives. The addition of these compounds before, during, or after pyrolysis can increase the reactivity of the biogenic reagent in a blast furnace. These compounds can lead to stronger materials, i.e. higher CSR, thereby improving blast-furnace efficiency. In addition, additives such as those selected from the alkaline earth metals, or oxides or carbonates thereof, can lead to lower emissions (e.g., SO₂).

In some embodiments, a blast furnace replacement product is a biogenic reagent comprising at least about 55 wt % carbon, not more than about 0.5 wt % sulfur, not more than about 8 wt % non-combustible material, and a heat value of at least about 11,000 Btu per pound. In some embodiments, the blast furnace replacement product further comprises not more than about 0.035 wt % phosphorous, about 0.5 wt % to about 50 wt % volatile matter, and optionally one or more additives. In some embodiments, the blast furnace replacement product comprises about 2 wt % to about 15 wt % dolomite, about 2 wt % to about 15 wt % dolomitic lime, about 2 wt % to about 15 wt % bentonite, and/or about 2 wt % to about 15 wt % calcium oxide. In some embodiments, the blast furnace replacement product has dimensions substantially in the range of about 1 cm to about 10 cm.

In some embodiments, a biogenic reagent is useful as a foundry coke replacement product. Foundry coke is generally characterized as having a carbon content of at least about 85 wt %, a sulfur content of about 0.6 wt %, not more than about 1.5 wt % volatile matter, not more than about 13 wt % ash, not more than about 8 wt % moisture, about 0.035 wt % phosphorus, a CRI value of about 30, and dimensions ranging from about 5 cm to about 25 cm.

Some variations utilize the biogenic reagents as carbon-based taconite pellet addition products. The ores used in making iron and steel are iron oxides. Major iron oxide ores include hematite, limonite (also called brown ore), taconite, and magnetite, a black ore. Taconite is a low-grade but important ore, which contains both magnetite and hematite. The iron content of taconite is generally 25 wt % to 35 wt %. Blast furnaces typically require at least 50 wt % iron content ore for efficient operation. Iron ores can undergo beneficiation including crushing, screening, tumbling, flotation, and magnetic separation. The refined ore is enriched to over 60% iron and is often formed into pellets before shipping. Taconite pellets are usually marble-sized and work very well in blast furnaces.

For example, taconite can be ground into a fine powder and combined with a binder such as bentonite clay and limestone. Pellets about one centimeter in diameter can be formed, containing approximately 65 wt % iron, for example. The pellets are fired, oxidizing magnetite to hematite. The pellets are durable which ensures that the blast furnace charge remains porous enough to allow heated gas to pass through and react with the pelletized ore.

The taconite pellets can be fed to a blast furnace to produce iron, as described above with reference to blast furnace addition products. In some embodiments, a biogenic reagent is introduced to the blast furnace. In these or other embodiments, a biogenic reagent is incorporated into the taconite pellet itself. For example, taconite ore powder, after beneficiation, can be mixed with a biogenic reagent and a binder and rolled into small objects, then baked to hardness. In such embodiments, taconite-carbon pellets with the appropriate composition can conveniently be introduced into a blast furnace without the need for a separate source of carbon.

Some variations utilize the biogenic reagents as ladle addition carbon-based products. A ladle is a vessel used to transport and pour out molten metals. Casting ladles are used to pour molten metal into molds to produce the casting. Transfers ladle are used to transfer a large amount of molten metal from one process to another. Treatment ladles are used for a process to take place within the ladle to change some aspect of the molten metal, such as the conversion of cast iron to ductile iron by the addition of various elements into the ladle.

Biogenic reagents can be introduced to any type of ladle, but typically carbon will be added to treatment ladles in suitable amounts based on the target carbon content. Carbon injected into ladles can be in the form of fine powder, for good mass transport of the carbon into the final composition. In some embodiments, a biogenic reagent, when used as a ladle addition product, has a minimum dimension of about 0.5 cm, such as about 0.75 cm, about 1 cm, about 1.5 cm, or higher.

In some embodiments, a high carbon biogenic reagent is useful as a ladle addition carbon additive at, for example, basic oxygen furnace or electric arc furnace facilities wherever ladle addition of carbon would be used (e.g., added to ladle carbon during steel manufacturing).

In some embodiments, the ladle addition carbon additive additionally comprises up to about 5 wt % manganese, up to about 5 wt % calcium oxide, and/or up to about 5 wt % dolomitic lime.

Direct-reduced iron (DRI), also called sponge iron, is produced from direct reduction of iron ore (in the form of lumps, pellets, or fines) by a reducing gas conventionally produced from natural gas or coal. The reducing gas is typically syngas, a mixture of hydrogen and carbon monoxide which acts as reducing agent. The biogenic reagent as provided herein can be converted into a gas stream comprising CO, to act as a reducing agent to produce direct-reduced iron.

Iron nuggets are a high-quality steelmaking and iron-casting feed material. Iron nuggets are essentially all iron and carbon, with almost no gangue (slag) and low levels of metal residuals. They are a premium grade pig iron product with superior shipping and handling characteristics. The carbon contained in iron nuggets, or any portion thereof, can be the biogenic reagent provided herein. Iron nuggets can be produced through the reduction of iron ore in a rotary hearth furnace, using a biogenic reagent as the reductant and energy source.

Some variations utilize the biogenic reagents as metallurgical coke carbon-based products. Metallurgical coke, also known as “met” coke, is a carbon material normally manufactured by the destructive distillation of various blends of bituminous coal. The final solid is a non-melting carbon called metallurgical coke. As a result of the loss of volatile gases and of partial melting, met coke has an open, porous morphology. Met coke has a very low volatile content. However, the ash constituents, that were part of the original bituminous coal feedstock, remain encapsulated in the resultant coke. Met coke feedstocks are available in a wide range of sizes from fine powder to basketball-sized lumps. Typical purities range from 86-92 wt % fixed carbon.

Metallurgical coke is used where a high-quality, tough, resilient, wearing carbon is required. Applications include, but are not limited to, conductive flooring, friction materials (e.g., carbon linings), foundry coatings, foundry carbon raiser, corrosion materials, drilling applications, reducing agents, heat-treatment agents, ceramic packing media, electrolytic processes, and oxygen exclusion.

Met coke can be characterized as having a heat value of about 10,000 to 14,000 Btu per pound and an ash content of about 10 wt % or greater. Thus, in some embodiments, a met coke replacement product comprises a biogenic reagent according to the present invention comprising at least about 80 wt %, 85 wt %, or 90 wt % carbon, not more than about 0.8 wt % sulfur, not more than about 3 wt % volatile matter, not more than about 15 wt % ash, not more than about 13 wt % moisture, and not more than about 0.035 wt % phosphorus. A biogenic reagent according to the present invention, when used as a met coke replacement product, can have a size range from about 2 cm to about 15 cm, for example.

In some embodiments, the met coke replacement product further comprises an additive such as chromium, nickel, manganese, magnesium oxide, silicon, aluminum, dolomite, fluorospar, calcium oxide, lime, dolomitic lime, bentonite and combinations thereof.

Some variations utilize the biogenic reagents as coal replacement products. Any process or system using coal can in principle be adapted to use a biogenic reagent. In some embodiments, a biogenic reagent is combined with one or more coal-based products to form a composite product having a higher rank than the coal-based product(s) and/or having fewer emissions, when burned, than the pure coal-based product.

For example, a low-rank coal such as sub-bituminous coal can be used in applications normally calling for a higher-rank coal product, such as bituminous coal, by combining a selected amount of a biogenic reagent according to the present invention with the low-rank coal product. In other embodiments, the rank of a mixed coal product (e.g., a combination of a plurality of coals of different rank) can be improved by combining the mixed coal with some amount of biogenic reagent. The amount of a biogenic reagent to be mixed with the coal product(s) can vary depending on the rank of the coal product(s), the characteristics of the biogenic reagent (e.g., carbon content, heat value, etc.) and the desired rank of the final combined product.

For example, anthracite coal is generally characterized as having at least about 80 wt % carbon, about 0.6 wt % sulfur, about 5 wt % volatile matter, up to about 15 wt % ash, up to about 10 wt % moisture, and a heat value of about 12,494 Btu/lb. In some embodiments, an anthracite coal replacement product is a biogenic reagent comprising at least about 80 wt % carbon, not more than about 0.6 wt % sulfur, not more than about 15 wt % ash, and a heat value of at least about 12,000 Btu/lb.

In some embodiments, a biogenic reagent is useful as a thermal coal replacement product. Thermal coal products are generally characterized as having high sulfur levels, high phosphorus levels, high ash content, and heat values of up to about 15,000 Btu/lb. In some embodiments, a thermal coal replacement product is a biogenic reagent comprising not more than about 0.5 wt % sulfur, not more than about 4 wt % ash, and a heat value of at least about 12,000 Btu/lb.

Some variations of the invention utilize the biogenic reagents as carbon-based coking products. Any coking process or system can be adapted to use biogenic reagents to produce coke, or use it as a coke feedstock.

In some embodiments, a biogenic reagent is useful as a thermal coal or coke replacement product. For example, a thermal coal or coke replacement product can consist essentially of a biogenic reagent comprising at least about 50 wt % carbon, not more than about 8 wt % ash, not more than about 0.5 wt % sulfur, and a heat value of at least about 11,000 Btu/lb. In other embodiments, the thermal coke replacement product further comprises about 0.5 wt % to about 50 wt % volatile matter. The thermal coal or coke replacement product can include about 0.4 wt % to about 15 wt % moisture.

In some embodiments, a biogenic reagent is useful as a petroleum (pet) coke or calcine pet coke replacement product. Calcine pet coke is generally characterized as having at least about 66 wt % carbon, up to 4.6 wt % sulfur, up to about 5.5 wt % volatile matter, up to about 19.5 wt % ash, and up to about 2 wt % moisture, and is typically sized at about 3 mesh or less. In some embodiments, the calcine pet coke replacement product is a biogenic reagent comprising at least about 66 wt % carbon, not more than about 4.6 wt % sulfur, not more than about 19.5 wt % ash, not more than about 2 wt % moisture, and is sized at about 3 mesh or less.

In some embodiments, a biogenic reagent is useful as a coking carbon replacement carbon (e.g., co-fired with metallurgical coal in a coking furnace). In one embodiment, a coking carbon replacement product is a biogenic reagent comprising at least about 55 wt % carbon, not more than about 0.5 wt % sulfur, not more than about 8 wt % non-combustible material, and a heat value of at least about 11,000 Btu per pound. In some embodiments, the coking carbon replacement product comprises about 0.5 wt % to about 50 wt % volatile matter, and/or one or more additives.

Some variations utilize the biogenic reagents as carbon breeze products, which typically have very fine particle sizes such as 6 mm, 3 mm, 2 mm, 1 mm, or smaller. In some embodiments, a biogenic reagent according to the present invention is useful as a coke breeze replacement product. Coke breeze is generally characterized as having a maximum dimension of not more than about 6 mm, a carbon content of at least about 80 wt %, 0.6 to 0.8 wt % sulfur, 1% to 20 wt % volatile matter, up to about 13 wt % ash, and up to about 13 wt % moisture. In some embodiments, a coke breeze replacement product is a biogenic reagent according to the present invention comprising at least about 80 wt % carbon, not more than about 0.8 wt % sulfur, not more than about 20 wt % volatile matter, not more than about 13 wt % ash, not more than about 13 wt % moisture, and a maximum dimension of about 6 mm.

Particle sizes can be measured by a variety of techniques, including dynamic light scattering, laser diffraction, image analysis, or sieve separation, for example. Dynamic light scattering is a non-invasive, well-established technique for measuring the size and size distribution of particles typically in the submicron region, and with the latest technology down to 1 nanometer. Laser diffraction is a widely used particle-sizing technique for materials ranging from hundreds of nanometers up to several millimeters in size. Exemplary dynamic light scattering instruments and laser diffraction instruments for measuring particle sizes are available from Malvern Instruments Ltd., Worcestershire, UK. Image analysis to estimate particle sizes and distributions can be done directly on photomicrographs, scanning electron micrographs, or other images. Finally, sieving is a conventional technique of separating particles by size.

In some embodiments, a biogenic reagent is useful as a carbon breeze replacement product during, for example, taconite pellet production or in an iron-making process.

Some variations utilize the biogenic reagents, or the biographite, as feedstocks for various fluidized beds, or as fluidized-bed carbon-based feedstock replacement products. The carbon can be employed in fluidized beds for total combustion, partial oxidation, gasification, steam reforming, or the like. The carbon can be primarily converted into syngas for various downstream uses, including production of energy (e.g., combined heat and power), or liquid fuels (e.g., methanol or Fischer-Tropsch diesel fuels).

In some embodiments, a biogenic reagent according is useful as a fluidized-bed coal replacement product in, for example, fluidized bed furnaces wherever coal would be used (e.g., for process heat or energy production).

Some variations utilize the biogenic reagents as carbon-based furnace addition products. Coal-based carbon furnace addition products are generally characterized as having high sulfur levels, high phosphorus levels, and high ash content, which contribute to degradation of the metal product and create air pollution. In some embodiments, a carbon furnace addition replacement product comprising a biogenic reagent comprises not more than about 0.5 wt % sulfur, not more than about 4 wt % ash, not more than about 0.03 wt % phosphorous, and a maximum dimension of about 7.5 cm. In some embodiments, the carbon furnace addition replacement product replacement product comprises about 0.5 wt % to about 50 wt % volatile matter and about 0.4 wt % to about 15 wt % moisture.

In some embodiments, the biographite is useful as a furnace addition carbon product at, for example, basic oxygen furnace or electric arc furnace facilities wherever carbon is used. For example, furnace addition carbon can be added to scrap steel during steel manufacturing at electric-arc furnace facilities. For electric-arc furnace applications, high-purity carbon is desired so that impurities are not introduced back into the process following earlier removal of impurities. In some embodiments, a furnace addition carbon product comprises at least about 80 wt % carbon, not more than about 0.5 wt % sulfur, not more than about 8 wt % non-combustible material, and a heat value of at least about 11,000 Btu per pound. In some embodiments, the furnace addition carbon product further comprises up to about 5 wt % manganese, up to about 5 wt % fluorospar, about 5 wt % to about 10 wt % dolomite, about 5 wt % to about 10 wt % dolomitic lime, and/or about 5 wt % to about 10 wt % calcium oxide.

Some variations utilize the biogenic reagents as stoker furnace carbon-based products. In some embodiments, a biogenic reagent according to the present invention is useful as a stoker coal replacement product at, for example, stoker furnace facilities wherever coal would be used (e.g., for process heat or energy production).

Some variations utilize the biogenic reagents as injectable (e.g., pulverized) carbon-based materials. In some embodiments, a biogenic reagent is useful as an injection-grade calcine pet coke replacement product. Injection-grade calcine pet coke is generally characterized as having at least about 66 wt % carbon, about 0.55 to about 3 wt % sulfur, up to about 5.5 wt % volatile matter, up to about 10 wt % ash, up to about 2 wt % moisture, and is sized at about 6 mesh or less. In some embodiments, a calcine pet coke replacement product is a biogenic reagent comprising at least about 66 wt % carbon, not more than about 3 wt % sulfur, not more than about 10 wt % ash, not more than about 2 wt % moisture, and is sized at about 6 mesh or less.

In some embodiments, a biogenic reagent is useful as an injectable carbon replacement product at, for example, basic oxygen furnace or electric arc furnace facilities in any application where injectable carbon would be used (e.g., injected into slag or ladle during steel manufacturing).

In some embodiments, a biogenic reagent is useful as a pulverized carbon replacement product, for example, wherever pulverized coal would be used (e.g., for process heat or energy production). In some embodiments, the pulverized coal replacement product comprises up to about 10 percent calcium oxide.

Some variations utilize the biogenic reagents as carbon addition product for metals production. In some embodiments, a biogenic reagent according to the present invention is useful as a carbon addition product for production of carbon steel or another metal alloy comprising carbon. Coal-based late-stage carbon addition products are generally characterized as having high sulfur levels, high phosphorous levels, and high ash content, and high mercury levels which degrade metal quality and contribute to air pollution. In some embodiments of this invention, the carbon addition product comprises not more than about 0.5 wt % sulfur, not more than about 4 wt % ash, not more than about 0.03 wt % phosphorus, a minimum dimension of about 1 to 5 mm, and a maximum dimension of about 8 to 12 mm.

Some variations of the invention utilize the biogenic reagents as catalyst supports. Carbon is a known catalyst support in a wide range of catalyzed chemical reactions, such as mixed-alcohol synthesis from syngas using sulfided cobalt-molybdenum metal catalysts supported on a carbon phase, or iron-based catalysts supported on carbon for Fischer-Tropsch synthesis of higher hydrocarbons from syngas.

Some variations utilize the biogenic reagents as activated carbon products. Activated carbon is used in a wide variety of liquid and gas-phase applications, including water treatment, air purification, solvent vapor recovery, food and beverage processing, and pharmaceuticals. For activated carbon, the porosity and surface area of the material are generally important. The biogenic reagent provided herein can provide a superior activated carbon product, in various embodiments, due to (i) greater surface area than fossil-fuel based activated carbon; (ii) carbon renewability; (iii) vascular nature of biomass feedstock in conjunction with additives better allows penetration/distribution of additives that enhance pollutant control; and (iv) less inert material (ash) leads to greater reactivity.

It should be recognized that in the above description of market applications of biogenic reagents, the described applications are not exclusive, nor are they exhaustive. Thus a biogenic reagent that is described as being suitable for one type of carbon product can be suitable for any other application described, in various embodiments. These applications are exemplary only, and there are other applications of biogenic reagents.

In addition, in some embodiments, the same physical material can be used in multiple market processes, either in an integrated way or in sequence. Thus, for example, a biogenic reagent that is used as a carbon electrode or an activated carbon can, at the end of its useful life as a performance material, then be introduced to a combustion process for energy value or to a metal-making (e.g., metal ore reduction) process, etc.

### Conversion of Biocarbon to Reducing Gas

Some variations utilize biocarbon to generate a reducing gas, wherein the reducing gas can be fed to the molten metal carbide reactor and/or can be recovered and sold.

The optional production of reducing gas (also referred to herein as “bio-reductant gas”) will now be further described. The conversion of biocarbon to reducing gas takes place in a reactor, which can be referred to as a bio-reductant formation unit.

A reactant can be employed to react with the biocarbon and produce a reducing gas. The reactant can be selected from oxygen, steam, or a combination thereof. In some embodiments, oxygen is mixed with steam, and the resulting mixture is added to the second reactor. Oxygen or oxygen-enriched air can be added to cause an exothermic reaction such as the partial or total oxidation of carbon with oxygen; to achieve a more favorable H₂/CO ratio in the reducing gas; (iii) to increase the yield of reducing gas; and/or (iv) to increase the purity of reducing gas, e.g. by reducing the amount of CO₂, pyrolysis products, tar, aromatic compounds, and/or other undesirable products.

Steam is a preferred reactant, in some embodiments. Steam (i.e. H₂O in a vapor phase) can be introduced into the reactor in one or more input streams. Steam can include steam generated by moisture contained in the biocarbon pellets, as well as steam generated by any chemical reactions that produce water.

All references herein to a “ratio” of chemical species are references to molar ratios unless otherwise indicated. For example, a H₂/CO ratio of 1 means one mole of hydrogen per mole of carbon dioxide.

Steam reforming, partial oxidation, water-gas shift (WGS), and/or combustion reactions can occur when oxygen or steam are added. Exemplary reactions are shown below with respect to a cellulose repeat unit (C₆H₁₀O₅) found, for example, in cellulosic feedstocks. Similar reactions can occur with any carbon-containing feedstock, including biocarbon pellets.

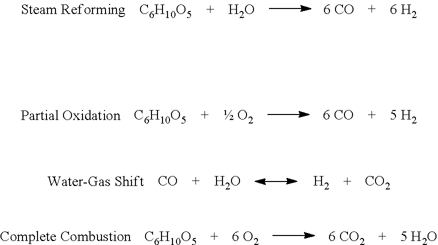

The bio-reductant formation unit is any reactor capable of causing at least one chemical reaction that produces reducing gas. Conventional steam reformers, well-known in the art, can be used either with or without a catalyst. Other possibilities include autothermal reformers, partial-oxidation reactors, and multistaged reactors that combine several reaction mechanisms (e.g., partial oxidation followed by water-gas shift). The reactor configuration can be a fixed bed, a fluidized bed, a plurality of microchannels, or some other configuration.

In some embodiments, the total amount of steam as reactant is at least about 0.1 mole of steam per mole of carbon in the feed material. In various embodiments, at least about any of 0.5, 1.0, 1.5, 2.0, 3.0, 4.0, 5.0, or more moles of steam are added or are present per mole of carbon. In some embodiments, between about 1.5-3.0 moles of steam are added or are present per mole carbon.

The amount to steam that is added to the second reactor can vary depending on factors such as the conditions of the pyrolysis reactor. When pyrolysis produces a carbon-rich solid material, generally more steam (and/or more oxygen) is used to add the necessary H and O atoms to the C available to generate CO and H₂. From the perspective of the overall system, the moisture contained in the biocarbon pellets can be accounted for in determining how much additional water (steam) to add in the process.

Exemplary ratios of oxygen to steam (O₂/H₂O) are equal to or less than about any of 2, 1.5, 1, 0.5, 0.2, 0.1, 0.05, 0.02, 0.01, or less, in the second reactor. When the ratio of O₂/H₂O is greater than 1, the combustion reaction starts to dominate over partial oxidation, which can produce undesirably low CO/CO₂ ratios.

In some embodiments, oxygen without steam is used as the reactant. Oxygen can be added in substantially pure form, or it can be fed to the process via the addition of air, optionally enriched with oxygen. In some embodiments, air that is not enriched with oxygen is added. In other embodiments, enriched air from an off-spec or recycle stream, which can be a stream from a nearby air-separation plant, for example, can be used. In some embodiments, the use of enriched air with a reduced amount of N₂ (i.e., less than 79 vol %) results in less N₂ in the resulting reducing gas. Because removal of N₂ can be expensive, methods of producing reducing gas with less or no N₂ are typically desirable.

In some embodiments, the presence of oxygen alters the ratio of H₂/CO in the reducing gas, compared to the ratio produced by the same method in the absence of oxygen. The H₂/CO ratio of the reducing gas can be between about 0.5 to about 2.0, such as between about 0.75-1.25, about 1-1.5, or about 1.5-2.0. As will be recognized, increased water-gas shift (by higher rates of steam addition) will tend to produce higher H₂/CO ratios, such as at least 2.0, 3.0. 4.0. 5.0, or even higher, which can be desired for certain applications, including hydrogen production.

Catalysts can optionally be utilized in the reactor for generating the reducing gas. Catalysts can include, but are not limited to, alkali metal salts, alkaline earth metal oxides and salts, mineral substances or ash in coal, transition metals and their oxides and salts, and eutectic salt mixtures. Specific examples of catalysts include, but are not limited to, potassium hydroxide, potassium carbonate, lithium hydroxide, lithium carbonate, cesium hydroxide, nickel oxide, nickel-substituted synthetic mica montmorillonite (NiSMM), NiSMM-supported molybdenum, iron hydroxyoxide, iron nitrate, iron-calcium-impregnated salts, nickel uranyl oxide, sodium fluoride, and cryolite.

Other exemplary catalysts include, but are not limited to, nickel, nickel oxide, rhodium, ruthenium, iridium, palladium, and platinum. Such catalysts can be coated or deposited onto one or more support materials, such as, for example, gamma-alumina (optionally doped with a stabilizing element such as magnesium, lanthanum, or barium).

Before being added to the system, any catalyst can be pretreated or activated using known techniques that impact total surface area, active surface area, site density, catalyst stability, catalyst lifetime, catalyst composition, surface roughness, surface dispersion, porosity, density, and/or thermal diffusivity. Pretreatments of catalysts include, but are not limited to, calcining, washcoat addition, particle-size reduction, and surface activation by thermal or chemical means.

Catalyst addition can be performed by first dissolving or slurrying the catalyst(s) into a solvent such as water or any hydrocarbon that can be gasified and/or reformed. In some embodiments, the catalyst is added by direct injection of such a slurry into a vessel. In some embodiments, the catalyst is added to steam and the steam/catalyst mixture is added to the system. In these embodiments, the added catalyst can be at or near its equilibrium solubility in the steam or can be introduced as particles entrained in the steam and thereby introduced into the system.

Material can generally be conveyed into and out of the reactor by single screws, twin screws, rams, and the like. Material can be conveyed mechanically by physical force (metal contact), pressure-driven flow, pneumatically driven flow, centrifugal flow, gravitational flow, fluidized flow, or some other known means of moving solid and gas phases. In certain embodiments, it can be preferable to utilize a fixed bed of biocarbon pellets in the reactor, especially in embodiments that employ a bed of metal oxide disposed above the biocarbon pellet bed which need to be mechanically robust.

In some embodiments, the reactor employs gasification of biocarbon pellets to generate a reducing gas. Gasification is carried out at elevated temperatures, typically about 600° C. to about 1100° C. Less-reactive biogenic reagents require higher operating temperatures. The amount of reactant introduced (e.g., air, oxygen, enriched air, or oxygen-steam mixtures) will typically be the primary factor controlling the gasification temperature. Operating pressures from atmospheric to about 50 bar have been employed in biomass gasification. Gasification also requires a reactant, commonly air, high-purity oxygen, steam, or some mixture of these gases.

Gasifiers can be differentiated based on the means of supporting solids within the vessel, the directions of flow of both solids and gas, and the method of supplying heat to the reactor. Whether the gasifier is operated at near atmospheric or at elevated pressures, and the gasifier is air-blown or oxygen-blown, are also distinguishing characteristics. Common classifications are fixed-bed updraft, fixed-bed downdraft, bubbling fluidized bed, and circulating fluidized bed.

Fixed-bed gasifiers, in general, cannot handle fibrous herbaceous feedstocks, such as wheat straw, corn stover, or yard wastes. However, in the disclosed processes, biomass is first pyrolyzed to a biogenic reagent, which is pelletized, and the biocarbon pellets can be gasified. The biocarbon pellets can be directly gasified using a fixed-bed gasifier, without necessarily reducing the size of the pellets.

Circulating fluidized-bed gasification technology is available from Lurgi and Foster Wheeler, and represents the majority of existing gasification technology utilized for biomass and other wastes. Bubbling fluidized-bed gasification (e.g., U-GAS® technology) has been commercially used.

Directly heated gasifiers conduct endothermic and exothermic gasification reactions in a single reaction vessel; no additional heating is needed. In contrast, indirectly heated gasifiers require an external source of heat. Indirectly heated gasifiers commonly employ two vessels. The first vessel gasifies the feed with steam (an endothermic process). Heat is supplied by circulating a heat-transfer medium, commonly sand. Reducing gas and solid char produced in the first vessel, along with the sand, are separated. The mixed char and sand are fed to the second vessel, where the char is combusted with air, heating the sand. The hot sand is circulated back to the first vessel.

The biocarbon pellets can be introduced to a gasifier as a “dry feed” (optionally with moisture, but no free liquid phase), or as a slurry or suspension in water. Dry-feed gasifiers typically allow for high per-pass carbon conversion to reducing gas and good energy efficiency. In a dry-feed gasifier, the energy released by the gasification reactions can cause the gasifier to reach extremely high temperatures. This problem can be resolved by using a wet-wall design.

In some embodiments, the feed to the gasifier is biocarbon pellets with high hydrogen content. The resulting reducing gas is relatively rich in hydrogen, with high H₂/CO ratios, such as H₂/CO>1.5 or more.

In some embodiments, the feed to the gasifier is biocarbon pellets with low hydrogen content. The resulting reducing gas is expected to have relatively low H₂/CO ratios. For downstream processes that require H₂/CO>1, it can be desirable to inject water or steam into the gasifier to both moderate the gasifier temperature (via sensible-heat effects and/or endothermic chemistry), and to shift the H₂/CO ratio to a higher, more-desirable ratio. Water addition can also contribute to temperature moderation by endothermic consumption, via steam-reforming chemistry. In steam reforming, H₂O reacts with carbon or with a hydrocarbon, such as tar or benzene/toluene/xylenes, to produce reducing gas and lower the adiabatic gasification temperature.

In certain variations, the gasifier is a fluidized-bed gasifier, such as a bubbling fluidized gasification reactor. Fluidization results in a substantially uniform temperature within the gasifier bed. A fluidizing bed material, such as alumina sand or silica sand, can reduce potential attrition issues. The gasifier temperature can be moderated to a sufficiently low temperature such that ash particles do not begin to transform from solid to molten form, which can cause agglomeration and loss of fluidization within the gasifier.

When a fluidized-bed gasifier is used, the total flow rate of all components should ensure that the gasifier bed is fluidized. The total gas flow rate and bed diameter establish the gas velocity through the gasifier. The correct velocity must be maintained to ensure proper fluidization.

In variations, the gasifier type can be entrained-flow slagging, entrained flow non-slagging, transport, bubbling fluidized bed, circulating fluidized bed, or fixed bed. Some embodiments employ gasification catalysts.

Circulating fluidized-bed gasifiers can be employed, wherein gas, sand, and feedstock (e.g., crushed or pulverized biocarbon pellets) move together. Exemplary transport gases include recirculated product gas, combustion gas, or recycle gas. High heat-transfer rates from the sand ensure rapid heating of the feedstock, and ablation is expected to be stronger than with regular fluidized beds. A separator can be employed to separate the reducing gas from the sand and char particles. The sand particles can be reheated in a fluidized burner vessel and recycled to the reactor.

In some embodiments in which a countercurrent fixed-bed gasifier is used, the reactor can consist essentially of a fixed bed of a feedstock through which a gasification agent (such as steam, oxygen, and/or recycle gas) flows in countercurrent configuration. The ash is either removed dry or as a slag.

In some embodiments in which a co-current fixed-bed gasifier is used, the reactor is similar to the countercurrent type, but the gasification agent gas flows in co-current configuration with the feedstock. Heat is added to the upper part of the bed, either by combusting small amounts of the feedstock or from external heat sources. The produced gas leaves the reactor at a high temperature, and much of this heat is transferred to the gasification agent added in the top of the bed, resulting in good energy efficiency.

In some embodiments in which a fluidized-bed reactor is used, the feedstock is fluidized in recycle gas, oxygen, air, and/or steam. The ash can be removed dry or as heavy agglomerates that defluidize. Recycle or subsequent combustion of solids can be used to increase conversion. Fluidized-bed reactors are useful for feedstocks that form highly corrosive ash that would damage the walls of slagging reactors.

In some embodiments in which an entrained-flow gasifier is used, biocarbon pellets are pulverized and gasified with oxygen, air, or recycle gas in co-current flow. The gasification reactions take place in a dense cloud of very fine particles. High temperatures can be employed, thereby providing for low quantities of tar and methane in the reducing gas.

Entrained-flow reactors remove the major part of the ash as a slag, as the operating temperature is typically well above the ash fusion temperature. A smaller fraction of the ash is produced either as a very fine dry fly ash or as a fly-ash slurry. Certain entrained-bed reactors have an inner water- or steam-cooled wall covered with partially solidified slag.

The gasifier chamber can be designed, by proper configuration of the freeboard or use of internal cyclones, to keep the carryover of solids downstream operations at a level suitable for recovery of heat. Unreacted carbon can be drawn from the bottom of the gasifier chamber, cooled, and recovered.

A gasifier can include one or more catalysts, such as catalysts effective for partial oxidation, reverse water-gas shift, or dry (CO₂) reforming of carbon-containing species.

In some embodiments, a bubbling fluid-bed devolatilization reactor is utilized. The reactor is heated, at least in part, by the hot recycle gas stream to approximately 600° C.—below the expected slagging temperature. Steam, oxygen, or air can also be introduced to the second reactor. The second can be designed, by proper configuration of a freeboard or use of internal cyclones, to keep the carryover of solids at a level suitable for recovery of heat downstream. Unreacted char can be drawn from the bottom of the devolatilization chamber, cooled, and then fed to a utility boiler to recover the remaining heating value of this stream.

When a fluidized-bed gasifier is employed, the feedstock can be introduced into a bed of hot sand fluidized by a gas, such as recycle gas. Reference herein to “sand” shall also include similar, substantially inert materials, such as glass particles, recovered ash particles, and the like. High heat-transfer rates from fluidized sand can result in rapid heating of the feedstock. There can be some ablation by attrition with the sand particles. Heat can be provided by heat-exchanger tubes through which hot combustion gas flows.

Circulating fluidized-bed reactors can be employed, wherein gas, sand, and feedstock move together. Exemplary transport gases include recirculated product gas, combustion gas, or recycle gas. High heat-transfer rates from the sand ensure rapid heating of the feedstock, and ablation is expected to be stronger than with regular fluidized beds. A separator can be employed to separate the reducing gas from the sand and char particles. The sand particles can be reheated in a fluidized burner vessel and recycled to the reactor.

In some embodiments in which a countercurrent fixed-bed reactor is used, the reactor can consist essentially of a fixed bed of a feedstock through which a gasification agent (such as steam, oxygen, and/or recycle gas) flows in countercurrent configuration. The ash is either removed dry or as a slag.

In some embodiments in which a co-current fixed-bed reactor is used, the reactor is similar to the countercurrent type, but the gasification agent gas flows in co-current configuration with the feedstock. Heat is added to the upper part of the bed, either by combusting small amounts of the feedstock or from external heat sources. The reducing gas leaves the reactor at a high temperature, and much of this heat is transferred to the reactants added in the top of the bed, resulting in good energy efficiency. Since tars pass through a hot bed of carbon in this configuration, tar levels are expected to be lower than when using the countercurrent type.

In some embodiments in which a fluidized-bed reactor is used, the feedstock is fluidized in recycle gas, oxygen, air, and/or steam. The ash is removed dry or as heavy agglomerates that defluidize. Recycle or subsequent combustion of solids can be used to increase conversion.

To enhance heat and mass transfer, water can be introduced into the reactor using a nozzle, which is generally a mechanical device designed to control the direction or characteristics of a fluid flow as it enters an enclosed chamber or pipe via an orifice. Nozzles are capable of reducing the water droplet size to generate a fine spray of water. Nozzles can be selected from atomizer nozzles (similar to fuel injectors), swirl nozzles which inject the liquid tangentially, and so on.

Water sources can include direct piping from process condensate, other recycle water, wastewater, make-up water, boiler feed water, city water, and so on. Water can optionally first be cleaned, purified, treated, ionized, distilled, and the like. When several water sources are used, various volume ratios of water sources are possible. In some embodiments, a portion or all of the water for the second reactor is wastewater.

In some variations, the reducing gas is filtered, purified, or otherwise conditioned prior to being converted to another product. For example, cooled reducing gas can be introduced to a conditioning unit, where benzene, toluene, ethyl benzene, xylene, sulfur compounds, nitrogen, metals, and/or other impurities are optionally removed from the reducing gas.

Some embodiments include a reducing-gas cleanup unit. The reducing-gas cleanup unit is not particularly limited in its design. Exemplary reducing-gas cleanup units include cyclones, centrifuges, filters, membranes, solvent-based systems, and other means of removing particulates and/or other specific contaminants. In some embodiments, an acid-gas removal unit is included and can be any means known in the art for removing H₂S, CO₂, and/or other acid gases from the reducing gas.

The reducing gas produced as described according to the present disclosure can be utilized in a number of ways. Reducing gas can generally be chemically converted and/or purified into hydrogen, carbon monoxide, methane, olefins (such as ethylene), oxygenates (such as dimethyl ether), alcohols (such as methanol and ethanol), paraffins, and other hydrocarbons. Reducing gas can be converted into linear or branched C₅-C₁₅ hydrocarbons, diesel fuel, gasoline, waxes, or olefins by Fischer-Tropsch chemistry; mixed alcohols by a variety of catalysts; isobutane by isosynthesis; ammonia by hydrogen production followed by the Haber process; aldehydes and alcohols by oxosynthesis; and many derivatives of methanol including dimethyl ether, acetic acid, ethylene, propylene, and formaldehyde by various processes. The reducing gas can also be converted to energy using energy-conversion devices such as solid-oxide fuel cells, Stirling engines, micro-turbines, internal combustion engines, thermo-electric generators, scroll expanders, gas burners, or thermo-photovoltaic devices.

In this detailed description, reference has been made to multiple embodiments of the invention and non-limiting examples relating to how the invention can be understood and practiced. Other embodiments that do not provide all of the features and advantages set forth herein can be utilized, without departing from the spirit and scope of the present invention. This invention incorporates routine experimentation and optimization of the methods and systems described herein. Such modifications and variations are considered to be within the scope of the invention defined by the claims.

All publications, patents, and patent applications cited in this specification are herein incorporated by reference in their entirety as if each publication, patent, or patent application were specifically and individually put forth herein.

Where methods and steps described above indicate certain events occurring in certain order, those of ordinary skill in the art will recognize that the ordering of certain steps can be modified and that such modifications are in accordance with the variations of the invention. Additionally, certain of the steps can be performed concurrently in a parallel process when possible, as well as performed sequentially.

Therefore, to the extent there are variations of the invention, which are within the spirit of the disclosure or equivalent to the inventions found in the appended claims, it is the intent that this patent will cover those variations as well. The present invention shall only be limited by what is claimed.

What is claimed is:

1. A process for producing biographite from a biocarbon feedstock, the process comprising:
(a) providing a biocarbon-containing feedstock;
(b) providing a metal-containing species that comprises a selected metal element, wherein the metal-containing species is a metal carbide or is capable of forming a metal carbide;
(c) feeding the biocarbon feedstock and the metal-containing species into a molten metal carbide reactor having a first reaction zone and a second reaction zone, wherein the first reaction zone is operated at a first-zone temperature selected to achieve a molten state comprising the metal carbide within the first reaction zone, and wherein the second reaction zone is operated at a second-zone temperature that is lower than the first-zone temperature;
(d) operating the molten metal carbide reactor to dissolve carbon from the biocarbon feedstock in the molten state, thereby generating dissolved carbon, and to produce biographite from the dissolved carbon in the second reaction zone;
(e) recovering and optionally further processing the biographite; and
(f) recycling a portion of the biographite to the molten metal carbide reactor as recycled biographite, wherein the recycled biographite functions as a graphitization template to enhance formation of the biographite from the dissolved carbon.

2. The process of claim 1, wherein the process co-produces hydrogen in the molten metal carbide reactor.

3. The process of claim 1, wherein the selected metal element is selected from iron, magnesium, calcium, nickel, copper, gallium, lithium, sodium, potassium, beryllium, strontium, barium, scandium, yttrium, titanium, zirconium, hafnium, vanadium, niobium, chromium, molybdenum, tungsten, manganese, technetium, rhenium, ruthenium, osmium, cobalt, rhodium, iridium, palladium, platinum, zinc, cadmium, mercury, aluminum, indium, thallium, silicon, germanium, tin, lead, lanthanum, cerium, uranium, thorium, or a combination thereof.

4. The process of claim 1, wherein the metal-containing species is iron.

5. The process of claim 1, wherein the metal-containing species is iron carbide, Fe₃C.

6. The process of claim 1, wherein the first-zone temperature is selected from about 1500° C. to about 2000° C.

7. The process of claim 1, wherein the second-zone temperature is selected from about 1200° C. to about 1600° C.

8. The process of claim 1, wherein the second-zone temperature is at least 100° C. lower than the first-zone temperature.

9. The process of claim 1, wherein the recycled biographite is recycled to the first reaction zone of the molten metal carbide reactor.

10. The process of claim 1, wherein the recycled biographite is recycled to the second reaction zone of the molten metal carbide reactor.

11. The process of claim 1, wherein the recycled biographite is first mixed with the biocarbon-containing feedstock and the metal-containing species to form a feed mixture, and wherein the feed mixture is conveyed to the first reaction zone of the molten metal carbide reactor.

12. The process of claim 1, wherein from about 10% to about 80% by mass of the biographite from step (e) is recycled as recycled biographite in step (f).

13. The process of claim 1, wherein step (f) comprises recycling on the basis of biographite particle size, and wherein the recycled biographite has a smaller average particle size compared to the biographite that is not recycled.

14. The process of claim 1, wherein at least a portion of the metal carbide present in the first reaction zone is recovered from the molten metal carbide reactor.

15. The process of claim 14, wherein the portion of metal carbide recovered from the molten metal carbide reactor is recycled to the first reaction zone.

16. The process of claim 15, wherein the recycled biographite and the portion of metal carbide recovered from the molten metal carbide reactor is first mixed with the biocarbon-containing feedstock and the metal-containing species to form a feed mixture, and wherein the feed mixture is conveyed to the first reaction zone of the molten metal carbide reactor.

17. The process of claim 1, wherein the process further comprises feeding a reducing gas into the molten metal carbide reactor, wherein the reducing gas contains H₂ and/or CO.

18. The process of claim 1, wherein in step (c), the biocarbon feedstock and the metal-containing species are fed into the first reaction vessel such that there is countercurrent flow of the biocarbon feedstock and the metal-containing species.

19. The process of claim 1, wherein the biographite product is 100% renewable, according to a measurement of the ¹⁴C/¹²C isotopic ratio of the biographite.

20. The process of claim 1, wherein the biographite is recovered in the form of a biographite product that contains at least 80 wt % crystalline graphite according to spectroscopy.
